(19) United States
(12) Patent Application Publication
(10) Pub. No.: US 2026/0074859 A1
(43) Pub. Date: Mar. 12, 2026

(54) METHOD FOR SWITCHING TCI STATE MODE, AND COMMUNICATION DEVICE

(71) Applicant: GUANGDONG OPPO MOBILE TELECOMMUNICATIONS CORP., LTD., Dongguan (CN)

(72) Inventors: Jianfei CAO, Dongguan (CN); Zhe LIU, Dongguan (CN)

(21) Appl. No.: 19/389,662

(22) Filed: Nov. 14, 2025

Related U.S. Application Data
(63) Continuation of application No. PCT/CN2023/112383, filed on Aug. 10, 2023.

(51) Int. Cl. H04L 5/00

(52) U.S. Cl. CPC H04L 5/0048; H04L 5/0044

(57) ABSTRACT

Provided is a method for switching a TCI state mode. The method is performed by a terminal device. The method includes: receiving signaling, wherein the signaling is used to indicate switching between two unified TCI state modes, wherein the two unified TCI state modes include a first unified TCI state mode and a second unified TCI state mode, wherein the first unified TCI state mode corresponds to a communication protocol of a first version, and the second unified TCI state mode corresponds to a communication protocol of a second version, the first version being different from the second version.

### CROSS-REFERENCE TO RELATED APPLICATION

This application is a continuation of International Application No. PCT/CN2023/112383, filed Aug. 10, 2023, the entire disclosure of which is incorporated herein by reference.

### TECHNICAL FIELD

The present disclosure relates to the field of mobile communications, and in particular, relates to a method for switching a transmission configuration indication (TCI) state mode, a communication device.

### RELATED ART

In two different new radio (NR) communication protocol versions that support a unified TCI state mode, the capabilities and overheads of user equipment (UE) are inconsistent. For example, a unified TCI state mode of a first version can support single transmission reception point (STRP) and multiple transmission reception points (MTRPs) transmission, but the overhead is relatively large; and a unified TCI state mode of a second version only supports STRP, but the overhead is relatively small.

### SUMMARY

Embodiments of the present disclosure provide a method for switching a TCI state mode, a communication device. The technical solutions are as follows.

According to some embodiments of the present disclosure, a method for switching a TCI state mode is provided. The method includes: receiving signaling, wherein the signaling is used to indicate switching between two unified TCI state modes, wherein the two unified TCI state modes comprise a first unified TCI state mode and a second unified TCI state mode, wherein the first unified TCI state mode corresponds to a communication protocol of a first version, and the second unified TCI state mode corresponds to a communication protocol of a second version, the first version being different from the second version.

According to some embodiments of the present disclosure, a communication device is provided. The communication device includes a processor and a memory storing at least one program therein, wherein the processor, when running the at least one program stored in the memory, causes the communication device to: receive signaling, wherein the signaling is used to indicate switching between two unified TCI state modes, wherein the two unified TCI state modes comprise a first unified TCI state mode and a second unified TCI state mode, wherein the first unified TCI state mode corresponds to a communication protocol of a first version, and the second unified TCI state mode corresponds to a communication protocol of a second version, the first version being different from the second version.

According to some embodiments of the present disclosure, a communication device is provided. The communication device includes a processor and a memory storing at least one program therein, wherein the processor, when running the at least one program stored in the memory, causes the communication device to: transmit signaling, wherein the signaling is used to instruct a terminal device to switch between two unified TCI state modes, wherein the two unified TCI state modes comprise a first unified TCI state mode and a second unified TCI state mode, wherein the first unified TCI state mode corresponds to a communication protocol of a first version, and the second unified TCI state mode corresponds to a communication protocol of a second version, the first version being different from the second version.

### BRIEF DESCRIPTION OF DRAWINGS

To describe the technical solutions in embodiments of the present disclosure more clearly, the following briefly describes the accompanying drawings required for describing the embodiments. Apparently; the accompanying drawings in the following description show merely some embodiments of the present disclosure, and those of ordinary skill in the art may still derive other accompanying drawings from these accompanying drawings without creative efforts.

FIG. 1 is a schematic diagram of STRP transmission according to the related art;

FIG. 2 is a schematic diagram of MTRP transmission according to the related art:

FIG. 3 is a schematic diagram of an architecture of a communication system according to some embodiments of the present disclosure:

FIG. 4 is a flowchart of a method for switching a TCI state mode according to some embodiments of the present disclosure:

FIG. 5 is a structural diagram of a media access control control element (MAC CE) of a second version according to the related art:

FIG. 6 is a structural diagram of a MAC CE of a first version according to some embodiments of the present disclosure:

FIG. 7 is a structural diagram of a MAC CE of a first version according to some embodiments of the present disclosure:

FIG. 8 is a structural diagram of a MAC CE of a first version according to some embodiments of the present disclosure;

FIG. 9 is a flowchart of a method for switching a TCI state mode according to some embodiments of the present disclosure:

FIG. 10 is a diagram of changes of unified TCI states according to some embodiments of the present disclosure:

FIG. 11 is a diagram of changes of unified TCI states according to some embodiments of the present disclosure:

FIG. 12 is a diagram of changes of unified TCI states according to some embodiments of the present disclosure:

FIG. 13 is a diagram of changes of unified TCI states according to some embodiments of the present disclosure:

FIG. 14 is a flowchart of a method for switching a TCI state mode according to some embodiments of the present disclosure:

FIG. 15 is a diagram of changes of unified TCI states according to some embodiments of the present disclosure:

FIG. 16 is a diagram of changes of unified TCI states according to some embodiments of the present disclosure:

FIG. 17 is a flowchart of a method for switching a TCI state mode according to some embodiments of the present disclosure:

FIG. 18 is a flowchart of a method for switching a TCI state mode according to some embodiments of the present disclosure:

FIG. 19 is a diagram of changes of unified TCI states according to some embodiments of the present disclosure:

FIG. 20 is a diagram of changes of unified TCI states according to some embodiments of the present disclosure:

FIG. 21 is a flowchart of a method for switching a TCI state mode according to some embodiments of the present disclosure:

FIG. 22 is a diagram of changes of unified TCI states according to some embodiments of the present disclosure:

FIG. 23 is a diagram of changes of unified TCI states according to some embodiments of the present disclosure:

FIG. 24 is a diagram of changes of unified TCI states according to some embodiments of the present disclosure:

FIG. 25 is a diagram of changes of unified TCI states according to some embodiments of the present disclosure:

FIG. 26 is a flowchart of a method for switching a TCI state mode according to some embodiments of the present disclosure:

FIG. 27 is a flowchart of a method for switching a TCI state mode according to some embodiments of the present disclosure:

FIG. 28 is a flowchart of a method for switching a TCI state mode according to some embodiments of the present disclosure:

FIG. 29 is a flowchart of a method for switching a TCI state mode according to some embodiments of the present disclosure:

FIG. 30 is a flowchart of a method for switching a TCI state mode according to some embodiments of the present disclosure:

FIG. 31 is a flowchart of a method for switching a TCI state mode according to some embodiments of the present disclosure:

FIG. 32 is a flowchart of a method for switching a TCI state mode according to some embodiments of the present disclosure:

FIG. 33 is a flowchart of a method for switching a TCI state mode according to some embodiments of the present disclosure:

FIG. 34 is a flowchart of a method for switching a TCI state mode according to some embodiments of the present disclosure:

FIG. 35 is a flowchart of a method for switching a TCI state mode according to some embodiments of the present disclosure;

FIG. 36 is a flowchart of a method for switching a TCI state mode according to some embodiments of the present disclosure:

FIG. 37 is a flowchart of a method for switching a TCI state mode according to some embodiments of the present disclosure;

FIG. 38 is an overall flowchart of a method for switching a TCI state mode according to some embodiments of the present disclosure:

FIG. 39 is a structural block diagram of an apparatus for switching a TCI state mode according to some embodiments of the present disclosure:

FIG. 40 is a structural block diagram of an apparatus for switching a TCI state mode according to some embodiments of the present disclosure; and

FIG. 41 is a schematic structural diagram of a communication device according to some embodiments of the present disclosure.

### DETAILED DESCRIPTION

For clearer descriptions of the objectives, technical solutions, and advantages of the present disclosure clearer, embodiments of the present disclosure are further described in detail hereinafter with reference to the accompanying drawings. When the following description refers to the accompanying drawings, the same numbers in different accompanying drawings represent the same or similar elements unless otherwise indicated. The embodiments described in the following embodiments do not represent all embodiments consistent with the present disclosure. Rather, they are merely examples of apparatus and methods consistent with certain aspects of the present disclosure, as detailed in the appended claims.

A network architecture and a service scenario described in the embodiments of the present disclosure are intended to describe the technical solutions according to the embodiments of the present disclosure more clearly, and do not constitute limitations on the technical solutions according to the embodiments of the present disclosure. Those of ordinary skill in the art may understand that, with evolution of the network architecture and emergence of a new service scenario, the technical solutions according to the embodiments of the present disclosure are also applicable to a similar technical problem. The terms used in the present disclosure are for the purpose of describing particular embodiments only and are not intended to limit the present disclosure. As used in the present disclosure and the appended claims, the singular forms “a.” “an.” and “the” are intended to include the plural forms as well, unless the context clearly indicates otherwise. It should also be understood that the term “and/or” as used herein refers to and encompasses any or all possible combinations of one or more associated listed items.

It should be understood that although the terms “first,” “second,” and the like may be used herein to describe various pieces of information, and such information should not be limited to these terms. These terms are only used to distinguish one type of information from another. For example, a first value may be referred to as a second value, and similarly, a second value may be referred to as a first value, without departing from the scope of the present disclosure. The word “if.” as used herein, may be interpreted as “in a case where,” “in a case when,” or “in response to determining that.” depending on the context.

First, some terms involved in the present disclosure are briefly described.

Transmission configuration indication (TCI) state; The TCI state is used to indicate beam information during transmission between a network device and a terminal device. The TCI state is proposed in the R15 version, and the TCI state is used for beam indication in a downlink spatial domain and transmission of beam information in a time domain and a frequency domain. The TCI state in the earlier version is only applicable to downlink channels and signals, and has many limitations in application in an NR system. To provide a unified uplink and downlink beam management mechanism for the NR system, a concept of a unified TCI state is proposed in the R17 version.

Unified TCI state: The unified TCI state is used to indicate beam information during transmission between a network device and a terminal device, and can achieve the unified management of uplink and downlink beams. In the unified TCI state, the downlink channels and signals use the same downlink transmission indication beam, and the uplink channels and signals use the same uplink transmission beam. In addition, two modes are designed for the unified TCI state: a joint TCI state and a separate TCI state. During configuration, only one of the two modes can be configured for the terminal device. In the related art, in R17, the network (NW) uses the following RRC parameters for distinguishing whether a joint TCI state or a separate TCI state is configured for the terminal device.

Unified TCI state type r17unifiedTCI-StateType-r17 ENUMERATED {separate, joint}:

Joint TCI state: The joint TCI state is used to indicate uplink and downlink beam information during transmission between a network device and a terminal device. The joint TCI state is applicable to uplink and downlink channels and signals. In the joint TCI state, the network device and the terminal device communicate with each other using a symmetric beam pair.

Separate TCI state: The separate TCI state is used to indicate uplink and downlink beam information during transmission between a network device and a terminal device. The separate TCI state includes an uplink TCI state (UL TCI state) and a downlink TCI state (DL TCI state). The UL TCI state is applicable to uplink channels and signals. The DL TCI state is applicable to downlink channels and signals.

TCI state mode: The TCI state mode should be equivalently understood as a TCI framework. The TCI state mode is a functional framework used to configure beam information during transmission between a network device and a terminal device. The TCI state mode can configure beam information using one or more signaling.

In the related art, the beam information of the unified TCI state is usually jointly indicated or configured by three types of signaling: RRC, media access control control element (MAC CE) and downlink control information (DCI), and the joint indication process of each signaling can be divided into three stages: 1. RRC configuration: 2. MAC CE activation: 3. DCI indication. In some embodiments, after the terminal device establishes a connection with the network device, the network device configures a set of TCI states that may be used for the terminal device over RRC signaling. For example, the network device configures 100 TCI states that may be used for the terminal device over RRC signaling. Then, the network device uses MAC CE signaling to indicate at least one beam in an activated state to the terminal device. For example, the MAC CE signaling activates eight beams in the 100 beams configured over the RRC signaling, wherein the activation means that the beams are switched from a non-operating state to an operating state. In a case where uplink transmission and downlink transmission are required, the network device further uses DCI signaling to indicate which beam in the eight beams in an activated state is specifically used for the uplink transmission and the downlink transmission to the terminal device, such that the terminal device clearly understands which beam should be used to communicate with the network device.

Transmission reception point (TRP): The TRP is an antenna array including one or more antenna elements, and the form and the number of ports of the entire array can be flexibly adjusted based on deployment scenarios and service requirements. TRPs may be connected using an optical fiber, to achieve a more flexible distributed deployment. In some embodiments, one base station is equivalently considered as one TRP.

Single transmission reception point (STRP): The STRP refers to a method for communicating with a terminal device using a single TRP. FIG. 1 is a schematic diagram of STRP transmission. In the STRP transmission scenario, TRP 1 transmits DCI to the terminal device over a physical downlink control channel (PDCCH), and transmits downlink data to the terminal device over a physical downlink shared channel (PDSCH).

Multiple transmission reception points (MTRPs): The MTRP refers to a method for communicating with a terminal device using multiple network devices. FIG. 2 is a schematic diagram of MTRP transmission. In the MTRP transmission scenario, the transmission of two PDSCHs may be scheduled using single DCI signaling. The DCI signaling may be from TRP 1 or TRP 2. For example, in a case where TRP 2 transmits a single DCI to the terminal device, a codepoint in the DCI indicates to the terminal whether the data to be transmitted this time is from one TRP or two TRPs. In a case where the codepoint in the DCI indicates that the data is transmitted by one TRP, the operation is the STRP transmission. In a case where the codepoint in the DCI indicates that the data is transmitted by two TRPs, the operation is the MTRP transmission. In this case, the TRP 1 and the TRP 2 transmit the same data to the terminal device over the PDSCH. Using the MTRP transmission can ensure that the integrity of data received by the terminal device at the edge of a cell with a relatively weak signal is basically consistent with the integrity of data received at the center of a cell with a relatively strong signal under STRP. That is, in a case where the terminal device is located at the center of a cell, the STRP transmission is recommended; and in a case where the terminal device is located at the edge of a cell, MTRP is recommended.

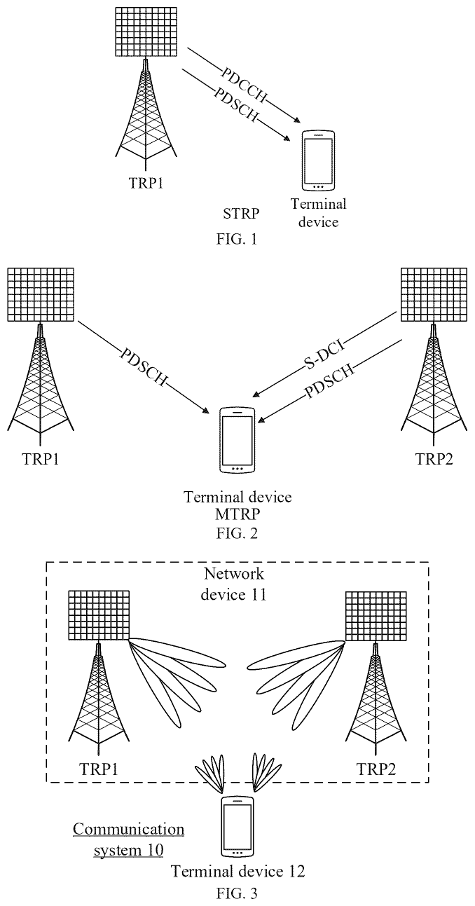

FIG. 3 is a schematic diagram of an architecture of a communication system 10 according to some embodiments of the present disclosure. The communication system 10 may include a network device 11 and a terminal device 12.

The network device 11 refers to an apparatus deployed in the access network to provide wireless communication function for the terminal device 12. For convenience of description, in the embodiments of the present disclosure, the above apparatus for providing the terminal device 12 with the wireless communication function is collectively referred to as the network device 11. The network device 11 and the terminal device 12 may establish a connection therebetween via an air interface, and then communicate with each other over the connection, including signaling and data interaction.

The network device 11 may include various forms of a macro base station, a micro base station, a relay station, an access point, or the like. In systems using different radio access technologies, a device with the functionality of a network device may have different names. For example, the device is referred to as an evolved node base station (eNodeB or eNB) in a long-term evolution (LTE) system; and the device is referred to as a next generation node base station (gNodeB or gNB) in a 5G new radio (NR) system. As communication technologies evolve, the name “network device” may change.

In some embodiments of the present disclosure, the network device 11 may only include the TRP 1, or may include more TRPs than the TRP 1 and the TRP 2. The TRP 1 and the TRP 2 may be two TRPs corresponding to the same cell, or may be two TRPs corresponding to different cells.

The terminal device 12 may refer to a user equipment (UE), an access terminal, a subscriber unit, a subscriber station, a mobile station, a mobile terminal, a remote station, a remote terminal, a mobile device, a wireless communication device, a user agent, or a user apparatus. In some embodiments, the terminal device 12 is also a cellular phone, a cordless phone, a Session Initiation Protocol (SIP) phone, a wireless local loop (WLL) station, personal digital assistant (PDA), a handheld device with wireless communication function, a computing device, or other processing devices connected to a wireless modem, a vehicle-mounted device, a wearable device, a terminal device in a 5^{th} generation system (5GS), or a terminal device in a public land mobile network (PLMN) evolved in the future, or the like, which is not limited in the embodiments of the present disclosure. For convenience of description, the devices described above are collectively referred to as the terminal devices. A plurality of terminal devices 12 are usually deployed, and one or more terminal devices 12 may be distributed in a cell managed by each network device.

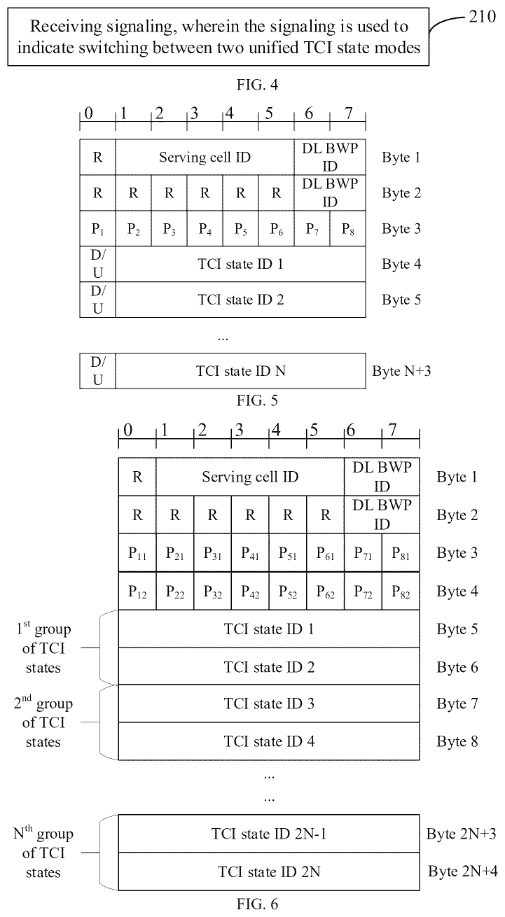

FIG. 4 illustrates a flowchart of a method for switching a TCI state mode according to some embodiments of the present disclosure. The method is performed by the terminal device illustrated in FIG. 3. The method includes the following processes.

In process 210, the terminal device receives signaling, wherein the signaling is used to indicate switching between two unified TCI state modes.

The two unified TCI state modes include a first unified TCI state mode and a second unified TCI state mode. The first unified TCI state mode corresponds to a communication protocol of a first version, and the second unified TCI state mode corresponds to a communication protocol of a second version, the first version being different from the second version. In some embodiments, the first unified TCI state mode and the second unified TCI state mode have different capabilities and/or overheads.

In some embodiments, the first unified TCI state mode supports both STRP and MTRP, and the second unified TCI state mode supports STRP. In some embodiments, the communication protocol of the first version supports STRP and MTRP, and the communication protocol of the second version supports STRP. In some embodiments, the communication protocol of the first version is a communication protocol of an R18 version, and the communication protocol of the second version is a communication protocol of an R17 version: alternatively, the communication protocol of the first version is a communication protocol of an R19 version, and the communication protocol of the second version is a communication protocol of an R17 version. The specific version numbers of the two versions of the communication protocols are not limited in the embodiments.

In some embodiments, the signaling includes first signaling and/or second signaling. The first signaling is used to indicate switching from the first unified TCI state mode to the second unified TCI state mode, or the second signaling is used to indicate switching from the second unified TCI state mode to the first unified TCI state mode. In a case where the first version is higher than the second version, the first signaling is used to indicate a fallback from the first unified TCI state mode to the second unified TCI state mode.

In some embodiments, switching between the two unified TCI state modes is applicable to all carriers in a first carrier list, and all the carriers in the first carrier list are a plurality of carriers of a common beam.

The common beam means that in a case where a plurality of component carriers (CCs) are configured in the first carrier list, and in the case where any one of the CCs receives the signaling, triggering a switch between the two unified TCI state modes, then the process is applicable to all other CCs in the first carrier list.

In summary; in the method according to the present disclosure, the signaling is received, wherein the signaling is used to indicate switching between the first unified TCI state mode and the second unified TCI state mode, such that the TCI state modes can be switched, thereby supporting transmission requirements in different transmission scenarios.

In some embodiments, the signaling is signaling used for configuring a unified TCI state, such as RRC signaling: alternatively, the signaling is signaling used for activating a unified TCI state, such as MAC CE: alternatively, the signaling is signaling used for indicating a unified TCI state, such as DCI. In the embodiments of the present disclosure, an example in which the signaling is signaling used for activating a unified TCI state is used for description.

### Signaling Used for Activating a Unified TCI State:

In some embodiments, the signaling used for activating a unified TCI state is a MAC CE. The signaling includes at least the following information fields:

### 1. Information Field for Activating a Unified TCI State

In some embodiments, the MAC CE is used to activate eight or eight groups of unified TCI states. In some embodiments, the MAC CE is used to activate 16 or 16 groups of unified TCI states, or the MAC CE is used to activate 32 or 32 groups of unified TCI states, or more groups of unified TCI states, which is not limited in the embodiments.

The information field may be illustrated in bytes 3 to N+3 of FIG. 5. The partial packet format of the MAC CE illustrated in FIG. 5 includes bytes 1 to N+3.

The 0^{th} bit of byte 1 is a reserved bit R, and the reserved bit is 0 by default. The 1^{st} to 5^{th} bits are used to indicate a serving cell ID, and the 6^{th} and 7^{th} bits are used to indicate a downlink bandwidth part ID (BWP ID).

The 0^{th} to 5^{th} bits of byte 2 are reserved bits R, and the reserved bit is 0 by default. The 6^{th} and 7^{th} bits are used to indicate an uplink BWP ID.

For example, the MAC CE is used to activate eight or eight groups of unified TCI states. Bytes 3 to N+3 are used to indicate activated unified TCI states corresponding to eight TCI codepoints, respectively. The 0^{th} TCI codepoint to 7^{th} TCI codepoint are 000, 001, 010, 011, 100, 101, 110, and 111, respectively. The eight TCI codepoints are not explicitly indicated in the MAC CE and are implicitly indicated by related bits of bytes 3 to N+3.

In a case where the RRC is configured as a joint TCI state:

The 0^{th} to 7^{th} bits of byte 3 form a Pᵢ field, wherein the Pᵢ field is used to indicate whether the i^{th} TCI codepoint corresponds to two TCI states or a single TCI state, wherein i represents an integer from 0 to 7. In a case where the value of the Pᵢ field is 0, the TCI codepoint corresponds to a single TCI state, i.e., a joint TCI state.

The 0^{th} bits of bytes 4 to N+3 are used to indicate that the unified TCI state corresponding to the i^{th} TCI codepoint is a joint TCI state, and the 1^{st} to 7^{th} bits are used to indicate the joint TCI state corresponding to the i^{th} TCI codepoint.

In a case where the RRC is configured as a separate TCI state:

The 0^{th} to 7^{th} bits of byte 3 form a Pᵢ field, wherein the Pᵢ field is used to indicate whether the i^{th} TCI codepoint corresponds to two TCI states or a single TCI state. In a case where the Pᵢ field is 0, the i^{th} TCI codepoint corresponds to a single TCI state, i.e., a UL TCI state or a DL TCI state; in this case, the i^{th} TCI codepoint corresponds to one byte in the following bytes. In a case where the Pᵢ field is 1, the i^{th} TCI codepoint corresponds to two TCI states, i.e., a UL TCI state and a DL TCI state; in this case, the i^{th} TCI codepoint corresponds to two bytes in the following bytes.

The 0^{th} bits of bytes 4 to N+3 are D/U, which are used to indicate whether the TCI state ID of the current byte is a DL TCI state or a UL TCI state. In a case where the D/U field is 1, the TCI state ID in the current byte is used to indicate a DL TCI state. In a case where the D/U field is 0, the TCI state ID in the current byte is used to indicate a UL TCI state. N represents a positive integer less than or equal to 8.

2. Extended Logical Channel ID (eLCID) Field

Table 1 illustrates the local value of the eLCID in the signaling used for activating a unified TCI state in the related art.

TABLE 1
Local value of eLCID in the related art

| Codepoint | Index | LCID value |
|---|---|---|
| 0 | 64 | . . . |
| . . . | . . . | . . . |
| 226 | 290 | . . . |
| . . . | . . . | . . . |
| 232 | 296 | Enhanced SCell activation/deactivation MAC CE with |
| | | four octet Ci field |
| 233 | 297 | Unified TCI states activation/deactivation MAC CE |
| 234 | 298 | PUCCH power control set update for multiple TRP |
| | | PUCCH repetition MAC CE |
| 235 | 299 | PUCCH spatial relation activation/deactivation for |
| | | multiple TRP PUCCH repetition MAC CE |
| . . . | . . . | . . . |
| 255 | 319 | Timing delta |

The present disclosure illustrates three implementations of switching between two unified TCI state modes based on signaling (that is, signaling for activating a unified TCI state). At least one of the three implementations may be used in different embodiments. The three implementations are as follows.

Implementation 1: Switching is performed between two unified TCI state modes based on an existing information field for activating a unified TCI state in the signaling.

Implementation 2: Switching is performed between two unified TCI state modes based on an existing eLCID field in the signaling.

Implementation 3: Switching is performed between two unified TCI state modes based on a newly added Flag field in the signaling.

The three implementations are sequentially described hereinafter, but the introduction sequence of the three implementations does not limit the superiority or inferiority of the three implementations.

With respect to Implementation 1: Switching is performed between two unified TCI state modes based on the existing information field for activating the unified TCI state in the signaling.

In some embodiments, a partial packet format of a MAC CE of the first version is designed.

For the MAC CE of the first version, the information field for activating a joint TCI state is illustrated in bytes 3 to 2N+4 of FIG. 6, and the partial packet format of the MAC CE illustrated in FIG. 6 includes bytes 1 to 2N+4.

The 0^{th} bit of byte 1 is a reserved bit R, and the reserved bit is 0 by default. The 1^{st} to 5^{th} bits are used to indicate a serving cell ID, and the 6^{th} and 7^{th} bits are used to indicate a downlink BWP ID.

The 0^{th} to 5^{th} bits of byte 2 are reserved bits R, and the reserved bit is 0 by default. The 6^{th} and 7^{th} bits are used to indicate an uplink BWP ID.

For example, the MAC CE is used to activate eight or eight groups of unified TCI states. Bytes 3 to 2N+4 are used to indicate activated unified TCI states corresponding to eight TCI codepoints, respectively. The 0^{th} TCI codepoint to 7^{th} TCI codepoint are 000, 001, 010, 011, 100, 101, 110, and 111, respectively. The eight TCI codepoints are not explicitly indicated in the MAC CE and are implicitly indicated by related bits of bytes 3 to 2N+4. Each codepoint corresponds to a group of unified TCI states: a first joint TCI state and/or a second joint TCI state.

The 0^{th} to 7^{th} bits of byte 3 form a Pᵢ₁ field, wherein the Pᵢ₁ field is used to indicate whether the first joint TCI state is present in the i^{th} group of TCI states, wherein i represents an integer from 0 to 7. In a case where Pᵢ₁ is 0, the i^{th} group of TCI states does not include the first joint TCI state. In a case where Pᵢ₁ is 1, the i^{th} group of TCI states includes the first joint TCI state.

The 0^{th} to 7^{th} bits of byte 4 form a Pᵢ₂ field, wherein the Pᵢ₂ field is used to indicate whether the second joint TCI state is present in the i^{th} group of TCI states. In a case where Piz is 0, the i^{th} group of TCI states does not include the second joint TCI state. In a case where Piz is 1, the i^{th} group of TCI states includes the second joint TCI state. The 0^{th} to 7^{th} bits of bytes 5 to 2N+4 are IDs of TCI states. In some embodiments, in a case where both the Pᵢ₁ field and the Pᵢ₂ field are 1, eight groups of TCI states are present. The 1^{st} byte in each group represents the ID of the first joint TCI state, and the 2^{nd} byte represents the ID of the second joint TCI state.

N represents a positive integer less than or equal to 8.

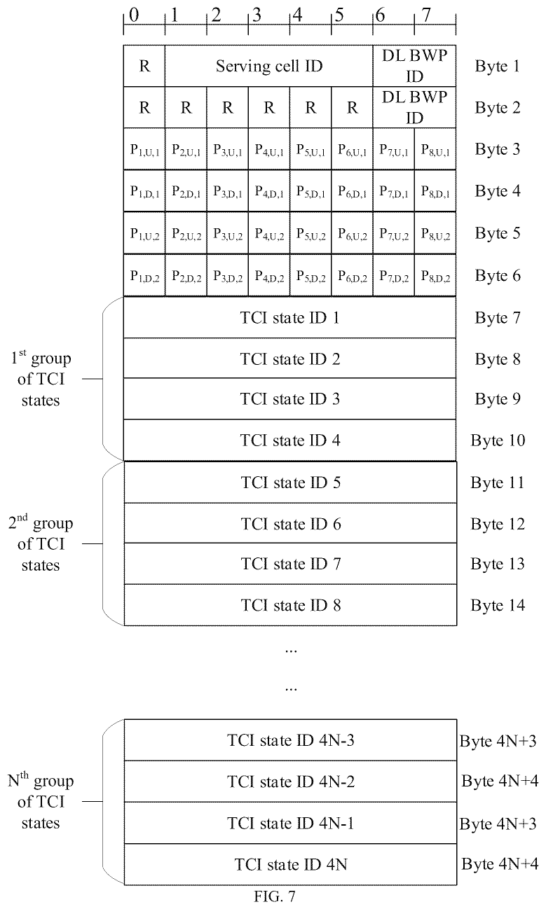

For the MAC CE of the first version, the information field for activating a separate TCI state is illustrated in bytes 3 to 2N+4 of FIG. 7, and the partial packet format of the MAC CE illustrated in FIG. 7 includes bytes 1 to 4N+4.

The 0^{th} bit of byte 1 is a reserved bit R, and the reserved bit is 0 by default. The 1^{st} to 5^{th} bits are used to indicate a serving cell ID, and the 6^{th} and 7^{th} bits are used to indicate a downlink BWP ID.

The 0^{th} to 5^{th} bits of byte 2 are reserved bits R, and the reserved bit is 0 by default. The 6^{th} and 7^{th} bits are used to indicate an uplink BWP ID.

For example, the MAC CE is used to activate eight or eight groups of unified TCI states. Bytes 3 to 4N+4 are used to indicate activated unified TCI states corresponding to eight TCI codepoints, respectively. The 0^{th} TCI codepoint to 7^{th} TCI codepoint are 000, 001, 010, 011, 100, 101, 110, and 111, respectively. The eight TCI codepoints are not explicitly indicated in the MAC CE and are implicitly indicated by related bits of bytes 3 to 4N+4. Each codepoint corresponds to a group of unified TCI states, and each group of unified TCI states includes one or more of a first UL TCI state, a first DL TCI state, a second UL TCI state, and a second DL TCI state.

The 0^{th} to 7^{th} bits of byte 3 form a P_{i, U, 1} field, wherein the P_{i, U, 1} field is used to indicate whether the first UL TCI state is present in the i^{th} group of TCI states, wherein i represents an integer from 0 to 7. In a case where P_{i, U, 1} is 0, the i^{th} group of TCI states does not include the first UL TCI state. In a case where P_{i, U, 1} is 1, the i^{th} group of TCI states includes the first UL TCI state.

The 0^{th} to 7^{th} bits of byte 4 form a P_{i, D, 1} field, wherein the P_{i, D, 1} field is used to indicate whether the first DL TCI state is present in the i^{th} group of TCI states. In a case where P_{i, D, 1} is 0, the i^{th} group of TCI states does not include the first DL TCI state. In a case where P_{i, D, 1} is 1, the i^{th} group of TCI states includes the first DL TCI state.

The 0^{th} to 7^{th} bits of byte 5 form a P_{i, U, 2} field, wherein the P_{i, U, 2} field is used to indicate whether the second UL TCI state is present in the i^{th} group of TCI states. In a case where P_{i, U, 2} is 0, the i^{th} group of TCI states does not include the second UL TCI state. In a case where P_{i, U, 2} is 1, the i^{th} group of TCI states includes the second UL TCI state.

The 0^{th} to 7^{th} bits of byte 6 form a P_{i, D, 2} field, wherein the P_{i, D, 2} field is used to indicate whether the second DL TCI state is present in the i^{th} group of TCI states. In a case where P_{i, D, 2} is 0, the i^{th} group of TCI states does not include the second DL TCI state. In a case where P_{i, D, 2} is 1, the i^{th} group of TCI states includes the second DL TCI state.

N represents a positive integer less than or equal to 8.

The MAC CE activates unified TCI states corresponding to at most eight TCI codepoints. In a case where the subsequent DCI indicates one TCI codepoint of the eight TCI codepoints, each TCI codepoint is represented by three bits. The TCI codepoint is one or more of 000, 001, 010, 011, 100, 101, 110, and 111. Each TCI codepoint corresponds to a group of TCI states. For example, 000 corresponds to the 1^{st} group of TCI states, and 001 corresponds to the 2^{nd} group of TCI states. The following table illustrates the corresponding relationship between one TCI codepoint and a TCI state.

TABLE 2
Corresponding relationship between TCI codepoint and TCI state

| TCI codepoint | First joint TCI state | Second joint TCI state |
|---|---|---|
| 000 | Joint TCI state ID = 1 | Joint TCI state ID = 2 |
| 001 | Joint TCI state ID = 3 | / |
| 010 | / | Joint TCI state ID = 4 |
| . . . | . . . | . . . |
| 111 | Joint TCI state ID = 5 | Joint TCI state ID = 6 |

In a case where the corresponding relationship between TCI codepoints and TCI states is as illustrated in the above table, the partial packet format of the MAC CE is illustrated in FIG. 8. The TCI codepoint 000 corresponds to the 1^{st} group of TCI states, P11 and P12 are both 1, and the 1^{st} group of TCI states includes the first joint TCI state and the second joint TCI state; P21 is 1, P22 is 0, and the 2^{nd} group of TCI states only includes the first joint TCI state; P31 is 0, P32 is 1, and the 3^{rd} group of TCI states only includes the second joint TCI state.

In some embodiments, “all activated unified TCI states” herein are understood as “a unified TCI state corresponding to each TCI codepoint in all activated TCI codepoints”, and “at least one activated unified TCI state” herein is understood as “a unified TCI state corresponding to at least one activated TCI codepoint”. That is, “all or at least one” in the context is measured based on the unified TCI state corresponding to one TCI codepoint.

Since two cases of switching are present between two unified TCI states, the following is categorized into 1.1 and 1.2 for introduction, respectively.

### 1.1 the First Unified TCI State Mode is Switched to the Second Unified TCI State Mode.

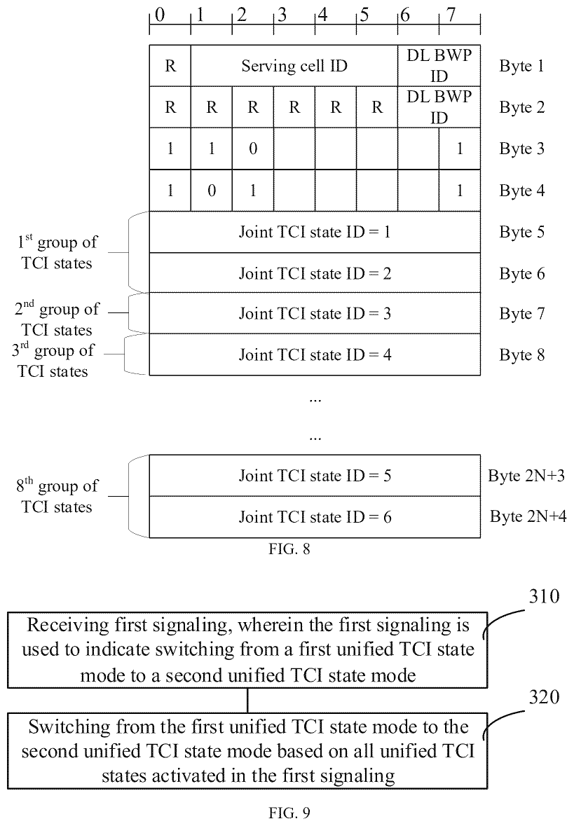

FIG. 9 illustrates a flowchart of a method for switching a TCI state mode according to some embodiments of the present disclosure. The method is performed by the terminal device illustrated in FIG. 3. The method includes the following processes.

In process 310, the terminal device receives first signaling, wherein the first signaling is used to indicate switching from the first unified TCI state mode to the second unified TCI state mode.

In some embodiments, the first signaling is signaling used for activating a unified TCI state in the first version: alternatively; the first signaling is signaling used for activating a unified TCI state in the second version.

In process 320, the terminal device switches from the first unified TCI state mode to the second unified TCI state mode based on all unified TCI states activated in the first signaling.

With Respect to the First Signaling being Signaling Used for Activating a Unified TCI State in the First Version:

All unified TCI states activated in the first signaling satisfy a first condition. The first condition herein means that the unified TCI state corresponding to each activated TCI codepoint corresponds to the same TRP.

In some embodiments, the first condition includes:
the all unified TCI states activated in the first signaling only corresponding to a first joint TCI state; or
the all unified TCI states activated in the first signaling only corresponding to a second joint TCI state; or
the all unified TCI states activated in the first signaling only corresponding to a first UL TCI state and/or a first DL TCI state; or
the all unified TCI states activated in the first signaling only corresponding to a second UL TCI state and/or a second DL TCI state.

The first unified TCI state mode is switched to the second unified TCI state mode in a case where all unified TCI states activated in the first signaling satisfy the first condition. In some embodiments, the activated unified TCI state is overwritten or rewritten or updated using the unified TCI state indicated in the first signaling, so as to switch from the first unified TCI state mode to the second unified TCI state mode.

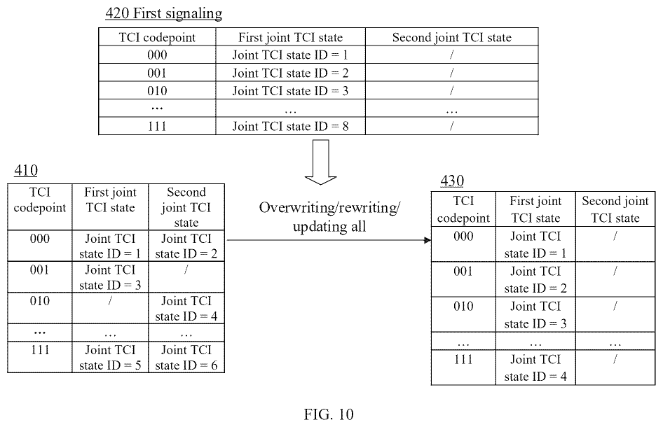

In some embodiments of the present disclosure, the terminal device is in the first unified TCI state mode, that is, in the communication protocol of the R18 version. In the first signaling received by the terminal device, all activated unified TCI states only correspond to the first joint TCI state. In this case, the terminal device overwrites or rewrites or updates the activated unified TCI state using the first joint TCI state in the first signaling, such that the terminal device switches from the first unified TCI state mode to the second unified TCI state mode. As illustrated in FIG. 10, the table 410 is used to indicate unified TCI states activated prior to receiving the first signaling, the table 420 is used to indicate unified TCI states activated in the first signaling, and the table 430 is used to indicate unified TCI states activated after an overwrite or rewrite or update operation. The terminal device is in the first unified TCI state prior to receiving the first signaling, and the activated unified TCI states include the first joint TCI state and the second joint TCI state. For example, the TCI codepoint is 000, which corresponds to the first joint TCI state and the second joint TCI state; the TCI codepoint is 001, which corresponds to the first joint TCI state; all unified TCI states activated in the first signaling only correspond to the first joint TCI state, and subsequent to overwriting or rewriting or updating, the activated unified TCI states also only correspond to the first joint TCI state.

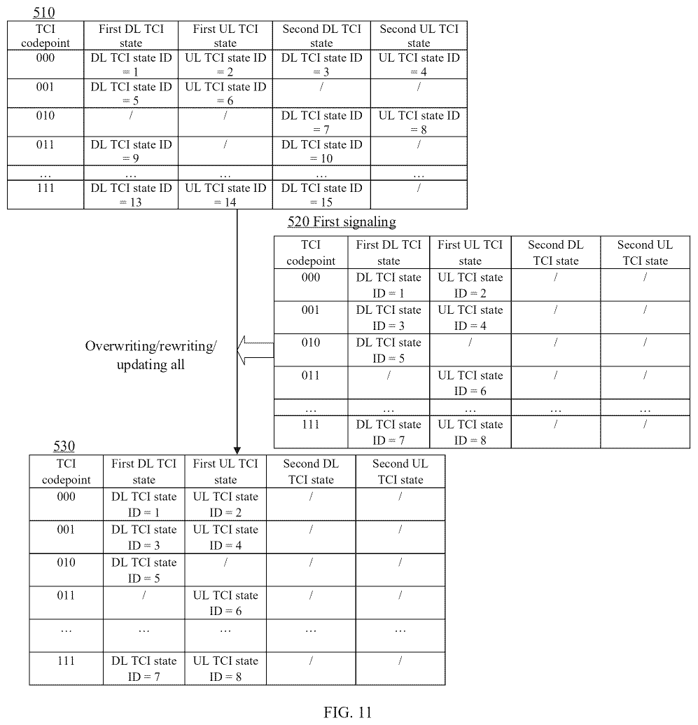

In some embodiments of the present disclosure, the terminal device is in the first unified TCI state mode, that is, in the communication protocol of the R18 version. In the first signaling received by the terminal device, all activated unified TCI states only correspond to the first UL TCI state and/or the first DL TCI state. In this case, the terminal device overwrites or rewrites or updates the activated unified TCI state using the first joint TCI state in the first signaling, such that the terminal device switches from the first unified TCI state mode to the second unified TCI state mode. As illustrated in FIG. 11, the table 510 is used to indicate unified TCI states activated prior to receiving the first signaling, the table 520 is used to indicate unified TCI states activated in the first signaling, and the table 530 is used to indicate unified TCI states activated after an overwrite or rewrite or update operation. The terminal device is in the first unified TCI state prior to receiving the first signaling, and the activated unified TCI states include the first UL TCI state, the first DL TCI state, the second UL TCI state, and the second DL TCI state. For example, the TCI codepoint is 000, which corresponds to the first UL TCI state, the first DL TCI state, the second UL TCI state, and the second DL TCI state; the TCI codepoint is 001, which corresponds to the first UL TCI state and the first DL TCI state; all unified TCI states activated in the first signaling only correspond to the first UL TCI state and/or the first DL TCI state, and subsequent to overwriting or rewriting or updating, the activated unified TCI states also only correspond to the first UL TCI state and/or the first DL TCI state.

With Respect to the First Signaling being Signaling Used for Activating a Unified TCI State in the Second Version:
All unified TCI states activated in the first signaling satisfy a first condition. In some embodiments, the first condition includes the following contents.
The all unified TCI states activated in the first signaling only correspond to the joint TCI state corresponding to one TRP: or it is understood that the activated joint TCI state of each TCI codepoint corresponds to one TRP: or it is understood that the activated joint TCI state of each TCI codepoint is one joint TCI state, and a case that the activated joint TCI state of any TCI codepoint is two joint TCI states is not present.
The all unified TCI states activated in the first signaling only correspond to the UL TCI state and/or DL TCI state corresponding to one TRP: or it is understood that the activated UL TCI state and/or DL TCI state of each TCI codepoint corresponds to one TRP: or it is understood that the activated UL TCI state of each TCI codepoint is one UL TCI state, and a case that the activated UL TCI state of any TCI codepoint is two UL TCI states is not present: or it is understood that the activated DL TCI state of each TCI codepoint is one DL TCI state, and a case that the activated DL TCI state of any TCI codepoint is two DL TCI states is not present.

In some embodiments, in a case where all unified TCI states activated in the first signaling only correspond to the joint TCI state corresponding to one TRP, the first unified TCI state mode is switched to the second unified TCI state mode. In some embodiments, in a case where all unified TCI states activated in the first signaling only correspond to the UL TCI state and/or the DL TCI state, the first unified TCI state mode is switched to the second unified TCI state mode.

In some embodiments, the activated unified TCI state is overwritten or rewritten or updated using the unified TCI state indicated in the first signaling, so as to switch from the first unified TCI state mode to the second unified TCI state mode.

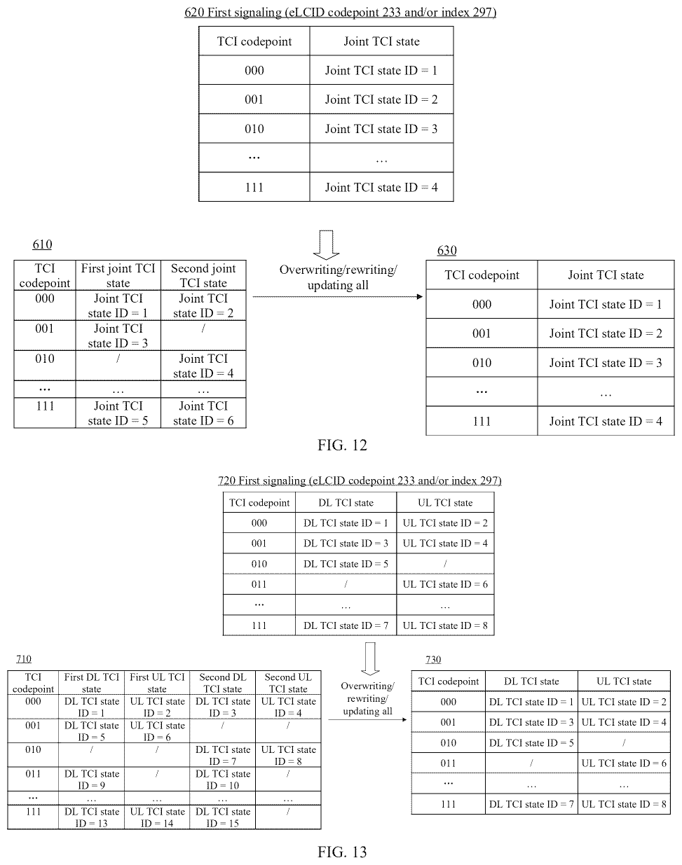

In some embodiments of the present disclosure, the terminal device is in the first unified TCI state mode, that is, in the communication protocol of the R18 version. In the first signaling received by the terminal device, all activated unified TCI states only correspond to the joint TCI state. In this case, the terminal device overwrites or rewrites or updates the activated unified TCI state using the joint TCI state in the first signaling, such that the terminal device switches from the first unified TCI state mode to the second unified TCI state mode. As illustrated in FIG. 12, the table 610 is used to indicate unified TCI states activated prior to receiving the first signaling, the table 620 is used to indicate unified TCI states activated in the first signaling, and the table 630 is used to indicate unified TCI states activated after an overwrite or rewrite or update operation. In a case where the terminal is in the first unified TCI state, the activated unified TCI states include the first joint TCI state and the second joint TCI state. For example, the TCI codepoint is 000, which corresponds to the first joint TCI state and the second joint TCI state; the TCI codepoint is 001, which corresponds to the first joint TCI state; all unified TCI states activated in the first signaling only correspond to the joint TCI state, and subsequent to overwriting or rewriting or updating, the activated unified TCI states also only correspond to the joint TCI state.

In some embodiments of the present disclosure, the terminal device is in the first unified TCI state mode, that is, in the communication protocol of the R18 version. In the first signaling received by the terminal device, all activated unified TCI states only correspond to the UL TCI state and/or the DL TCI state. In this case, the terminal device overwrites or rewrites or updates the activated unified TCI state using the UL TCI state and/or the DL TCI state in the first signaling, such that the terminal device switches from the first unified TCI state mode to the second unified TCI state mode. As illustrated in FIG. 13, the table 710 is used to indicate unified TCI states activated prior to receiving the first signaling, the table 720 is used to indicate unified TCI states activated in the first signaling, and the table 730 is used to indicate unified TCI states activated after an overwrite or rewrite or update operation. In a case where the terminal is in the first unified TCI state, the activated unified TCI states include the first UL TCI state, the first DL TCI state, the second UL TCI state, and the second DL TCI state. For example, the TCI codepoint is 000, which corresponds to the first UL TCI state, the first DL TCI state, the second UL TCI state, and the second DL TCI state; the TCI codepoint is 001, which corresponds to the first UL TCI state and the first DL TCI state; all unified TCI states activated in the first signaling only correspond to the UL TCI state and/or the DL TCI state, and subsequent to overwriting or rewriting or updating, the activated unified TCI states also only correspond to the UL TCI state and/or the DL TCI state.

It should be noted that the above process 310 may be separately implemented as one embodiment, the above process 320 may be separately implemented as one embodiment, and the above processes 310 and 320 may be combined to form one embodiment, which is not limited in the present disclosure.

In summary; in the method according to the embodiments, switching from the first TCI state mode to the second TCI state mode can be achieved over the first signaling. In a case where the UE moves between cells or within a cell, the UE may be proximal to a first TRP and distal to a second TRP. In a case where a significant difference is present in link qualities between the UE and a plurality of TRPs, the UE is not suitable for operating in an MTRP scenario. Therefore, the UE does not need to consume a large number of downlink measurement and reporting resources and store a plurality of unified TCI state resources. The UE may switch from the first unified TCI state mode to the second unified TCI state mode, thereby saving air interface resources and computing resources.

Due to the design of the above TCI codepoint, the terminal device can be implicitly instructed to perform a corresponding switching behavior without modifying the signaling format of the MAC CE in the communication protocol. Therefore, the need for modifications or redesigns of the MAC CE is avoided and the forward compatibility of the MAC CE across different communication versions is ensured.

### 1.2 the Second Unified TCI State Mode is Switched to the First Unified TCI State Mode.

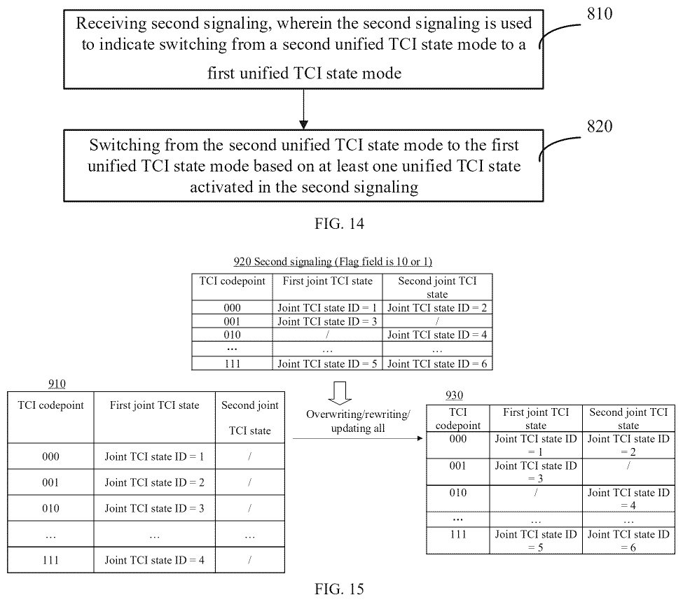

FIG. 14 illustrates a flowchart of a method for switching a TCI state mode according to some embodiments of the present disclosure. The method is performed by the terminal device illustrated in FIG. 3. The method includes the following processes.

In process 810, the terminal device receives second signaling, wherein the second signaling is used to indicate switching from the second unified TCI state mode to the first unified TCI state mode.

In some embodiments, the second signaling is signaling used for activating a unified TCI state.

In process 820, the terminal device switches from the second unified TCI state mode to the first unified TCI state mode based on at least one unified TCI state activated in the second signaling.

In some embodiments, the first unified TCI state mode corresponds to the communication protocol of the R18 version that supports STRP and MTRP, and the second unified TCI state mode corresponds to the communication protocol of the R17 version that supports only STRP. The second signaling is a MAC CE. Each codepoint of the MAC CE corresponding to R17 corresponds to only one unified TCI state, and one codepoint of the MAC CE corresponding to R18 may correspond to one or two unified TCI states.

In some embodiments, at least one unified TCI state activated in the second signaling satisfies a second condition. The second condition herein means that the unified TCI state corresponding to at least one activated TCI codepoint corresponds to two TRPs.

In some embodiments, the second condition includes:
the at least one unified TCI state activated in the second signaling corresponding to a first joint TCI state and a second joint TCI state simultaneously: or
the at least one unified TCI state activated in the second signaling corresponding to a first UL TCI state and a second UL TCI state simultaneously (the DL TCI state may be null, one, or two, which is not limited): or
the at least one unified TCI state activated in the second signaling corresponding to a first DL TCI state and a second DL TCI state simultaneously (the UL TCI state may be null, one, or two, which is not limited); or
the at least one unified TCI state activated in the second signaling corresponding to a first UL TCI state, a second UL TCI state, a first DL TCI state, and a second DL TCI state simultaneously.

In some embodiments, the activated unified TCI state is overwritten or rewritten or updated using the unified TCI state indicated in the second signaling, so as to switch from the second unified TCI state mode to the first unified TCI state mode.

In some embodiments, the terminal device is in the second unified TCI state mode, that is, in the communication protocol of the R17 version, and the activated TCI state is the first joint TCI state. In the second signaling received by the terminal device, at least one activated TCI codepoint corresponds to the first joint TCI state and the second joint TCI state simultaneously. In this case, the terminal device overwrites or rewrites or updates the activated unified TCI state, that is, the first joint TCI state, using the first joint TCI state and the second joint TCI state in the second signaling, such that the terminal device switches from the second unified TCI state mode to the first unified TCI state mode. As illustrated in FIG. 15, the table 910 is used to indicate unified TCI states activated prior to receiving the second signaling, the table 920 is used to indicate unified TCI states activated in the second signaling, and the table 930 is used to indicate unified TCI states activated after an overwrite or rewrite or update operation. The terminal device is in the second unified TCI state prior to receiving the second signaling: the activated unified TCI states include the first joint TCI state; at least one unified TCI codepoint activated in the second signaling corresponds to the first joint TCI state and the second joint TCI state simultaneously; and subsequent to overwriting or rewriting or updating, the at least one activated unified TCI codepoint corresponds to the first joint TCI state and the second joint TCI state simultaneously:

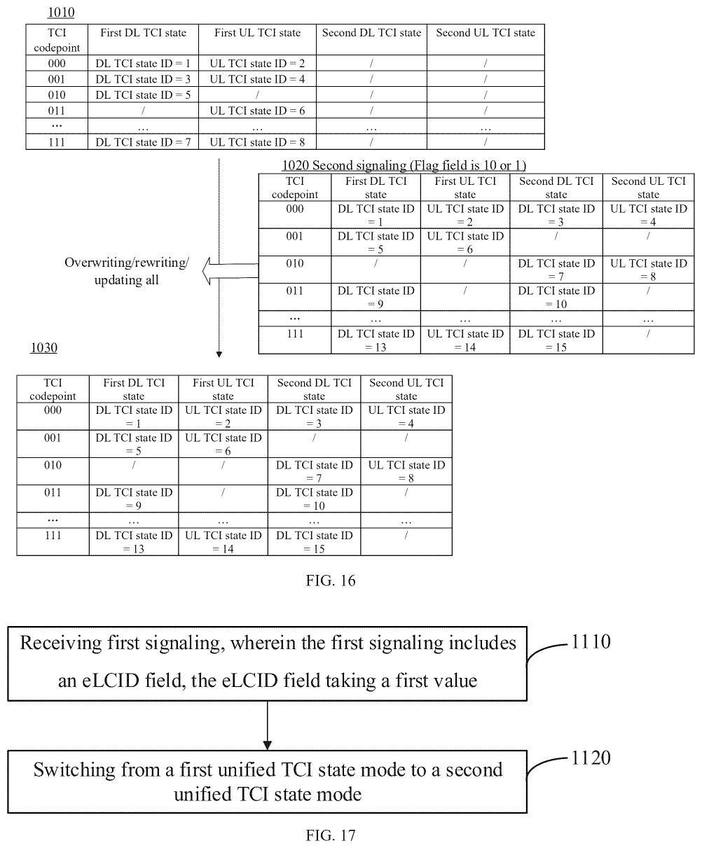

In some embodiments, the terminal device is in the second unified TCI state mode, that is, in the communication protocol of the R17 version, and the activated TCI states are the first UL TCI state and the first DL TCI state. In the second signaling received by the terminal device, at least one activated TCI codepoint corresponds to the first UL TCI state and the second UL TCI state simultaneously. In this case, the terminal device overwrites or rewrites or updates the activated unified TCI states, that is, the first UL TCI state and the first DL TCI state, using the first UL TCI state and the second UL TCI state in the second signaling, such that the terminal device switches from the second unified TCI state mode to the first unified TCI state mode. As illustrated in FIG. 16, the table 1010 is used to indicate unified TCI states activated prior to receiving the second signaling, the table 1020 is used to indicate unified TCI states activated in the second signaling, and the table 1030 is used to indicate unified TCI states activated after an overwrite or rewrite or update operation. The terminal device is in the second unified TCI state prior to receiving the second signaling: the activated unified TCI state only corresponds to the first UL TCI state and/or the first DL TCI state; at least one unified TCI state activated in the second signaling corresponds to the first UL TCI state and the second UL TCI state simultaneously; and subsequent to overwriting or rewriting or updating, the at least one activated unified TCI state corresponds to the first UL TCI state and the second UL TCI state simultaneously:

It should be noted that the above process 810 may be separately implemented as one embodiment, the above process 820 may be separately implemented as one embodiment, and the above processes 810 and 820 may be combined to form one embodiment, which is not limited in the present disclosure.

In summary; in the method according to the embodiments, switching from the second TCI state mode to the first TCI state mode can be achieved over the second signaling. In a case where the UE moves to a cell edge, to enhance the uplink and downlink coverage of the UE, MTRP transmission is more suitable for the UE. Therefore, it is necessary to switch the UE from the second unified TCI state mode to the first unified TCI state mode.

Due to the design of the above TCI codepoint, the terminal device can be implicitly instructed to perform a corresponding switching behavior without modifying the signaling format of the MAC CE in the communication protocol. Therefore, the need for modifications or redesigns of the MAC CE is avoided and the forward compatibility of the MAC CE across different communication versions is ensured.

With respect to Implementation 2: Switching is performed between two unified TCI state modes based on the existing eLCID field in the signaling.

The present disclosure exemplarily illustrates the value range of the eLCID field corresponding to the first version, as illustrated in Table 3.

TABLE 3
Local value of eLCID

| Codepoint | Index | LCID value |
|---|---|---|
| 0 | 64 | . . . |
| . . . | . . . | . . . |
| xxx | yyy | Enhanced unified TCI states activation/deactivation |
| | | MAC CE for multi-TRP |
| . . . | . . . | . . . |
| 226 | 290 | . . . |
| . . . | . . . | . . . |
| 232 | 296 | Enhanced SCell activation/deactivation MAC CE with |
| | | four octet Cᵢ field |
| 233 | 297 | Unified TCI states activation/deactivation MAC CE |
| 234 | 298 | PUCCH power control set update for multiple |
| | | TRP PUCCH repetition MAC CE |
| 235 | 299 | PUCCH spatial relation activation/deactivation for |
| | | multiple TRP PUCCH repetition MAC CE |
| . . . | . . . | . . . |
| 255 | 319 | Timing delta |

The first value is the codepoint 233 and/or the index 297.

The second value is the codepoint xxx and/or the index yyy. The codepoint xxx is any numerical value from 0 to 226, the index yyy is any numerical value from 64 to 290, and the index yyy is the codepoint xxx plus 64.

Since two cases of switching are present between two unified TCI states, the following is categorized into 2.1 and 2.2 for introduction, respectively.

### 2.1 the First Unified TCI State Mode is Switched to the Second Unified TCI State Mode.

FIG. 17 illustrates a flowchart of a method for switching a TCI state mode according to some embodiments of the present disclosure. The method is performed by the terminal device illustrated in FIG. 3. The method includes the following processes.

In process 1110, the terminal device receives first signaling, wherein the first signaling includes an eLCID field, the eLCID field taking a first value.

The value of the eLCID is used to indicate switching from the first unified TCI state mode to the second unified TCI state mode.

In some embodiments of the present disclosure, the value of the eLCID is the first value, wherein the first value is used to indicate switching from the first unified TCI state mode to the second unified TCI state mode.

The first value is a value corresponding to the second version, and the second value is a value corresponding to the first version.

In process 1120, the terminal device switches from the first unified TCI state mode to the second unified TCI state mode.

The first value is a value corresponding to the second version. In some embodiments, the value range of the first value includes the codepoint 233 and/or the index 297.

In some embodiments, the value corresponding to the eLCID of R17 includes the codepoint 233 and the index 297.

In some embodiments, the activated unified TCI state is overwritten or rewritten or updated using the activated joint TCI state in the first signaling.

In some embodiments, the terminal device is in the first unified TCI state mode, that is, in the communication protocol of the R18 version, and the eLCID field in the first signaling received by the terminal device takes the first value. In this case, the terminal device overwrites or rewrites or updates the activated unified TCI state using the joint TCI state in the first signaling, such that the terminal device switches from the first unified TCI state mode to the second unified TCI state mode. As illustrated in FIG. 12, the table 610 is used to indicate unified TCI states activated prior to receiving the first signaling, the table 620 is used to indicate unified TCI states activated in the first signaling, and the table 630 is used to indicate unified TCI states activated after an overwrite or rewrite or update operation. In a case where the terminal is in the first unified TCI state, the activated unified TCI states include the first joint TCI state and the second joint TCI state. For example, the TCI codepoint is 000, which corresponds to the first joint TCI state and the second joint TCI state; the TCI codepoint is 001, which corresponds to the first joint TCI state; the value of the eLCID field in the first signaling is the codepoint 233 and/or the index 297, and subsequent to overwriting or rewriting or updating, the activated unified TCI states also only correspond to the joint TCI state.

In some embodiments, the activated unified TCI state is overwritten or rewritten or updated using the activated UL TCI state and/or the activated DL TCI state in the first signaling.

In some embodiments, the terminal device is in the first unified TCI state mode, that is, in the communication protocol of the R18 version, and the eLCID field in the first signaling received by the terminal device takes the first value. In this case, the terminal device overwrites or rewrites or updates the activated unified TCI state using the UL TCI state and the DL TCI state in the first signaling, such that the terminal device switches from the first unified TCI state mode to the second unified TCI state mode. As illustrated in FIG. 13, the table 710 is used to indicate unified TCI states activated prior to receiving the first signaling, the table 720 is used to indicate unified TCI states activated in the first signaling, and the table 730 is used to indicate unified TCI states activated after an overwrite or rewrite or update operation. In a case where the terminal is in the first unified TCI state, the activated unified TCI states include the first UL TCI state, the first DL TCI state, the second UL TCI state, and the second DL TCI state. For example, the TCI codepoint is 000, which corresponds to the first UL TCI state, the first DL TCI state, the second UL TCI state, and the second DL TCI state; the TCI codepoint is 001, which corresponds to the first UL TCI state and the first DL TCI state; the value of the eLCID field in the first signaling is the codepoint 233 and/or the index 297, and subsequent to overwriting or rewriting or updating, the activated unified TCI states also only correspond to the UL TCI state and/or the DL TCI state.

It should be noted that the above process 1110 may be separately implemented as one embodiment, the above process 1120 may be separately implemented as one embodiment, and the above processes 1110 and 1120 may be combined to form one embodiment, which is not limited in the present disclosure.

In summary; in the method according to the embodiments, switching from the first TCI state mode to the second TCI state mode can be achieved over the first signaling. In a case where the UE moves between cells or within a cell, the UE may be proximal to a first TRP and distal to a second TRP. In a case where a significant difference is present in link qualities between the UE and a plurality of TRPs, the UE is not suitable for operating in an MTRP scenario. Therefore, the UE does not need to consume a large number of downlink measurement and reporting resources and store a plurality of unified TCI state resources. The UE may switch from the first unified TCI state mode to the second unified TCI state mode, thereby saving air interface resources and computing resources.

Since the eLCID field is the existing information field, and the value range of the eLCID is also large, the value of the eLCID is used to indicate the switching of the TCI state modes without modifying the signaling format of the MAC CE in the communication protocol. In addition, without additionally defining the switching behavior of the UE, the terminal device can be instructed to switch from the first unified TCI state mode to the second unified TCI state mode. Therefore, the need for modifications or redesigns of the MAC CE is avoided and the forward compatibility of the MAC CE across different communication versions is ensured.

### 2.2 the Second Unified TCI State Mode is Switched to the First Unified TCI State Mode.

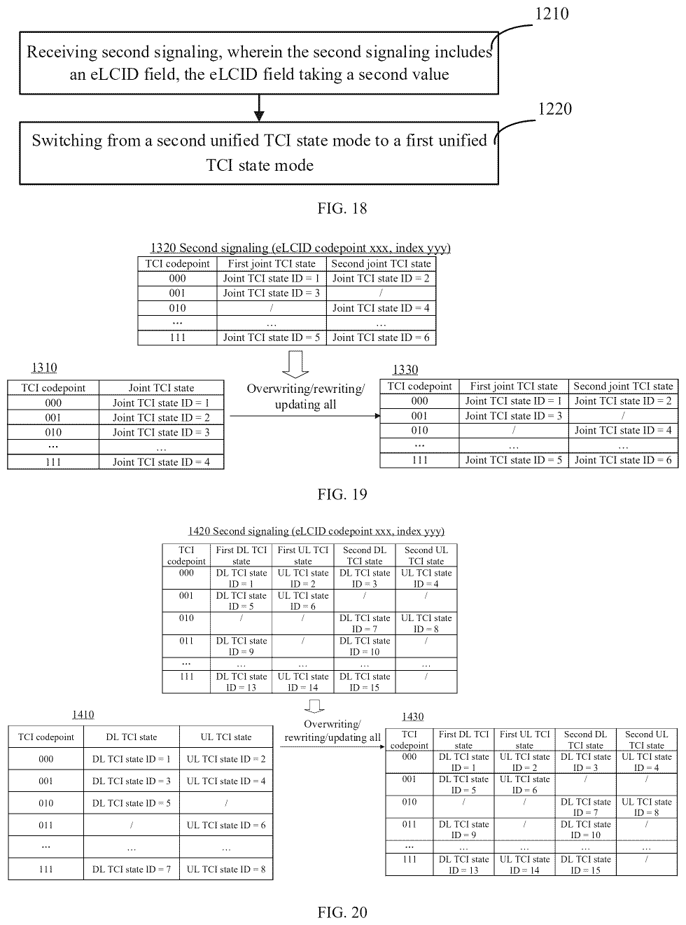

FIG. 18 illustrates a flowchart of a method for switching a TCI state mode according to some embodiments of the present disclosure. The method is performed by the terminal device illustrated in FIG. 3. The method includes the following processes.

In process 1210, the terminal device receives second signaling, wherein the second signaling includes an eLCID field, the eLCID field in the second signaling taking a second value.

The value of the eLCID is used to indicate switching from the second unified TCI state mode to the first unified TCI state mode.

In some embodiments of the present disclosure, the value of the eLCID is the second value, wherein the second value is used to indicate switching from the second unified TCI state mode to the first unified TCI state mode.

The first value is a value corresponding to the second version, and the second value is a value corresponding to the first version.

In some embodiments, a value corresponding to the eLCID of R18 is that the eLCID codepoint ranges from 0 to 226, an index of the eLCID ranges from 64 to 290, and the index of the eLCID is the eLCID codepoint plus 64.

In process 1220, the terminal device switches from the second unified TCI state mode to the first unified TCI state mode.

The activated unified TCI state is overwritten or rewritten or updated using the unified TCI state indicated in the second signaling.

In some embodiments, the activated unified TCI state is overwritten or rewritten or updated using the joint TCI state indicated in the second signaling. In some embodiments, at least one group of joint TCI states activated in the second signaling includes two.

In some embodiments, the terminal device is in the second unified TCI state mode, that is, in the communication protocol of the R17 version, the activated TCI state is the joint TCI state, and the eLCID field in the second signaling received by the terminal device takes the second value. In this case, the terminal device overwrites or rewrites or updates the activated unified TCI state using the first joint TCI state and the second joint TCI state, such that the terminal device switches from the second unified TCI state mode to the first unified TCI state mode. As illustrated in FIG. 19, the table 1310 is used to indicate unified TCI states activated prior to receiving the second signaling, the table 1320 is used to indicate unified TCI states activated in the second signaling, and the table 1330 is used to indicate unified TCI states activated after an overwrite or rewrite or update operation. The terminal device is in the second unified TCI state prior to receiving the second signaling: the activated unified TCI states include the joint TCI state; at least one unified TCI codepoint activated in the second signaling corresponds to the first joint TCI state and the second joint TCI state simultaneously; and subsequent to overwriting or rewriting or updating, the at least one activated unified TCI codepoint corresponds to the first joint TCI state and the second joint TCI state simultaneously.

In some embodiments, the activated unified TCI state is overwritten or rewritten or updated using the UL TCI state and/or the DL TCI state indicated in the second signaling. In separate TCI states corresponding to at least one codepoint activated in the second signaling, two UL TCI states and/or two DL TCI states are present.

In some embodiments, the terminal device is in the second unified TCI state mode, that is, in the communication protocol of the R17 version, the activated TCI state is the UL TCI state, and the eLCID field in the second signaling received by the terminal device takes the second value. In this case, the terminal device overwrites or rewrites or updates the activated unified TCI state using the first UL TCI state and the second UL TCI state, such that the terminal device switches from the second unified TCI state mode to the first unified TCI state mode. As illustrated in FIG. 20, the table 1410 is used to indicate unified TCI states activated prior to receiving the second signaling, the table 1420 is used to indicate unified TCI states activated in the second signaling, and the table 1430 is used to indicate unified TCI states activated after an overwrite or rewrite or update operation. The terminal device is in the second unified TCI state prior to receiving the second signaling: the activated unified TCI state corresponds to only one group of UL TCI states and/or DL TCI states: at least one unified TCI state activated in the second signaling corresponds to the first UL TCI state and the second UL TCI state simultaneously, and subsequent to overwriting or rewriting or updating, the at least one activated unified TCI state corresponds to the first UL TCI state and the second UL TCI state simultaneously:

It should be noted that the above process 1210 may be separately implemented as one embodiment, the above process 1220 may be separately implemented as one embodiment, and the above processes 1210 and 1220 may be combined to form one embodiment, which is not limited in the present disclosure.

In summary, in the method according to the embodiments, switching from the second TCI state mode to the first TCI state mode can be achieved over the second signaling. In a case where the UE moves to a cell edge, to enhance the uplink and downlink coverage of the UE, MTRP transmission is more suitable for the UE. Therefore, it is necessary to switch the UE from the second unified TCI state mode to the first unified TCI state mode.

Since the eLCID field is the existing information field, and the value range of the eLCID is also large, the value of the eLCID can be used to indicate the switching of the TCI state mode only by reusing the meaning of the existing value or using a reserved value as a value corresponding to the first version without modifying the signaling format of the MAC CE in the communication protocol. In addition, without additionally defining the switching behavior of the UE, the terminal device can be instructed to switch from the first unified TCI state mode to the second unified TCI state mode. Therefore, the need for modifications or redesigns of the MAC CE is avoided and the forward compatibility of the MAC CE across different communication versions is ensured.

With respect to Implementation 3: Switching is performed between two unified TCI state modes based on a newly added Flag field in the signaling.

In the present disclosure, a Flag field is newly added or designed to the signaling exemplarily; which is used to instruct the terminal device to switch to a corresponding unified TCI state mode. The Flag field may be designed to be one bit, two bits, or more bits.

In the embodiments of the present disclosure, an example in which the Flag field includes one bit and two bits is used for description. However, the number of bits of the Flag field is not limited.

In Some Embodiments, Flag is Two Bits, Wherein the Two Bits have at Least Three Values.

A first value is a value corresponding to the second version and the first value is used to instruct the terminal device to use the first unified TCI state as a unified TCI state in the second unified TCI state mode in a case where the terminal device switches from the first unified TCI state mode to the second unified TCI state mode.

A second value is a value corresponding to the second version and the second value is used to instruct the terminal device to use the second unified TCI state as a unified TCI state in the second unified TCI state mode in a case where the terminal device switches from the first unified TCI state mode to the second unified TCI state mode.

A third value is a value corresponding to the first version and the third value is used to instruct the terminal device to switch from the second unified TCI state mode to the first unified TCI state mode.

In some embodiments, the first value is any one of 00, 01, 10, or 11: the second value is any one of 00, 01, 10, or 11 except the first value: the third value is any one of 00, 01, 10, or 11 except the first value and the second value. In some embodiments, the first value is 00, the second value is 01, and the third value is 10: or the first value is 01, the second value is 10, and the third value is 00; or the first value is 11, the second value is 00, and the third value is 10. In the embodiments of the present disclosure, an example in which the first value is 00, the second value is 01, and the third value is 10 is used for description. However, the specific values of the first value, the second value, and the third value are not limited.

### 3.1 the First Unified TCI State Mode is Switched to the Second Unified TCI State Mode.

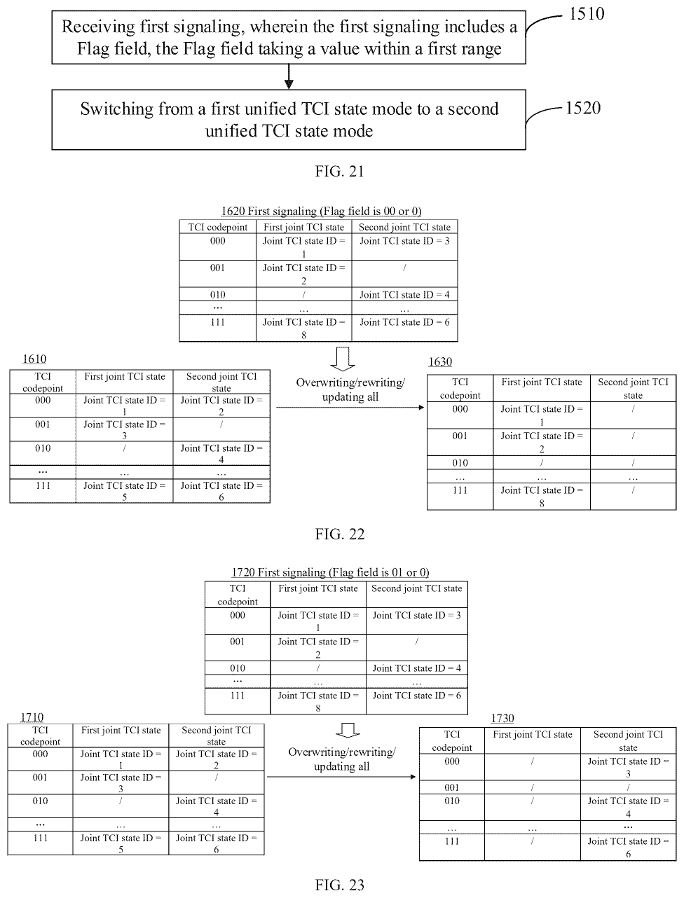

FIG. 21 illustrates a flowchart of a method for switching a TCI state mode according to some embodiments of the present disclosure. The method is performed by the terminal device illustrated in FIG. 3. The method includes the following processes.

In process 1510, the terminal device receives first signaling, wherein the first signaling includes a Flag field, the Flag field taking a value within a first range.

The first signaling is used to indicate switching from the first unified TCI state mode to the second unified TCI state mode. The first range includes values corresponding to the second version.

In some embodiments, two values corresponding to the second version are present in the first range, for example, a first value of 00, and a second value of 01, respectively.

The first value is used to indicate to overwrite or rewrite or update the activated unified TCI state using the first joint TCI state indicated in the first signaling, or to overwrite or rewrite or update the activated unified TCI state using the first UL TCI state and/or the first DL TCI state indicated in the first signaling.

The second value is used to indicate to overwrite or rewrite or update the activated unified TCI state using the second joint TCI state indicated in the first signaling, or to overwrite or rewrite or update the activated unified TCI state using the second UL TCI state and/or the second DL TCI state indicated in the first signaling.

In process 1520, the terminal device switches from the first unified TCI state mode to the second unified TCI state mode.

In some embodiments, in a case where the Flag field takes the first value within the first range, the activated unified TCI state is overwritten or rewritten or updated using the first joint TCI state indicated in the first signaling.

In some embodiments, the terminal device is in the first unified TCI state mode, that is, in the communication protocol of the R18 version, the activated TCI states are the first joint TCI state and the second joint TCI state, and the Flag field in the first signaling received by the terminal device takes 00. In this case, the terminal device overwrites or rewrites or updates the activated unified TCI states, that is, the first joint TCI state and the second joint TCI state, using the first joint TCI state in the first signaling, such that the terminal device switches from the first unified TCI state mode to the second unified TCI state mode. As illustrated in FIG. 22, the table 1610 is used to indicate unified TCI states activated prior to receiving the first signaling, the table 1620 is used to indicate unified TCI states activated in the first signaling, and the table 1630 is used to indicate unified TCI states activated after an overwrite or rewrite or update operation. The terminal device is in the first unified TCI state prior to receiving the first signaling, and the activated unified TCI states include the first joint TCI state and the second joint TCI state. For example, the TCI codepoint is 000, which corresponds to the first joint TCI state and the second joint TCI state; the TCI codepoint is 001, which corresponds to the first joint TCI state; the Flag field in the first signaling takes 00, and the activated unified TCI state is overwritten or rewritten or updated using the first joint TCI state in the first signaling.

In some embodiments, in a case where the Flag field takes the second value within the first range, the activated unified TCI state is overwritten or rewritten or updated using the second joint TCI state indicated in the first signaling.

In some embodiments, the terminal device is in the first unified TCI state mode, that is, in the communication protocol of the R18 version, the activated TCI states are the first joint TCI state and the second joint TCI state, and the Flag field in the first signaling received by the terminal device takes 01. In this case, the terminal device overwrites or rewrites or updates the activated unified TCI states, that is, the first joint TCI state and the second joint TCI state, using the second joint TCI state in the first signaling, such that the terminal device switches from the first unified TCI state mode to the second unified TCI state mode. As illustrated in FIG. 23, the table 1710 is used to indicate unified TCI states activated prior to receiving the first signaling, the table 1720 is used to indicate unified TCI states activated in the first signaling, and the table 1730 is used to indicate unified TCI states activated after an overwrite or rewrite or update operation. The terminal device is in the first unified TCI state prior to receiving the first signaling, and the activated unified TCI states include the first joint TCI state and the second joint TCI state. For example, the TCI codepoint is 000, which corresponds to the first joint TCI state and the second joint TCI state; the TCI codepoint is 001, which corresponds to the first joint TCI state; the Flag field in the first signaling takes 01, and the activated unified TCI state is overwritten or rewritten or updated using the second joint TCI state in the first signaling.

In some embodiments, in a case where the Flag field takes the first value within the first range, the activated unified TCI state is overwritten or rewritten or updated using the first UL TCI state and/or the first DL TCI state indicated in the first signaling.

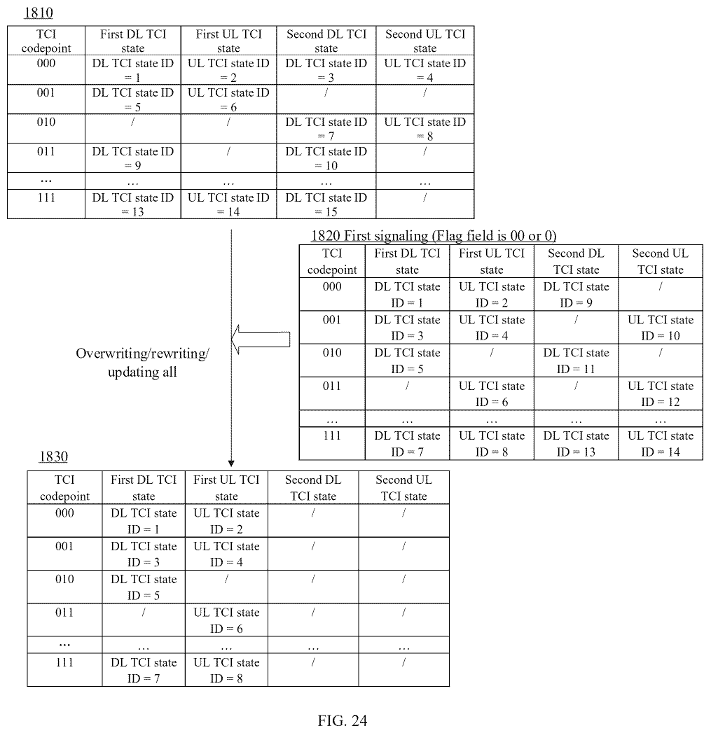

In some embodiments, the terminal device is in the first unified TCI state mode, that is, in the communication protocol of the R18 version, and the Flag field in the first signaling received by the terminal device takes 00. In this case, the terminal device overwrites or rewrites or updates the activated unified TCI state using the first UL TCI state and/or the first DL TCI state in the first signaling, such that the terminal device switches from the first unified TCI state mode to the second unified TCI state mode. As illustrated in FIG. 24, the table 1810 is used to indicate unified TCI states activated prior to receiving the first signaling, the table 1820 is used to indicate unified TCI states activated in the first signaling, and the table 1830 is used to indicate unified TCI states activated after an overwrite or rewrite or update operation. The terminal device is in the first unified TCI state prior to receiving the first signaling, and the activated unified TCI states include the first UL TCI state, the first DL TCI state, the second UL TCI state, and the second DL TCI state. For example, the TCI codepoint is 000, which corresponds to the first UL TCI state, the first DL TCI state, the second UL TCI state, and the second DL TCI state; the TCI codepoint is 001, which corresponds to the first UL TCI state and the first DL TCI state; the Flag field in the first signaling takes 00, and the activated unified TCI state is overwritten or rewritten or updated using the first UL TCI state and/or the first DL TCI state in the first signaling.

In some embodiments, in a case where the Flag field takes the second value within the first range, the activated unified TCI state is overwritten or rewritten or updated using the second UL TCI state and/or the second DL TCI state indicated in the first signaling.

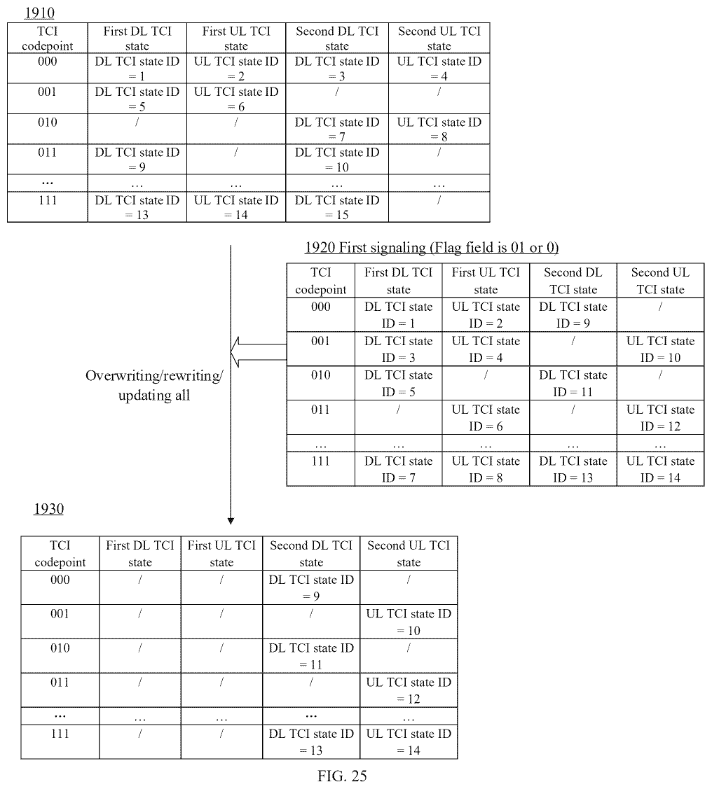

In some embodiments, the terminal device is in the first unified TCI state mode, that is, in the communication protocol of the R18 version, and the Flag field in the first signaling received by the terminal device takes 01. In this case, the terminal device overwrites or rewrites or updates the activated unified TCI state using the second UL TCI state and/or the second DL TCI state in the first signaling, such that the terminal device switches from the first unified TCI state mode to the second unified TCI state mode. As illustrated in FIG. 25, the table 1910 is used to indicate unified TCI states activated prior to receiving the first signaling, the table 1920 is used to indicate unified TCI states activated in the first signaling, and the table 1930 is used to indicate unified TCI states activated after an overwrite or rewrite or update operation. The terminal device is in the first unified TCI state prior to receiving the first signaling, and the activated unified TCI states include the first UL TCI state, the first DL TCI state, the second UL TCI state, and the second DL TCI state. For example, the TCI codepoint is 000, which corresponds to the first UL TCI state, the first DL TCI state, the second UL TCI state, and the second DL TCI state; the TCI codepoint is 001, which corresponds to the first UL TCI state and the first DL TCI state; the Flag field in the first signaling takes 01, and the activated unified TCI state is overwritten or rewritten or updated using the second UL TCI state and/or the second DL TCI state in the first signaling.

It should be noted that the above process 1510 may be separately implemented as one embodiment, the above process 1520 may be separately implemented as one embodiment, and the above processes 1510 and 1520 may be combined to form one embodiment, which is not limited in the present disclosure.

### 3.2 the Second Unified TCI State Mode is Switched to the First Unified TCI State Mode.

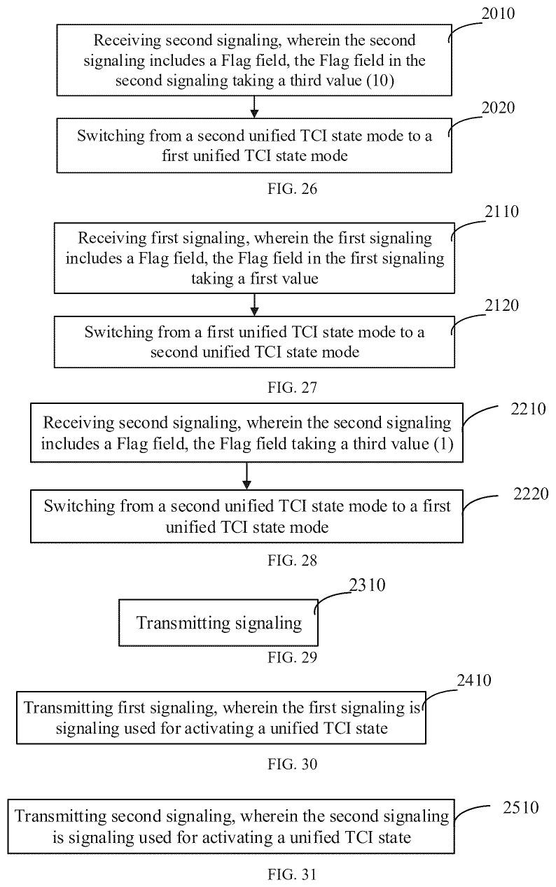

FIG. 26 illustrates a flowchart of a method for switching a TCI state mode according to some embodiments of the present disclosure. The method is performed by the terminal device illustrated in FIG. 3. The method includes the following processes.

In process 2010, the terminal device receives second signaling, wherein the second signaling includes a Flag field, the Flag field in the second signaling taking a third value (10).

The third value is a value corresponding to the first version.

In some embodiments, the Flag field in the second signaling takes the third value, wherein this Flag field is used to indicate switching from the second unified TCI state mode to the first unified TCI state mode.

In process 2020, the terminal device switches from the second unified TCI state mode to the first unified TCI state mode.

In some embodiments, the terminal device is in the second unified TCI state mode, that is, in the communication protocol of the R17 version, and the Flag field in the second signaling received by the terminal device takes 10. In this case, the terminal device overwrites or rewrites or updates the activated unified TCI state using the first joint TCI state and the second TCI state in the second signaling, such that the terminal device switches from the second unified TCI state mode to the first unified TCI state mode. As illustrated in FIG. 15, the table 910 is used to indicate unified TCI states activated prior to receiving the second signaling, the table 920 is used to indicate unified TCI states activated in the second signaling, and the table 930 is used to indicate unified TCI states activated after an overwrite or rewrite or update operation. The terminal device is in the second unified TCI state prior to receiving the second signaling: the activated unified TCI states include the first joint TCI state; the Flag field in the second signaling takes 10: the activated unified TCI state is overwritten or rewritten or updated using the first joint TCI state and the second joint TCI in the second signaling.

In some embodiments, in a case where the Flag field in the second signaling takes the third value, the activated unified TCI state is overwritten or rewritten or updated using the first UL TCI state and/or the first DL TCI state and/or the second UL TCI state and/or the second DL TCI state indicated in the second signaling.

In some embodiments, the terminal device is in the second unified TCI state mode, that is, in the communication protocol of the R17 version, and the Flag field in the second signaling received by the terminal device takes 10. In this case, the terminal device overwrites or rewrites or updates the activated unified TCI state using the unified TCI state activated in the second signaling, such that the terminal device switches from the second unified TCI state mode to the first unified TCI state mode. As illustrated in FIG. 16, the table 1010 is used to indicate unified TCI states activated prior to receiving the second signaling, the table 1020 is used to indicate unified TCI states activated in the second signaling, and the table 1030 is used to indicate unified TCI states activated after an overwrite or rewrite or update operation. The terminal device is in the second unified TCI state prior to receiving the second signaling: the activated unified TCI state only corresponds to the first UL TCI state and/or the first DL TCI state; the Flag field in the second signaling takes 10: the activated unified TCI state is overwritten or rewritten or updated using the first UL TCI state and/or the first DL TCI state and/or the second UL TCI state and/or the second DL TCI state in the second signaling.

It should be noted that the above process 2010 may be separately implemented as one embodiment, the above process 2020 may be separately implemented as one embodiment, and the above processes 2010 and 2020 may be combined to form one embodiment, which is not limited in the present disclosure.

### In Some Embodiments of the Present Disclosure, Flag is One Bit, Wherein the One Bit has Two Values.

A first value is a value corresponding to the second version and the first value is used to instruct the terminal device to switch from the first unified TCI state mode to the second unified TCI state mode.

A third value is a value corresponding to the first version and the third value is used to instruct the terminal device to switch from the second unified TCI state mode to the first unified TCI state mode.

In some embodiments, the first value is any one of 0 or 1: the second value is any one of 0 or 1 except the first value. In some embodiments, the first value is 0, and the third value is 1: or the first value is 1, and the third value is 0. In the embodiments of the present disclosure, an example in which the first value is 0 and the third value is 1 is used for description. However, the specific values of the first value and the second value are not limited.

### 3.3 the First Unified TCI State Mode is Switched to the Second Unified TCI State Mode.

FIG. 27 illustrates a flowchart of a method for switching a TCI state mode according to some embodiments of the present disclosure. The method is performed by the terminal device illustrated in FIG. 3. The method includes the following processes.

In process 2110, the terminal device receives first signaling, wherein the first signaling includes a Flag field, the Flag field in the first signaling taking a first value.

The first signaling is used to indicate switching from the first unified TCI state mode to the second unified TCI state mode. The first value is a value corresponding to the second version.

In process 2120, the terminal device switches from the first unified TCI state mode to the second unified TCI state mode.

In some embodiments, the activated unified TCI state is overwritten or rewritten or updated using the first joint TCI state indicated in the first signaling by default.

In some embodiments, the terminal device is in the first unified TCI state mode, that is, in the communication protocol of the R18 version, and the Flag field in the first signaling received by the terminal device takes 0. In this case, the terminal device overwrites or rewrites or updates the activated unified TCI state using the first joint TCI state in the first signaling, such that the terminal device switches from the first unified TCI state mode to the second unified TCI state mode. As illustrated in FIG. 22, the table 1610 is used to indicate unified TCI states activated prior to receiving the first signaling, the table 1620 is used to indicate unified TCI states activated in the first signaling, and the table 1630 is used to indicate unified TCI states activated after an overwrite or rewrite or update operation. The terminal device is in the first unified TCI state prior to receiving the first signaling, and the activated unified TCI states include the first joint TCI state and the second joint TCI state. For example, the TCI codepoint is 000, which corresponds to the first joint TCI state and the second joint TCI state; the TCI codepoint is 001, which corresponds to the first joint TCI state; the Flag field in the first signaling takes 0, and the activated unified TCI state is overwritten or rewritten or updated using the first joint TCI state in the first signaling.

In some embodiments, the activated unified TCI state is overwritten or rewritten or updated using the second joint TCI state indicated in the first signaling by default.

In some embodiments, the terminal device is in the first unified TCI state mode, that is, in the communication protocol of the R18 version, and the Flag field in the first signaling received by the terminal device takes 0. In this case, the terminal device overwrites or rewrites or updates the activated unified TCI state using the second joint TCI state in the first signaling, such that the terminal device switches from the first unified TCI state mode to the second unified TCI state mode. As illustrated in FIG. 23, the table 1710 is used to indicate unified TCI states activated prior to receiving the first signaling, the table 1720 is used to indicate unified TCI states activated in the first signaling, and the table 1730 is used to indicate unified TCI states activated after an overwrite or rewrite or update operation. The terminal device is in the first unified TCI state prior to receiving the first signaling, and the activated unified TCI states include the first joint TCI state and the second joint TCI state. For example, the TCI codepoint is 000, which corresponds to the first joint TCI state and the second joint TCI state; the TCI codepoint is 001, which corresponds to the first joint TCI state; the Flag field in the first signaling takes 0, and the activated unified TCI state is overwritten or rewritten or updated using the second joint TCI state in the first signaling.

In some embodiments, the activated unified TCI state is overwritten or rewritten or updated using the first UL and/or DL TCI state indicated in the first signaling by default.

In some embodiments, the terminal device is in the first unified TCI state mode, that is, in the communication protocol of the R18 version, and the Flag field in the first signaling received by the terminal device takes 0. In this case, the terminal device overwrites or rewrites or updates the activated unified TCI state using the first UL TCI state and the first DL TCI state in the first signaling, such that the terminal device switches from the first unified TCI state mode to the second unified TCI state mode. As illustrated in FIG. 24, the table 1810 is used to indicate unified TCI states activated prior to receiving the first signaling, the table 1820 is used to indicate unified TCI states activated in the first signaling, and the table 1830 is used to indicate unified TCI states activated after an overwrite or rewrite or update operation. The terminal device is in the first unified TCI state prior to receiving the first signaling, and the activated unified TCI states include the first UL TCI state, the first DL TCI state, the second UL TCI state, and the second DL TCI state. For example, the TCI codepoint is 000, which corresponds to the first UL TCI state, the first DL TCI state, the second UL TCI state, and the second DL TCI state; the TCI codepoint is 001, which corresponds to the first UL TCI state and the first DL TCI state; the Flag field in the first signaling takes 0, and the activated unified TCI state is overwritten or rewritten or updated using the first UL TCI state and/or the first DL TCI state in the first signaling.

In some embodiments, the activated unified TCI state is overwritten or rewritten or updated using the second UL and/or DL TCI state indicated in the first signaling by default.

In some embodiments, the terminal device is in the first unified TCI state mode, that is, in the communication protocol of the R18 version, and the Flag field in the first signaling received by the terminal device takes 0. In this case, the terminal device overwrites or rewrites or updates the activated unified TCI state using the first UL TCI state and the first DL TCI state in the first signaling, such that the terminal device switches from the first unified TCI state mode to the second unified TCI state mode. As illustrated in FIG. 25, the table 1910 is used to indicate unified TCI states activated prior to receiving the first signaling, the table 1920 is used to indicate unified TCI states activated in the first signaling, and the table 1930 is used to indicate unified TCI states activated after an overwrite or rewrite or update operation. In a case where the terminal device is in the first unified TCI state, the activated unified TCI states include the first UL TCI state, the first DL TCI state, the second UL TCI state, and the second DL TCI state. For example, the TCI codepoint is 000, which corresponds to the first UL TCI state, the first DL TCI state, the second UL TCI state, and the second DL TCI state; the TCI codepoint is 001, which corresponds to the first UL TCI state and the first DL TCI state; the Flag field in the first signaling takes 0, and the activated unified TCI state is overwritten or rewritten or updated using the second UL TCI state and/or the second DL TCI state in the first signaling.

It should be noted that the above process 2110 may be separately implemented as one embodiment, the above process 2120 may be separately implemented as one embodiment, and the above processes 2110 and 2120 may be combined to form one embodiment, which is not limited in the present disclosure.

### 3.4 the Second Unified TCI State Mode is Switched to the First Unified TCI State Mode.

FIG. 28 illustrates a flowchart of a method for switching a TCI state mode according to some embodiments of the present disclosure. The method is performed by the terminal device illustrated in FIG. 3. The method includes the following processes.

In process 2210, the terminal device receives second signaling, wherein the second signaling includes a Flag field, the Flag field in the second signaling taking a third value.

In process 2220, the terminal device switches from the second unified TCI state to the first unified TCI state mode.

The third value is a value corresponding to the first version.

In some embodiments, the activated unified TCI state is overwritten or rewritten or updated using the first joint TCI state and the second joint TCI indicated (i.e., activated) in the second signaling.

In some embodiments, the terminal device is in the second unified TCI state mode, that is, in the communication protocol of the R17 version, and the Flag field in the second signaling received by the terminal device takes 1. In this case, the terminal device overwrites or rewrites or updates the activated unified TCI state using the first joint TCI state and the second joint TCI state in the second signaling, such that the terminal device switches from the second unified TCI state mode to the first unified TCI state mode. As illustrated in FIG. 15, the table 910 is used to indicate unified TCI states activated prior to receiving the second signaling, the table 920 is used to indicate unified TCI states activated in the second signaling, and the table 930 is used to indicate unified TCI states activated after an overwrite or rewrite or update operation. The terminal device is in the second unified TCI state prior to receiving the second signaling; the activated unified TCI states include the first joint TCI state; the Flag field in the second signaling takes 1: the activated unified TCI state is overwritten or rewritten or updated using the first joint TCI state and the second joint TCI in the second signaling.

In some embodiments, the activated unified TCI state is overwritten or rewritten or updated using the unified TCI state indicated in the second signaling (including eight groups at most, each group of unified TCI states including one or more of the first UL TCI state, the first DL TCI state, the second UL TCI state, and the second DL TCI state).

In some embodiments, the terminal device is in the second unified TCI state mode, that is, in the communication protocol of the R17 version, and the Flag field in the second signaling received by the terminal device takes 1. In this case, the terminal device overwrites or rewrites or updates the activated unified TCI state using the first UL TCI state and the second UL TCI state in the second signaling, such that the terminal device switches from the second unified TCI state mode to the first unified TCI state mode. As illustrated in FIG. 16, the table 1010 is used to indicate unified TCI states activated prior to receiving the second signaling, the table 1020 is used to indicate unified TCI states activated in the second signaling, and the table 1030 is used to indicate unified TCI states activated after an overwrite or rewrite or update operation. The terminal device is in the second unified TCI state prior to receiving the second signaling: the activated unified TCI state only corresponds to the first UL TCI state and/or the first DL TCI state; the Flag field in the second signaling takes 1: the activated unified TCI state is overwritten or rewritten or updated using the unified TCI state in the second signaling.

It should be noted that the above process 2210 may be separately implemented as one embodiment, the above process 2220 may be separately implemented as one embodiment, and the above processes 2210 and 2220 may be combined to form one embodiment, which is not limited in the present disclosure.

In summary; the method for switching a TCI state mode according to the present disclosure is implemented by newly adding or designing a Flag field. Although the packet format of the MAC CE is changed, the solutions can explicitly and accurately instruct the terminal device to switch between two unified TCI states.

In a case where the UE moves between cells or within a cell, the UE may be proximal to a first TRP and distal to a second TRP. In a case where a significant difference is present in link qualities between the UE and a plurality of TRPs, the UE is not suitable for operating in an MTRP scenario. Therefore, the UE does not need to consume a large number of downlink measurement and reporting resources and store a plurality of unified TCI state resources, and the UE may switch from the first unified TCI state mode to the second unified TCI state mode. On the contrary, in a case where the UE moves to a cell edge, to enhance the uplink and downlink coverage of the UE, MTRP transmission is more suitable for the UE, and the UE may switch from the second unified TCI state mode to the first unified TCI state mode, thereby satisfying requirements in different transmission scenarios.

In the above embodiments, an example in which the first information field is the eLCID field or the first information field is the Flag field is used for description, but it is not excluded that in some other embodiments, other information fields in the MAC CE are used as the first information field to indicate switching between two TCI state modes, which is not limited in the embodiments of the present disclosure.

In some embodiments, switching between the two unified TCI state modes is applicable to all carriers in a first carrier list, wherein all the carriers in the first carrier list are a plurality of carriers of a common beam.

The common beam means that in a case where a plurality of component carriers (CCs) are configured in the first carrier list, and in a case where any one of the CCs receives the signaling, triggering a switch between the two unified TCI state modes, then the process is applicable to all other CCs in the first carrier list.

In some embodiments, a plurality of serving cells are configured in the same CC list, that is, a CC list of common beam operations. After the UE receives the MAC CE of the unified TCI state corresponding to R18 and the switching of the unified TCI state modes of R18 and R17 occurs, and moreover, in a case where the serving cell ID in the MAC CE is configured in a CC list of common beam operations, such as the TCI synchronization update list XsimultaneousU-TCI-Update ListX, the TCI synchronization update list YsimultaneousU-TCI-UpdateListY, and the TCI synchronization update list ZsimultaneousU-TCI-UpdateListZ, the UE switches the unified TCI state modes of all serving cells in the CC list, that is, switches from R18 to the 17 mode or vice versa.

In some embodiments, capability information is reported, wherein the capability information is used to indicate to the network device whether the terminal device supports the capability of switching between different unified TCI state modes.

In some embodiments, Implementation 1 and Implementation 2 are combined and implemented as an independent embodiment: Implementation 1 and Implementation 3 are combined and implemented as an independent embodiment: Implementation 2 and Implementation 3 are combined and implemented as an independent embodiment: Implementation 1, Implementation 2, and Implementation 3 are combined and implemented as an independent embodiment, which are not listed one by one in the embodiments of the present disclosure, but the protection scope of the present disclosure is not limited thereto.

FIG. 29 illustrates a flowchart of a method for switching a TCI state mode according to some embodiments of the present disclosure. The method is performed by the network device illustrated in FIG. 3. The method includes the following processes.

In process 2310, the network device transmits signaling, wherein the signaling is used to instruct a terminal device to switch between two unified TCI state modes.

The two unified TCI state modes include a first unified TCI state mode and a second unified TCI state mode. The first unified TCI state mode corresponds to a communication protocol of a first version, and the second unified TCI state mode corresponds to a communication protocol of a second version, the first version being different from the second version.

In some embodiments, the first unified TCI state mode supports both STRP and MTRP, and the second unified TCI state mode supports STRP. In some embodiments, the communication protocol of the first version supports STRP and MTRP, and the communication protocol of the second version supports STRP. In some embodiments, the communication protocol of the first version is a communication protocol of an R18 version, and the communication protocol of the second version is a communication protocol of an R17 version: alternatively, the communication protocol of the first version is a communication protocol of an R19 version, and the communication protocol of the second version is a communication protocol of an R17 version. The specific version numbers of the two versions of the communication protocols are not limited in the embodiments.

In some embodiments, the terminal device switches from the first unified TCI state mode to the second unified TCI state mode based on first signaling: alternatively, the terminal device switches from the second unified TCI state mode to the first unified TCI state mode based on second signaling. In a case where the first version is higher than the second version, the terminal device falls back from the first unified TCI state mode to the second unified TCI state mode based on the first signaling.

In some embodiments, switching between the two unified TCI state modes is applicable to all carriers in a first carrier list, wherein all the carriers in the first carrier list are a plurality of carriers of a common beam.

The common beam means that in a case where a plurality of component carriers (CCs) are configured in the first carrier list, and in a case where any one of the CCs receives the signaling, triggering a switch between the two unified TCI state modes, then the process is applicable to all other CCs in the first carrier list.

In summary; in the method according to the present disclosure, in a case where the terminal device needs to be switched from the first unified TCI state mode to the second unified TCI state mode, the communication protocol of the terminal device is switched from the first version to the second version; alternatively, in a case where the terminal device needs to be switched from the second unified TCI state mode to the first unified TCI state mode, the communication protocol of the terminal device is switched back from the second version to the first version.

In some embodiments, the signaling is signaling used for configuring a unified TCI state, such as RRC signaling: alternatively, the first signaling is signaling used for activating a unified TCI state, such as MAC CE; alternatively, the first signaling is signaling used for indicating a unified TCI state, such as DCI. In the embodiments of the present disclosure, an example in which the signaling is signaling used for activating a unified TCI state is used for description.

The present disclosure illustrates three implementations of transmitting signaling (that is, signaling used for activating a unified TCI state), wherein the signaling is used to instruct a terminal device to switch between two unified TCI state modes. At least one of the three implementations may be used in different embodiments. The three implementations are as follows.

Implementation 1: Signaling is transmitted, wherein the signaling includes an information field for activating a unified TCI state, which is used to indicate switching between two unified TCI state modes.

Implementation 2: Signaling is transmitted, wherein the signaling includes an eLCID field, which is used to indicate switching between two unified TCI state modes.

Implementation 3: Signaling is transmitted, wherein the signaling includes a Flag field, which is used to indicate switching between two unified TCI state modes.

The three implementations are sequentially described hereinafter, but the introduction sequence of the three implementations does not limit the superiority or inferiority of the three implementations.

With respect to Implementation 1: Signaling is transmitted, wherein the signaling includes an information field for activating a unified TCI state, which is used to indicate switching between two unified TCI state modes.

Since two cases of switching between two unified TCI states are present, the following is categorized into 1.1 and 1.2 for introduction, respectively.

### 1.1 the First Unified TCI State Mode is Switched to the Second Unified TCI State Mode.

FIG. 30 illustrates a flowchart of a method for switching a TCI state mode according to some embodiments of the present disclosure. The method is performed by the network device illustrated in FIG. 3. The method includes the following processes.

In process 2410, the network device transmits first signaling, wherein the first signaling is signaling used for activating a unified TCI state.

In some embodiments, the first signaling is signaling used for activating a unified TCI state in the first version: alternatively, the first signaling is signaling used for activating a unified TCI state in the second version.

With Respect to the First Signaling being Signaling Used for Activating a Unified TCI State in the First Version:

In some embodiments, all unified TCI states activated in the first signaling satisfy a first condition. The first condition includes:
the all unified TCI states activated in the first signaling only corresponding to a first joint TCI state; or
the all unified TCI states activated in the first signaling only corresponding to a second joint TCI state; or
the all unified TCI states activated in the first signaling only corresponding to a first UL TCI state and/or a first DL TCI state; or
the all unified TCI states activated in the first signaling only corresponding to a second UL TCI state and/or a second DL TCI state.
   With Respect to the First Signaling being Signaling Used for Activating a Unified TCI State in the Second Version:

In some embodiments, all unified TCI states activated in the first signaling satisfy a first condition. The first condition includes:
the all unified TCI states activated in the first signaling only corresponding to the joint TCI state; or
the all unified TCI states activated in the first signaling only corresponding to the UL TCI state and/or the DL TCI state.

In some embodiments, the terminal device overwrites or rewrites or updates the activated unified TCI state using the unified TCI state indicated in the first signaling, so as to switch from the first unified TCI state mode to the second unified TCI state mode. The specific embodiments are illustrated in embodiments corresponding to FIG. 9.

### 1.2 the Second Unified TCI State Mode is Switched to the First Unified TCI State Mode.

FIG. 31 illustrates a flowchart of a method for switching a TCI state mode according to some embodiments of the present disclosure. The method is performed by the network device illustrated in FIG. 3. The method includes the following processes.

In process 2510, the network device transmits second signaling, wherein the second signaling is a signaling used for activating a unified TCI state.

In some embodiments, the first unified TCI state mode corresponds to the communication protocol of the R18 version that supports STRP and MTRP, and the second unified TCI state mode corresponds to the communication protocol of the R17 version that supports only STRP. The second signaling is a MAC CE. Each codepoint of the MAC CE corresponding to R17 only corresponds to one unified TCI state, and one codepoint of the MAC CE corresponding to R18 may correspond to one or two unified TCI states.

The second signaling is used to indicate switching from the second unified TCI state to the first unified TCI state. At least one unified TCI state activated in the second signaling satisfies a second condition. In some embodiments, the second condition includes:
in some embodiments, the at least one unified TCI state activated in the second signaling corresponding to a first joint TCI state and a second joint TCI state simultaneously: or
in some embodiments, the at least one unified TCI state activated in the second signaling corresponding to a first UL TCI state and a second UL TCI state simultaneously: or
in some embodiments, the at least one unified TCI state activated in the second signaling corresponding to a first DL TCI state and a second DL TCI state simultaneously: or
in some embodiments, the at least one unified TCI state activated in the second signaling corresponds to a first UL TCI state, a second UL TCI state, a first DL TCI state, and a second DL TCI state simultaneously.

In some embodiments, the terminal device overwrites or rewrites or updates the activated unified TCI state using the unified TCI state indicated in the second signaling. The specific method is illustrated in embodiments corresponding to FIG. 14.

In summary; the method for switching a TCI state mode according to the present disclosure uses the activated unified TCI state as an implicit indication. For example, in a case where all unified TCI states activated in the signaling only correspond to the first joint TCI state, it is considered that the terminal device needs to fall back to the second version that supports only STRP: in a case where at least one unified TCI state activated in the signaling corresponds to the first UL TCI state and the second UL TCI state simultaneously, it is considered that the terminal device needs to switch to the first version that supports MTRP. Based on the method, not only can the switching intention of the terminal device be identified, but also the original MAC CE packet format can be used for determination, thereby better accommodating the earlier version to achieve switching between unified TCI state modes.

With respect to Implementation 2: Signaling is transmitted, wherein the signaling includes an eLCID field, wherein the eLCID field is used to indicate switching between two unified TCI state modes.

The present disclosure exemplarily illustrates the value range of the eLCID field corresponding to the first version, as illustrated in Table 3.

The first value is the codepoint 233 and/or the index 297.

The second value is the codepoint xxx and/or the index yyy. The codepoint xxx is any numerical value from 0 to 226, the index yyy is any numerical value from 64 to 290, and the index yyy is the codepoint xxx plus 64.

Since two cases of switching between two unified TCI states are present, the following is categorized into 2.1 and 2.2 for introduction, respectively.

### 2.1 the First Unified TCI State Mode is Switched to the Second Unified TCI State Mode.

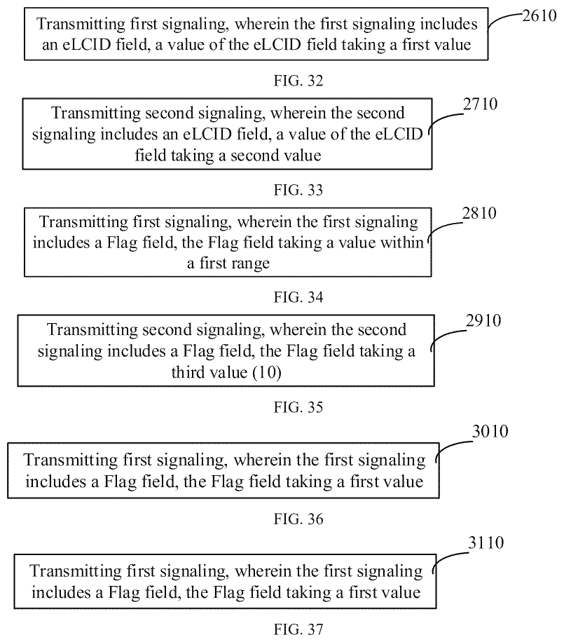

FIG. 32 illustrates a flowchart of a method for switching a TCI state mode according to some embodiments of the present disclosure. The method is performed by the network device illustrated in FIG. 3. The method includes the following processes.

In process 2610, the network device transmits first signaling, wherein the first signaling includes an eLCID field, a value of the eLCID field being a first value, wherein this eLCID field is used to instruct a terminal device to switch from the first unified TCI state mode to the second unified TCI state mode.

The first value is a value corresponding to the second version.

In some embodiments, the value range of the first value includes the codepoint 233 and/or the index 297.

In some embodiments, the value corresponding to the eLCID of R17 includes the codepoint 233 and the index 297.

In some embodiments, the terminal device overwrites or rewrites or updates the activated unified TCI state using the joint TCI state indicated in the first signaling. The specific method is illustrated in embodiments corresponding to FIG. 17.

### 2.2 the Second Unified TCI State Mode is Switched to the First Unified TCI State Mode.

FIG. 33 illustrates a flowchart of a method for switching a TCI state mode according to some embodiments of the present disclosure. The method is performed by the network device illustrated in FIG. 3. The method includes the following processes.

In process 2710, the network device transmits second signaling, wherein the second signaling includes an eLCID field, a value of the eLCID field being a second value, wherein the eLCID field is used to instruct the terminal device to switch from the second unified TCI state mode to the first unified TCI state mode.

The second value is a value corresponding to the first version.

In some embodiments, a value corresponding to the eLCID of R18 is that the eLCID codepoint ranges from 0 to 226, an index of the eLCID ranges from 64 to 290, and the index of the eLCID is the eLCID codepoint plus 64. The terminal device determines, based on the value of the eLCID in the second signaling, whether to switch from the second unified TCI state mode to the first unified TCI state mode.

In some embodiments, the terminal device overwrites or rewrites or updates the activated unified TCI state using the unified TCI state indicated in the second signaling. The specific method is illustrated in embodiments corresponding to FIG. 18.

In summary, in the method for switching a TCI state mode according to the present disclosure, by using different designed values of the eLCID in the signaling, switching can be achieved between two unified TCI states by only modifying the existing value or setting a reserved value to a value corresponding to the first version. The overall format and length of the packet are not affected and better accommodation to different versions is achieved. In addition, for the terminal device, the switching instruction in the solutions is clearer and more specific.

With respect to Implementation 3: Signaling is transmitted, wherein the signaling includes a Flag field, which is used to indicate switching between two unified TCI state modes.

In the present disclosure, a Flag field is newly added or designed to the signaling exemplarily, which is used to instruct the terminal device to switch to a corresponding unified TCI state mode. The Flag field may be designed to be one bit, two bits, or more bits.

In the embodiments of the present disclosure, an example in which the Flag field includes one bit and two bits is used for description. However, the number of bits of the Flag field is not limited.

In Some Embodiments, Flag is Two Bits, and the Two Bits have at Least Three Values.

A first value is a value corresponding to the second version and the first value is used to instruct the terminal device to use the first unified TCI state as a unified TCI state in the second unified TCI state mode in a case where the terminal device switches from the first unified TCI state mode to the second unified TCI state mode.

A second value is a value corresponding to the second version and the second value is used to instruct the terminal device to use the second unified TCI state as a unified TCI state in the second unified TCI state mode in a case where the terminal device switches from the first unified TCI state mode to the second unified TCI state mode.

A third value is a value corresponding to the first version and the third value is used to instruct the terminal device to switch from the second unified TCI state mode to the first unified TCI state mode.

In some embodiments, the first value is any one of 00, 01, 10, or 11: the second value is any one of 00, 01, 10, or 11 except the first value: the third value is any one of 00, 01, 10, or 11 except the first value and the second value. In some embodiments, the first value is 00, the second value is 01, and the third value is 10: or the first value is 01, the second value is 10, and the third value is 00; or the first value is 11, the second value is 00, and the third value is 10. In the embodiments of the present disclosure, an example in which the first value is 00, the second value is 01, and the third value is 10 is used for description. However, the specific values of the first value, the second value, and the third value are not limited.

### 3.1 the First Unified TCI State Mode is Switched to the Second Unified TCI State Mode.

FIG. 34 illustrates a flowchart of a method for switching a TCI state mode according to some embodiments of the present disclosure. The method is performed by the network device illustrated in FIG. 3. The method includes the following processes.

In process 2810, the network device transmits first signaling, wherein the first signaling includes a Flag field, wherein the Flag field takes a value within a first range, this Flag field being used to instruct a terminal device to switch from the first unified TCI state mode to the second unified TCI state mode.

The first range includes values corresponding to the second version.

In some embodiments, two values corresponding to the second version are present in the first range, a first value of 00 and a second value of 01, respectively:

In some embodiments, the Flag field takes the first value within the first range, which is used to instruct the terminal device to overwrite or rewrite or update the activated unified TCI state using the first joint TCI state indicated in the first signaling. The specific method is illustrated in embodiments corresponding to FIG. 21.

In some embodiments, the Flag field takes the second value within the first range, which is used to instruct the terminal device to overwrite or rewrite or update the activated unified TCI state using the second joint TCI state indicated in the first signaling.

In some embodiments, the Flag field takes the first value within the first range, which is used to instruct the terminal device to overwrite or rewrite or update the activated unified TCI state using the first UL TCI state and/or the first DL TCI state indicated in the first signaling.

In some embodiments, the Flag field takes the second value within the first range, which is used to instruct the terminal device to overwrite or rewrite or update the activated unified TCI state using the second UL TCI state and/or the second DL TCI state indicated in the first signaling.

### 3.2 the Second Unified TCI State Mode is Switched to the First Unified TCI State Mode.

FIG. 35 illustrates a flowchart of a method for switching a TCI state mode according to some embodiments of the present disclosure. The method is performed by the network device illustrated in FIG. 3. The method includes the following processes.

In process 2910, the network device transmits second signaling, wherein the second signaling includes a Flag field, the Flag field taking a third value (10), wherein this Flag field is used to instruct a terminal device to switch from the second unified TCI state mode to the first unified TCI state mode.

The third value is a value corresponding to the first version.

In some embodiments, the Flag field takes the third value, which is used to instruct the terminal device to overwrite or rewrite or update the activated unified TCI state using the first joint TCI state and the second joint TCI indicated in the second signaling. The specific method is illustrated in embodiments corresponding to FIG. 26.

In some embodiments, the Flag field takes the third value, which is used to instruct the terminal device to overwrite or rewrite or update the activated unified TCI state using the first UL TCI state and/or the first DL TCI state and/or the second UL TCI state and/or the second DL TCI state indicated in the second signaling

### In Some Embodiments of the Present Disclosure, Flag is One Bit, and the One Bit has Two Values.

A first value is a value corresponding to the second version and the first value is used to instruct the terminal device to switch from the first unified TCI state mode to the second unified TCI state mode.

A third value is a value corresponding to the first version and the third is used to instruct the terminal device to switch from the second unified TCI state mode to the first unified TCI state mode.

In some embodiments, the first value is any one of 0 or 1: the second value is any one of 0 or 1 except the first value. In some embodiments, the first value is 0, and the third value is 1: or the first value is 1, and the third value is 0. In the embodiments of the present disclosure, an example in which the first value is 0 and the third value is 1 is used for description. However, the specific values of the first value and the second value are not limited.

### 3.3 the First Unified TCI State Mode is Switched to the Second Unified TCI State Mode.

FIG. 36 illustrates a flowchart of a method for switching a TCI state mode according to some embodiments of the present disclosure. The method is performed by the network device illustrated in FIG. 3. The method includes the following processes.

In process 3010, the network device transmits first signaling, wherein the first signaling includes a Flag field, the Flag field taking a first value, wherein this Flag field is used to instruct a terminal device to switch from the first unified TCI state mode to the second unified TCI state mode.

The first value is a value corresponding to the second version.

In some embodiments, the Flag field takes the first value, which is used to instruct to overwrite or rewrite or update the activated unified TCI state using the first joint TCI state indicated in the first signaling. The specific method is illustrated in embodiments corresponding to FIG. 9.

In some embodiments, the Flag field takes the first value, which is used to overwrite or rewrite or update the activated unified TCI state using the second joint TCI state indicated in the first signaling.

In some embodiments, the Flag field takes the first value, which is used to overwrite or rewrite or update the activated unified TCI state using the first UL and/or DL TCI state indicated in the first signaling.

In some embodiments, the Flag field takes the first value, which is used to overwrite or rewrite or update the activated unified TCI state using the second UL and/or DL TCI state indicated in the first signaling.

### 3.4 the Second Unified TCI State Mode is Switched to the First Unified TCI State Mode.

FIG. 37 illustrates a flowchart of a method for switching a TCI state mode according to some embodiments of the present disclosure. The method is performed by the network device illustrated in FIG. 3. The method includes the following processes.

In process 3110, the network device transmits second signaling, wherein the second signaling includes a Flag field, the Flag field taking a third value (1), wherein this Flag field is used to instruct a terminal device to switch from the second unified TCI state mode to the first unified TCI state mode.

The third value is a value corresponding to the first version.

In some embodiments, the Flag field takes the third value, which is used to instruct the terminal device to overwrite or rewrite or update the activated unified TCI state using the first joint TCI state and the second joint TCI indicated in the first signaling. The specific method is illustrated in embodiments corresponding to FIG. 28.

In some embodiments, the Flag field takes the third value, which is used to instruct the terminal device to overwrite or rewrite or update the activated unified TCI state using the unified TCI state indicated in the second signaling (including eight groups at most, each group of unified TCI states including one or more of the first UL TCI state, the first DL TCI state, the second UL TCI state, and the second DL TCI state).

In summary; the method for switching a TCI state mode according to the present disclosure is implemented by newly adding or designing a Flag field. Although the packet format is changed, the solutions can very accurately instruct the terminal device to switch between two unified TCI states.

In the above embodiments, an example in which the first information field is the eLCID field or the first information field is the Flag field is used for description, but it is not excluded that in some other embodiments, other information fields in the MAC CE are used as the first information field to indicate switching between two TCI state modes, which is not limited in the embodiments of the present disclosure.

In some embodiments, switching between the two unified TCI state modes is applicable to all carriers in a first carrier list, and all the carriers in the first carrier list are a plurality of carriers of a common beam.

The common beam means that in a case where a plurality of component carriers (CCs) are configured in the first carrier list, and in a case where any one of the CCs receives the signaling, triggering a switch between the two unified TCI state modes, then the process is applicable to all other CCs in the first carrier list.

In some embodiments, a plurality of serving cells are configured in the same CC list, that is, a CC list of common beam operations. After the UE receives the MAC CE of the unified TCI state corresponding to R18 and the switching of the unified TCI state modes of R18 and R17 occurs, and moreover, in a case where the serving cell ID in the MAC CE is configured in a CC list of common beam operations, such as the TCI synchronization update list XsimultaneousU-TCI-Update ListX, the TCI synchronization update list YsimultaneousU-TCI-UpdateListY, and the TCI synchronization update list ZsimultaneousU-TCI-UpdateListZ, the UE switches the unified TCI state modes of all serving cells in the CC list, that is, switches from R18 to the 17 mode or vice versa.

In some embodiments, the capability information reported by the terminal device is received. The capability information is used to indicate whether the terminal device supports the capability of switching between different unified TCI state modes. In a case where the terminal device supports switching between different unified TCI state modes, two different types of signaling are configured and used. In a case where the terminal device does not support switching between different unified TCI state modes, signaling supported by the terminal device is configured and used.

In some embodiments, Implementation 1 and Implementation 2 are implemented as an independent embodiment: Implementation 1 and Implementation 3 are implemented as an independent embodiment: Implementation 2 and Implementation 3 are implemented as an independent embodiment; Implementation 1, Implementation 2, and Implementation 3 are implemented as an independent embodiment, which is not limited thereto.

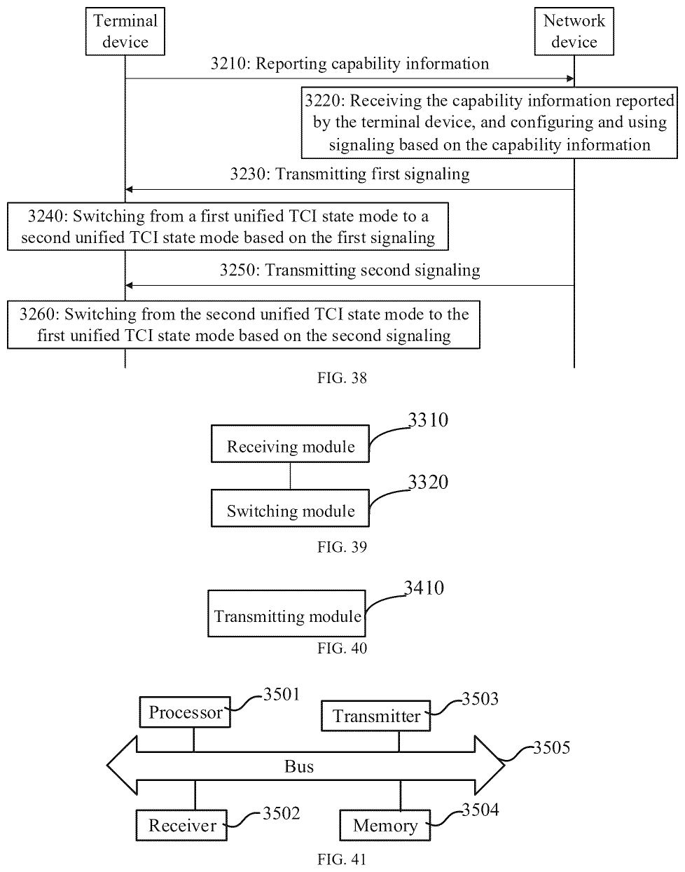

FIG. 38 illustrates an overall flowchart of a method for switching a TCI state mode according to some embodiments of the present disclosure. The method includes at least some of the following content.

In process 3210, a terminal device reports capability information to a network device, wherein the capability information is used to indicate to the network device whether the terminal device supports the capability of switching between different unified TCI state modes.

In some embodiments, in a case where the terminal device only supports operation in the second unified TCI state mode, the terminal device reports to the network device that the terminal device can only operate in the second unified TCI state mode.

In process 3220, the network device receives the capability information reported by the terminal device, wherein the capability information is used to indicate whether the terminal device supports the capability of switching between different unified TCI state modes.

In a case where the terminal device supports switching between different unified TCI state modes, two different types of signaling are configured and used.

In a case where the terminal device does not support switching between different unified TCI state modes, signaling supported by the terminal device is configured and used.

In some embodiments, in a case where the network device receives information indicating that the terminal device does not support switching between TCI state modes, and the terminal device can only operate in the first unified TCI state mode, the network device only configures and uses the signaling of the first unified TCI state mode for the terminal device.

In some embodiments, in a case where the network device receives information indicating that the terminal device supports switching between TCI state modes, and the terminal device can operate in the first unified TCI state mode or the second unified TCI state mode, the network device configures and uses the signaling of the first unified TCI state mode or the second unified TCI state mode for the terminal device.

In some embodiments, the method includes processes 630 and 640.

In process 3230, the network device transmits first signaling to the terminal device.

The first signaling is used to instruct the terminal device to switch from the first unified TCI state mode to the second unified TCI state mode.

In some embodiments, the first signaling is a MAC CE.

In process 3240, the terminal device switches from the first unified TCI state mode to the second unified TCI state mode based on the first signaling.

The first signaling is signaling used for activating a unified TCI state.

The terminal device receives the first signaling from the network device and switches from the first unified TCI state mode to the second unified TCI state mode.

In some embodiments, the first unified TCI state mode supports STRP and MTRP, and the second unified TCI state mode supports STRP.

In some embodiments, the communication protocol of the first version is a communication protocol of an R18 version, and the communication protocol of the second version is a communication protocol of an R17 version.

In some embodiments, the method includes processes 650 and 660.

In process 3250, the network device transmits second signaling to the terminal device.

The second signaling is used to instruct the terminal device to switch from the second unified TCI state mode to the first unified TCI state mode.

In some embodiments, the second signaling is a MAC CE.

In process 3260, the terminal device switches from the second unified TCI state mode to the first unified TCI state mode based on the second signaling.

The second signaling is signaling for activating a unified TCI state.

In some embodiments, the first unified TCI state mode supports STRP and MTRP, and the second unified TCI state mode supports STRP.

In some embodiments, the communication protocol of the first version is a communication protocol of an R18 version, and the communication protocol of the second version is a communication protocol of an R17 version.

FIG. 39 illustrates a structural block diagram of an apparatus for switching a TCI state mode according to some embodiments of the present disclosure. The switching apparatus may be implemented as a part of a terminal device. The method includes at least some of the following content.

The present disclosure illustrates three implementations of switching between two unified TCI state modes based on signaling (that is, signaling used for activating a unified TCI state). At least one of the three implementations may be used in different embodiments. The three implementations are as follows.

Implementation 1: Switching is performed between two unified TCI state modes based on the existing information field for activating a unified TCI state in the signaling.

Implementation 2: Switching is performed between two unified TCI state modes based on the existing eLCID field in the signaling.

Implementation 3: Switching is performed between two unified TCI state modes based on a newly added Flag field in the signaling.

The three implementations are sequentially described hereinafter, but the introduction sequence of the three implementations does not limit the superiority or inferiority of the three implementations.

With respect to Implementation 1: Switching is performed between two unified TCI state modes based on the existing information field for activating a unified TCI state in the signaling.

Since two cases of switching between two unified TCI states are present, the following is categorized into 1.1 and 1.2 for introduction, respectively.

### 1.1 the First Unified TCI State Mode is Switched to the Second Unified TCI State Mode.

A receiving module 3310 is configured to receive first signaling, wherein the first signaling is signaling used for activating a unified TCI state.

In some embodiments, the first signaling is signaling used for activating a unified TCI state in the first version: alternatively, the first signaling is signaling used for activating a unified TCI state in the second version. The first signaling is used to indicate switching from the first unified TCI state mode to the second unified TCI state mode.

A switching module 3320 is configured to switch from the first unified TCI state mode to the second unified TCI state mode based on all unified TCI states activated in the first signaling.

With Respect to the First Signaling being Signaling Used for Activating a Unified TCI State in the First Version:

All unified TCI states activated in the first signaling satisfy a first condition. The first condition herein means that the unified TCI state corresponding to each activated TCI codepoint corresponds to the same TRP.

In some embodiments, the first condition includes:
the all unified TCI states activated in the first signaling only corresponding to a first joint TCI state; or
the all unified TCI states activated in the first signaling only corresponding to a second joint TCI state; or
the all unified TCI states activated in the first signaling only corresponding to a first UL TCI state and/or a first DL TCI state; or
the all unified TCI states activated in the first signaling only corresponding to a second UL TCI state and/or a second DL TCI state.

The first unified TCI state mode is switched to the second unified TCI state mode in a case where all unified TCI states activated in the first signaling satisfy the first condition. In some embodiments, the activated unified TCI state is overwritten or rewritten or updated using the unified TCI state indicated in the first signaling, so as to switch from the first unified TCI state mode to the second unified TCI state mode.

In some embodiments of the present disclosure, the terminal device is in the first unified TCI state mode, that is, in the communication protocol of the R18 version. In the first signaling received by the terminal device, all activated unified TCI states only correspond to the first joint TCI state. In this case, the terminal device overwrites or rewrites or updates the activated unified TCI state using the first joint TCI state in the first signaling, such that the terminal device switches from the first unified TCI state mode to the second unified TCI state mode. As illustrated in FIG. 10, the table 410 is used to indicate unified TCI states activated prior to receiving the first signaling, the table 420 is used to indicate unified TCI states activated in the first signaling, and the table 430 is used to indicate unified TCI states activated after an overwrite or rewrite or update operation. The terminal device is in the first unified TCI state prior to receiving the first signaling, and the activated unified TCI states include the first joint TCI state and the second joint TCI state. For example, the TCI codepoint is 000, which corresponds to the first joint TCI state and the second joint TCI state; the TCI codepoint is 001, which corresponds to the first joint TCI state; all unified TCI states activated in the first signaling only correspond to the first joint TCI state, and subsequent to overwriting or rewriting or updating, the activated unified TCI states also only correspond to the first joint TCI state.

In some embodiments of the present disclosure, the terminal device is in the first unified TCI state mode, that is, in the communication protocol of the R18 version. In the first signaling received by the terminal device, all activated unified TCI states only correspond to the first UL TCI state and/or the first DL TCI state. In this case, the terminal device overwrites or rewrites or updates the activated unified TCI state using the first joint TCI state in the first signaling, such that the terminal device switches from the first unified TCI state mode to the second unified TCI state mode. As illustrated in FIG. 11, the table 510 is used to indicate unified TCI states activated prior to receiving the first signaling, the table 520 is used to indicate unified TCI states activated in the first signaling, and the table 530 is used to indicate unified TCI states activated after an overwrite or rewrite or update operation. The terminal device is in the first unified TCI state prior to receiving the first signaling, and the activated unified TCI states include the first UL TCI state, the first DL TCI state, the second UL TCI state, and the second DL TCI state. For example, the TCI codepoint is 000, which corresponds to the first UL TCI state, the first DL TCI state, the second UL TCI state, and the second DL TCI state; the TCI codepoint is 001, which corresponds to the first UL TCI state and the first DL TCI state; all unified TCI states activated in the first signaling only correspond to the first UL TCI state and/or the first DL TCI state, and subsequent to overwriting or rewriting or updating, the activated unified TCI states also only correspond to the first UL TCI state and/or the first DL TCI state.

With Respect to the First Signaling being Signaling Used for Activating a Unified TCI State in the Second Version:

All unified TCI states activated in the first signaling satisfy a first condition. In some embodiments, the first condition includes the following cases.
The all unified TCI states activated in the first signaling only correspond to the joint TCI state corresponding to one TRP: or it is understood that the activated joint TCI state of each TCI codepoint corresponds to one TRP: or it is understood that the activated joint TCI state of each TCI codepoint is one joint TCI state, and a case that the activated joint TCI state of any TCI codepoint is two joint TCI states is not present.
The all unified TCI states activated in the first signaling only correspond to the UL TCI state and/or DL TCI state corresponding to one TRP: or it is understood that the activated UL TCI state and/or DL TCI state of each TCI codepoint corresponds to one TRP: or it is understood that the activated UL TCI state of each TCI codepoint is one UL TCI state, and a case that the activated UL TCI state of any TCI codepoint is two UL TCI states is not present: or it is understood that the activated DL TCI state of each TCI codepoint is one DL TCI state, and a case that the activated DL TCI state of any TCI codepoint is two DL TCI states is not present.

In some embodiments, in a case where all unified TCI states activated in the first signaling only correspond to the joint TCI state corresponding to one TRP, the first unified TCI state mode is switched to the second unified TCI state mode. In some embodiments, in a case where all unified TCI states activated in the first signaling only correspond to the UL TCI state and/or the DL TCI state, the first unified TCI state mode is switched to the second unified TCI state mode.

In some embodiments, the activated unified TCI state is overwritten or rewritten or updated using the unified TCI state indicated in the first signaling, so as to switch from the first unified TCI state mode to the second unified TCI state mode.

In some embodiments of the present disclosure, the terminal device is in the first unified TCI state mode, that is, in the communication protocol of the R18 version. In the first signaling received by the terminal device, all activated unified TCI states only correspond to the joint TCI state. In this case, the terminal device overwrites or rewrites or updates the activated unified TCI state using the joint TCI state in the first signaling, such that the terminal device switches from the first unified TCI state mode to the second unified TCI state mode. As illustrated in FIG. 12, the table 610 is used to indicate unified TCI states activated prior to receiving the first signaling, the table 620 is used to indicate unified TCI states activated in the first signaling, and the table 630 is used to indicate unified TCI states activated after an overwrite or rewrite or update operation. In a case where the terminal is in the first unified TCI state, the activated unified TCI states include the first joint TCI state and the second joint TCI state. For example, the TCI codepoint is 000, which corresponds to the first joint TCI state and the second joint TCI state; the TCI codepoint is 001, which corresponds to the first joint TCI state; all unified TCI states activated in the first signaling only correspond to the joint TCI state, and subsequent to overwriting or rewriting or updating, the activated unified TCI states also only correspond to the joint TCI state.

In some embodiments of the present disclosure, the terminal device is in the first unified TCI state mode, that is, in the communication protocol of the R18 version. In the first signaling received by the terminal device, all activated unified TCI states only correspond to the UL TCI state and/or the DL TCI state. In this case, the terminal device overwrites or rewrites or updates the activated unified TCI state using the UL TCI state and/or the DL TCI state in the first signaling, such that the terminal device switches from the first unified TCI state mode to the second unified TCI state mode. As illustrated in FIG. 13, the table 710 is used to indicate unified TCI states activated prior to receiving the first signaling, the table 720 is used to indicate unified TCI states activated in the first signaling, and the table 730 is used to indicate unified TCI states activated after an overwrite or rewrite or update operation. In a case where the terminal is in the first unified TCI state, the activated unified TCI states include the first UL TCI state, the first DL TCI state, the second UL TCI state, and the second DL TCI state. For example, the TCI codepoint is 000, which corresponds to the first UL TCI state, the first DL TCI state, the second UL TCI state, and the second DL TCI state; the TCI codepoint is 001, which corresponds to the first UL TCI state and the first DL TCI state; all unified TCI states activated in the first signaling only correspond to the UL TCI state and/or the DL TCI state, and subsequent to overwriting or rewriting or updating, the activated unified TCI states also only correspond to the UL TCI state and/or the DL TCI state.

It should be noted that the above process 310 may be separately implemented as one embodiment, the above process 320 may be separately implemented as one embodiment, and the above processes 310 and 320 may be combined to form one embodiment, which is not limited in the present disclosure.

In summary; the apparatus according to the embodiments can switch from the first TCI state mode to the second TCI state mode over the first signaling. In a case where the UE moves between cells or within a cell, the UE may be proximal to a first TRP and distal to a second TRP. In a case where a significant difference is present in link qualities between the UE and a plurality of TRPs, the UE is not suitable for operating in an MTRP scenario. Therefore, the UE does not need to consume a large number of downlink measurement and reporting resources and store a plurality of unified TCI state resources. The UE may switch from the first unified TCI state mode to the second unified TCI state mode, thereby saving air interface resources and computing resources.

Due to the design of the above TCI codepoint, the terminal device can be implicitly instructed to perform a corresponding switching behavior without modifying the signaling format of the MAC CE in the communication protocol. Therefore, the need for modifications or redesigns of the MAC CE is avoided and the forward compatibility of the MAC CE across different communication versions is ensured.

### 1.2 the Second Unified TCI State Mode is Switched to the First Unified TCI State Mode.

A receiving module 3310 is configured to receive second signaling, wherein the second signaling is signaling used for activating a unified TCI state.

The second signaling is used to indicate switching from the second unified TCI state mode to the first unified TCI state mode.

A switching module 3320 is configured to switch from the second unified TCI state mode to the first unified TCI state mode based on at least one unified TCI state activated in the second signaling.

In some embodiments, the first unified TCI state mode corresponds to the communication protocol of the R18 version that supports STRP and MTRP, and the second unified TCI state mode corresponds to the communication protocol of the R17 version that supports only STRP. The second signaling is a MAC CE. Each codepoint of the MAC CE corresponding to R17 only corresponds to one unified TCI state, and one codepoint of the MAC CE corresponding to R18 may correspond to one or two unified TCI states.

In some embodiments, at least one unified TCI state activated in the second signaling satisfies a second condition. The second condition herein means that the unified TCI state corresponding to at least one activated TCI codepoint corresponds to two TRPs.

In some embodiments, the second condition includes:
the at least one unified TCI state activated in the second signaling corresponding to a first joint TCI state and a second joint TCI state simultaneously: or
the at least one unified TCI state activated in the second signaling corresponding to a first UL TCI state and a second UL TCI state simultaneously (the DL TCI state may be null, one, or two, which is not limited): or
the at least one unified TCI state activated in the second signaling corresponding to a first DL TCI state and a second DL TCI state simultaneously (the UL TCI state may be null, one, or two, which is not limited): or
the at least one unified TCI state activated in the second signaling corresponding to a first UL TCI state, a second UL TCI state, a first DL TCI state, and a second DL TCI state simultaneously.

In some embodiments, the activated unified TCI state is overwritten or rewritten or updated using the unified TCI state indicated in the second signaling, so as to switch from the second unified TCI state mode to the first unified TCI state mode.

In some embodiments, the terminal device is in the second unified TCI state mode, that is, in the communication protocol of the R17 version, and the activated TCI state is the first joint TCI state. In the second signaling received by the terminal device, at least one activated TCI codepoint corresponds to the first joint TCI state and the second joint TCI state simultaneously. In this case, the terminal device overwrites or rewrites or updates the activated unified TCI state, that is, the first joint TCI state, using the first joint TCI state and the second joint TCI state in the second signaling, such that the terminal device switches from the second unified TCI state mode to the first unified TCI state mode. As illustrated in FIG. 15, the table 910 is used to indicate unified TCI states activated prior to receiving the second signaling, the table 920 is used to indicate unified TCI states activated in the second signaling, and the table 930 is used to indicate unified TCI states activated after an overwrite or rewrite or update operation. The terminal device is in the second unified TCI state prior to receiving the second signaling: the activated unified TCI states include the first joint TCI state; at least one unified TCI codepoint activated in the second signaling corresponds to the first joint TCI state and the second joint TCI state simultaneously; and subsequent to overwriting or rewriting or updating, the at least one activated unified TCI codepoint corresponds to the first joint TCI state and the second joint TCI state simultaneously:

In some embodiments, the terminal device is in the second unified TCI state mode, that is, in the communication protocol of the R17 version, and the activated TCI states are the first UL TCI state and the first DL TCI state. In the second signaling received by the terminal device, at least one activated TCI codepoint corresponds to the first UL TCI state and the second UL TCI state simultaneously. In this case, the terminal device overwrites or rewrites or updates the activated unified TCI states, that is, the first UL TCI state and the first DL TCI state, using the first UL TCI state and the second UL TCI state in the second signaling, such that the terminal device switches from the second unified TCI state mode to the first unified TCI state mode. As illustrated in FIG. 16, the table 1010 is used to indicate unified TCI states activated prior to receiving the second signaling, the table 1020 is used to indicate unified TCI states activated in the second signaling, and the table 1030 is used to indicate unified TCI states activated after an overwrite or rewrite or update operation. The terminal device is in the second unified TCI state prior to receiving the second signaling: the activated unified TCI state only corresponds to the first UL TCI state and/or the first DL TCI state; at least one unified TCI state activated in the second signaling corresponds to the first UL TCI state and the second UL TCI state simultaneously; and subsequent to overwriting or rewriting or updating, the at least one activated unified TCI state corresponds to the first UL TCI state and the second UL TCI state simultaneously

It should be noted that the above process 810 may be separately implemented as one embodiment, the above process 820 may be separately implemented as one embodiment, and the above processes 810 and 820 may be combined to form one embodiment, which is not limited in the present disclosure.

In summary; in the apparatus according to the embodiments, switching from the second TCI state mode to the first TCI state mode can be achieved over the second signaling. In a case where the UE moves to a cell edge, to enhance the uplink and downlink coverage of the UE, MTRP transmission is more suitable for the UE. Therefore, it is necessary to switch the UE from the second unified TCI state mode to the first unified TCI state mode.

Due to the design of the above TCI codepoint, the terminal device can be implicitly instructed to perform a corresponding switching behavior without modifying the signaling format of the MAC CE in the communication protocol. Therefore, the need for modifications or redesigns of the MAC CE is avoided and the forward compatibility of the MAC CE across different communication versions is ensured.

With respect to Implementation 2: Switching is performed between two unified TCI state modes based on the existing eLCID field in the signaling.

The present disclosure exemplarily illustrates the value range of the eLCID field corresponding to the first version, as illustrated in Table 3.

The first value is the codepoint 233 and/or the index 297.

The second value is the codepoint xxx and/or the index yyy. The codepoint xxx is any numerical value from 0 to 226, the index yyy is any numerical value from 64 to 290, and the index yyy is the codepoint xxx plus 64.

Since two cases of switching between two unified TCI states are present, the following is categorized into 2.1 and 2.2 for introduction, respectively.

### 2.1 the First Unified TCI State Mode is Switched to the Second Unified TCI State Mode.

A receiving module 3310 is configured to receive first signaling, wherein the first signaling includes an eLCID field, the eLCID field taking a first value.

The value of the eLCID is used to indicate switching from the first unified TCI state mode to the second unified TCI state mode.

In some embodiments of the present disclosure, the value of the eLCID is the first value, wherein the first value is used to indicate switching from the first unified TCI state mode to the second unified TCI state mode.

The first value is a value corresponding to the second version, and the second value is a value corresponding to the first version.

A switching module 3320 is configured to switch from the first unified TCI state mode to the second unified TCI state mode in a case where the eLCID field in the first signaling takes the first value.

The first value is a value corresponding to the second version. In some embodiments, the value range of the first value includes the codepoint 233 and/or the index 297.

In some embodiments, the value corresponding to the eLCID of R17 includes the codepoint 233 and the index 297.

In some embodiments, the switching module 3320 is configured to overwrite or rewrite or update the activated unified TCI state using the joint TCI state indicated in the first signaling.

In some embodiments, the terminal device is in the first unified TCI state mode, that is, in the communication protocol of the R18 version, and the eLCID field in the first signaling received by the terminal device takes the first value. In this case, the terminal device overwrites or rewrites or updates the activated unified TCI state using the joint TCI state in the first signaling, such that the terminal device switches from the first unified TCI state mode to the second unified TCI state mode. As illustrated in FIG. 12, the table 610 is used to indicate unified TCI states activated prior to receiving the first signaling, the table 620 is used to indicate unified TCI states activated in the first signaling, and the table 630 is used to indicate unified TCI states activated after an overwrite or rewrite or update operation. In a case where the terminal is in the first unified TCI state, the activated unified TCI states include the first joint TCI state and the second joint TCI state. For example, the TCI codepoint is 000, which corresponds to the first joint TCI state and the second joint TCI state; the TCI codepoint is 001, which corresponds to the first joint TCI state; the value of the eLCID field in the first signaling is the codepoint 233 and/or the index 297, and subsequent to overwriting or rewriting or updating, the activated unified TCI states also only correspond to the joint TCI state.

In some embodiments, the switching module 3320 is configured to overwrite or rewrite or update the activated unified TCI state using the UL TCI state and/or the DL TCI state indicated in the first signaling.

In some embodiments, the terminal device is in the first unified TCI state mode, that is, in the communication protocol of the R18 version, and the eLCID field in the first signaling received by the terminal device takes the first value. In this case, the terminal device overwrites or rewrites or updates the activated unified TCI state using the UL TCI state and the DL TCI state in the first signaling, such that the terminal device switches from the first unified TCI state mode to the second unified TCI state mode. As illustrated in FIG. 13, the table 710 is used to indicate unified TCI states activated prior to receiving the first signaling, the table 720 is used to indicate unified TCI states activated in the first signaling, and the table 730 is used to indicate unified TCI states activated after an overwrite or rewrite or update operation. In a case where the terminal is in the first unified TCI state, the activated unified TCI states include the first UL TCI state, the first DL TCI state, the second UL TCI state, and the second DL TCI state. For example, the TCI codepoint is 000, which corresponds to the first UL TCI state, the first DL TCI state, the second UL TCI state, and the second DL TCI state; the TCI codepoint is 001, which corresponds to the first UL TCI state and the first DL TCI state; the value of the eLCID field in the first signaling is the codepoint 233 and/or the index 297, and subsequent to overwriting or rewriting or updating, the activated unified TCI states also only correspond to the UL TCI state and/or the DL TCI state.

It should be noted that the above process 1110 may be separately implemented as one embodiment, the above process 1120 may be separately implemented as one embodiment, and the above processes 1110 and 1120 may be combined to form one embodiment, which is not limited in the present disclosure.

In summary; the apparatus according to the embodiments can switch from the first TCI state mode to the second TCI state mode over the first signaling. In a case where the UE moves between cells or within a cell, the UE may be proximal to a first TRP and distal to a second TRP. In a case where a significant difference is present in link qualities between the UE and a plurality of TRPs, the UE is not suitable for operating in an MTRP scenario. Therefore, the UE does not need to consume a large number of downlink measurement and reporting resources and store a plurality of unified TCI state resources. The UE may switch from the first unified TCI state mode to the second unified TCI state mode, thereby saving air interface resources and computing resources.

Since the eLCID field is the existing information field, and the value range of the eLCID is also large, the value of the eLCID is used to indicate the switching of the TCI state mode without modifying the signaling format of the MAC CE in the communication protocol. In addition, without additionally defining the switching behavior of the UE, the terminal device can be instructed to switch from the first unified TCI state mode to the second unified TCI state mode. Therefore, the need for modifications or redesigns of the MAC CE is avoided and the forward compatibility of the MAC CE across different communication versions is ensured.

### 2.2 the Second Unified TCI State Mode is Switched to the First Unified TCI State Mode.

A receiving module 3310 is configured to receive second signaling, wherein the second signaling includes an eLCID field, the eLCID field in the second signaling taking a second value.

The value of the eLCID is used to indicate switching from the second unified TCI state mode to the first unified TCI state mode.

In some embodiments of the present disclosure, the value of the eLCID is the second value, wherein the second value is used to indicate switching from the second unified TCI state mode to the first unified TCI state mode.

The first value is a value corresponding to the second version, and the second value is a value corresponding to the first version.

In some embodiments, a value corresponding to the eLCID of R18 is that the eLCID codepoint ranges from 0 to 226, an index of the eLCID ranges from 64 to 290, and the index of the eLCID is the eLCID codepoint plus 64.

A switching module 3320 is configured to switch from the second unified TCI state mode to the first unified TCI state mode.

The activated unified TCI state is overwritten or rewritten or updated using the unified TCI state indicated in the second signaling.

In some embodiments, the switching module 3320 is configured to overwrite or rewrite or update the activated unified TCI state using the joint TCI state indicated in the second signaling. In some embodiments, at least one group of joint TCI states activated in the second signaling includes two.

In some embodiments, the terminal device is in the second unified TCI state mode, that is, in the communication protocol of the R17 version, the activated TCI state is the joint TCI state, and the eLCID field in the second signaling received by the terminal device takes the second value. In this case, the terminal device overwrites or rewrites or updates the activated unified TCI state using the first joint TCI state and the second joint TCI state, such that the terminal device switches from the second unified TCI state mode to the first unified TCI state mode. As illustrated in FIG. 19, the table 1310 is used to indicate unified TCI states activated prior to receiving the second signaling, the table 1320 is used to indicate unified TCI states activated in the second signaling, and the table 1330 is used to indicate unified TCI states activated after an overwrite or rewrite or update operation. The terminal device is in the second unified TCI state prior to receiving the second signaling: the activated unified TCI states include the joint TCI state; at least one unified TCI codepoint activated in the second signaling corresponds to the first joint TCI state and the second joint TCI state simultaneously, and subsequent to overwriting or rewriting or updating, the at least one activated unified TCI codepoint corresponds to the first joint TCI state and the second joint TCI state simultaneously.

In some embodiments, the switching module 3320 is configured to overwrite or rewrite or update the activated unified TCI state using the UL TCI state and/or the DL TCI state indicated in the second signaling. In separate TCI states corresponding to at least one codepoint activated in the second signaling, two UL TCI states and/or two DL TCI states are present.

In some embodiments, the terminal device is in the second unified TCI state mode, that is, in the communication protocol of the R17 version, the activated TCI state is the UL TCI state, and the eLCID field in the second signaling received by the terminal device takes the second value. In this case, the terminal device overwrites or rewrites or updates the activated unified TCI state using the first UL TCI state and the second UL TCI state, such that the terminal device switches from the second unified TCI state mode to the first unified TCI state mode. As illustrated in FIG. 20, the table 1410 is used to indicate unified TCI states activated prior to receiving the second signaling, the table 1420 is used to indicate unified TCI states activated in the second signaling, and the table 1430 is used to indicate unified TCI states activated after an overwrite or rewrite or update operation. The terminal device is in the second unified TCI state prior to receiving the second signaling: the activated unified TCI state only corresponds to one group of UL TCI states and/or DL TCI states: at least one unified TCI state activated in the second signaling corresponds to the first UL TCI state and the second UL TCI state simultaneously, and subsequent to overwriting or rewriting or updating, the at least one activated unified TCI state corresponds to the first UL TCI state and the second UL TCI state simultaneously.

It should be noted that the above process 1210 may be separately implemented as one embodiment, the above process 1220 may be separately implemented as one embodiment, and the above processes 1210 and 1220 may be combined to form one embodiment, which is not limited in the present disclosure.

In summary; in the apparatus according to the embodiments, switching from the second TCI state mode to the first TCI state mode can be achieved over the second signaling. In a case where the UE moves to a cell edge, to enhance the uplink and downlink coverage of the UE, MTRP transmission is more suitable for the UE. Therefore, it is necessary to switch the UE from the second unified TCI state mode to the first unified TCI state mode.

Since the eLCID field is the existing information field, and the value range of the eLCID is also large, the value of the eLCID can be used to indicate the switching of the TCI state mode only by reusing the meaning of the existing value or using a reserved value as a value corresponding to the first version without modifying the signaling format of the MAC CE in the communication protocol. In addition, without additionally defining the switching behavior of the UE, the terminal device can be instructed to switch from the first unified TCI state mode to the second unified TCI state mode. Therefore, the need for modifications or redesigns of the MAC CE is avoided and the forward compatibility of the MAC CE across different communication versions is ensured.

With respect to Implementation 3: Switching is performed between two unified TCI state modes based on a newly added Flag field in the signaling.

In the present disclosure, a Flag field is newly added or designed to the signaling exemplarily, which is used to instruct the terminal device to switch to a corresponding unified TCI state mode. The Flag field may be designed to be one bit, two bits, or more bits.

In the embodiments of the present disclosure, an example in which the Flag field includes one bit and two bits is used for description. However, the number of bits of the Flag field is not limited.

In Some Embodiments, Flag is Two Bits, and the Two Bits have at Least Three Values.

A first value is a value corresponding to the second version and the first value is used to instruct the terminal device to use the first unified TCI state as a unified TCI state in the second unified TCI state mode in a case where the terminal device switches from the first unified TCI state mode to the second unified TCI state mode.

A second value is a value corresponding to the second version and the second value is used to instruct the terminal device to use the second unified TCI state as a unified TCI state in the second unified TCI state mode in a case where the terminal device switches from the first unified TCI state mode to the second unified TCI state mode.

A third value is a value corresponding to the first version and the third value is used to instruct the terminal device to switch from the second unified TCI state mode to the first unified TCI state mode.

In some embodiments, the first value is any one of 00, 01, 10, or 11: the second value is any one of 00, 01, 10, or 11 except the first value: the third value is any one of 00, 01, 10, or 11 except the first value and the second value. In some embodiments, the first value is 00, the second value is 01, and the third value is 10: or the first value is 01, the second value is 10, and the third value is 00; or the first value is 11, the second value is 00, and the third value is 10. In the embodiments of the present disclosure, an example in which the first value is 00, the second value is 01, and the third value is 10 is used for description. However, the specific values of the first value, the second value, and the third value are not limited.

### 3.1 the First Unified TCI State Mode is Switched to the Second Unified TCI State Mode.

A receiving module 3310 is configured to receive first signaling, wherein the first signaling includes a Flag field, the Flag field taking a value within a first range.

The first signaling is used to indicate switching from the first unified TCI state mode to the second unified TCI state mode. The first range includes values corresponding to the second version.

In some embodiments, two values corresponding to the second version are present in the first range, for example, a first value of 00, and a second value of 01, respectively.

The first value is used to indicate to overwrite or rewrite or update the activated unified TCI state using the first joint TCI state indicated in the first signaling, or to overwrite or rewrite or update the activated unified TCI state using the first UL TCI state and/or the first DL TCI state indicated in the first signaling.

The second value is used to indicate to overwrite or rewrite or update the activated unified TCI state using the second joint TCI state indicated in the first signaling, or to overwrite or rewrite or update the activated unified TCI state using the second UL TCI state and/or the second DL TCI state indicated in the first signaling.

A switching module 3320 is configured to switch from the first unified TCI state mode to the second unified TCI state mode.

In some embodiments, the switching module 3320 is configured to overwrite or rewrite or update the activated unified TCI state using the first joint TCI state indicated in the first signaling in a case where the Flag field takes the first value within the first range.

In some embodiments, the terminal device is in the first unified TCI state mode, that is, in the communication protocol of the R18 version, the activated TCI states are the first joint TCI state and the second joint TCI state, and the Flag field in the first signaling received by the terminal device takes 00. In this case, the terminal device overwrites or rewrites or updates the activated unified TCI states, that is, the first joint TCI state and the second joint TCI state, using the first joint TCI state in the first signaling, such that the terminal device switches from the first unified TCI state mode to the second unified TCI state mode. As illustrated in FIG. 22, the table 1610 is used to indicate unified TCI states activated prior to receiving the first signaling, the table 1620 is used to indicate unified TCI states activated in the first signaling, and the table 1630 is used to indicate unified TCI states activated after an overwrite or rewrite or update operation. The terminal device is in the first unified TCI state prior to receiving the first signaling, and the activated unified TCI states include the first joint TCI state and the second joint TCI state. For example, the TCI codepoint is 000, which corresponds to the first joint TCI state and the second joint TCI state; the TCI codepoint is 001, which corresponds to the first joint TCI state; the Flag field in the first signaling takes 00, and the activated unified TCI state is overwritten or rewritten or updated using the first joint TCI state in the first signaling.

In some embodiments, the switching module 3320 is configured to overwrite or rewrite or update the activated unified TCI state using the second joint TCI state indicated in the first signaling in a case where the Flag field takes the second value within the first range.

In some embodiments, the terminal device is in the first unified TCI state mode, that is, in the communication protocol of the R18 version, the activated TCI states are the first joint TCI state and the second joint TCI state, and the Flag field in the first signaling received by the terminal device takes 01. In this case, the terminal device overwrites or rewrites or updates the activated unified TCI states, that is, the first joint TCI state and the second joint TCI state, using the second joint TCI state in the first signaling, such that the terminal device switches from the first unified TCI state mode to the second unified TCI state mode. As illustrated in FIG. 23, the table 1710 is used to indicate unified TCI states activated prior to receiving the first signaling, the table 1720 is used to indicate unified TCI states activated in the first signaling, and the table 1730 is used to indicate unified TCI states activated after an overwrite or rewrite or update operation. The terminal device is in the first unified TCI state prior to receiving the first signaling, and the activated unified TCI states include the first joint TCI state and the second joint TCI state. For example, the TCI codepoint is 000, which corresponds to the first joint TCI state and the second joint TCI state; the TCI codepoint is 001, which corresponds to the first joint TCI state; the Flag field in the first signaling takes 01, and the activated unified TCI state is overwritten or rewritten or updated using the second joint TCI state in the first signaling.

In some embodiments, the switching module 3320 is configured to overwrite or rewrite or update the activated unified TCI state using the first UL TCI state and/or the first DL TCI state indicated in the first signaling in a case where the Flag field takes the first value within the first range.

In some embodiments, the terminal device is in the first unified TCI state mode, that is, in the communication protocol of the R18 version, and the Flag field in the first signaling received by the terminal device takes 00. In this case, the terminal device overwrites or rewrites or updates the activated unified TCI state using the first UL TCI state and/or the first DL TCI state in the first signaling, such that the terminal device switches from the first unified TCI state mode to the second unified TCI state mode. As illustrated in FIG. 24, the table 1810 is used to indicate unified TCI states activated prior to receiving the first signaling, the table 1820 is used to indicate unified TCI states activated in the first signaling, and the table 1830 is used to indicate unified TCI states activated after an overwrite or rewrite or update operation. The terminal device is in the first unified TCI state prior to receiving the first signaling, and the activated unified TCI states include the first UL TCI state, the first DL TCI state, the second UL TCI state, and the second DL TCI state. For example, the TCI codepoint is 000, which corresponds to the first UL TCI state, the first DL TCI state, the second UL TCI state, and the second DL TCI state; the TCI codepoint is 001, which corresponds to the first UL TCI state and the first DL TCI state; the Flag field in the first signaling takes 00, and the activated unified TCI state is overwritten or rewritten or updated using the first UL TCI state and/or the first DL TCI state in the first signaling.

In some embodiments, the switching module 3320 is configured to overwrite or rewrite or update the activated unified TCI state using the second UL TCI state and/or the second DL TCI state indicated in the first signaling in a case where the Flag field takes the second value within the first range.

In some embodiments, the terminal device is in the first unified TCI state mode, that is, in the communication protocol of the R18 version, and the Flag field in the first signaling received by the terminal device takes 01. In this case, the terminal device overwrites or rewrites or updates the activated unified TCI state using the second UL TCI state and/or the second DL TCI state in the first signaling, such that the terminal device switches from the first unified TCI state mode to the second unified TCI state mode. As illustrated in FIG. 25, the table 1910 is used to indicate unified TCI states activated prior to receiving the first signaling, the table 1920 is used to indicate unified TCI states activated in the first signaling, and the table 1930 is used to indicate unified TCI states activated after an overwrite or rewrite or update operation. The terminal device is in the first unified TCI state prior to receiving the first signaling, and the activated unified TCI states include the first UL TCI state, the first DL TCI state, the second UL TCI state, and the second DL TCI state. For example, the TCI codepoint is 000, which corresponds to the first UL TCI state, the first DL TCI state, the second UL TCI state, and the second DL TCI state; the TCI codepoint is 001, which corresponds to the first UL TCI state and the first DL TCI state; the Flag field in the first signaling takes 01, and the activated unified TCI state is overwritten or rewritten or updated using the second UL TCI state and/or the second DL TCI state in the first signaling.

It should be noted that the above process 1510 may be separately implemented as one embodiment, the above process 1520 may be separately implemented as one embodiment, and the above processes 1510 and 1520 may be combined to form one embodiment, which is not limited in the present disclosure.

### 3.2 the Second Unified TCI State Mode is Switched to the First Unified TCI State Mode.

A receiving module 3310 is configured to receive second signaling, wherein the second signaling includes a Flag field, the Flag field in the second signaling taking a third value (10).

The third value is a value corresponding to the first version.

In some embodiments, the Flag field in the second signaling takes the third value, wherein this Flag field is used to indicate switching from the second unified TCI state mode to the first unified TCI state mode.

A switching module 3320 switches from the second unified TCI state mode to the first unified TCI state mode.

In some embodiments, the terminal device is in the second unified TCI state mode, that is, in the communication protocol of the R17 version, and the Flag field in the second signaling received by the terminal device takes 10. In this case, the terminal device overwrites or rewrites or updates the activated unified TCI state using the first joint TCI state and the second TCI state in the second signaling, such that the terminal device switches from the second unified TCI state mode to the first unified TCI state mode. As illustrated in FIG. 15, the table 910 is used to indicate unified TCI states activated prior to receiving the second signaling, the table 920 is used to indicate unified TCI states activated in the second signaling, and the table 930 is used to indicate unified TCI states activated after an overwrite or rewrite or update operation. The terminal device is in the second unified TCI state prior to receiving the second signaling: the activated unified TCI states include the first joint TCI state; the Flag field in the second signaling takes 10; the activated unified TCI state is overwritten or rewritten or updated using the first joint TCI state and the second joint TCI in the second signaling.

In some embodiments, the switching module 3320 is configured to overwrite or rewrite or update the activated unified TCI state using the first UL TCI state and/or the first DL TCI state and/or the second UL TCI state and/or the second DL TCI state indicated in the second signaling in a case where the Flag field takes the third value.

In some embodiments, the terminal device is in the second unified TCI state mode, that is, in the communication protocol of the R17 version, and the Flag field in the second signaling received by the terminal device takes 10. In this case, the terminal device overwrites or rewrites or updates the activated unified TCI state using the unified TCI state activated in the second signaling, such that the terminal device switches from the second unified TCI state mode to the first unified TCI state mode. As illustrated in FIG. 16, the table 1010 is used to indicate unified TCI states activated prior to receiving the second signaling, the table 1020 is used to indicate unified TCI states activated in the second signaling, and the table 1030 is used to indicate unified TCI states activated after an overwrite or rewrite or update operation. The terminal device is in the second unified TCI state prior to receiving the second signaling: the activated unified TCI state only corresponds to the first UL TCI state and/or the first DL TCI state; the Flag field in the second signaling takes 10; the activated unified TCI state is overwritten or rewritten or updated using the first UL TCI state and/or the first DL TCI state and/or the second UL TCI state and/or the second DL TCI state in the second signaling.

It should be noted that the above process 2010 may be separately implemented as one embodiment, the above process 2020 may be separately implemented as one embodiment, and the above processes 2010 and 2020 may be combined to form one embodiment, which is not limited in the present disclosure.

### In Some Embodiments of the Present Disclosure, Flag is One Bit, and the One Bit has Two Values.

A first value is a value corresponding to the second version and the first value is used to instruct the terminal device to switch from the first unified TCI state mode to the second unified TCI state mode.

A third value is a value corresponding to the first version and the third value is used to instruct the terminal device to switch from the second unified TCI state mode to the first unified TCI state mode.

In some embodiments, the first value is any one of 0 or 1: the second value is any one of 0 or 1 except the first value. In some embodiments, the first value is 0, and the third value is 1: or the first value is 1, and the third value is 0. In the embodiments of the present disclosure, an example in which the first value is 0 and the third value is 1 is used for description. However, the specific values of the first value and the second value are not limited.

### 3.3 the First Unified TCI State Mode is Switched to the Second Unified TCI State Mode.

A receiving module 3310 is configured to receive first signaling, wherein the first signaling includes a Flag field. The Flag field in the first signaling takes a first value.

The first signaling is used to indicate switching from the first unified TCI state mode to the second unified TCI state mode. The first value is a value corresponding to the second version.

A switching module 3320 is configured to switch from the first unified TCI state mode to the second unified TCI state mode.

In some embodiments, the switching module 3320 is configured to overwrite or rewrite or update the activated unified TCI state using the first joint TCI state indicated in the first signaling by default.

In some embodiments, the terminal device is in the first unified TCI state mode, that is, in the communication protocol of the R18 version, and the Flag field in the first signaling received by the terminal device takes 0. In this case, the terminal device overwrites or rewrites or updates the activated unified TCI state using the first joint TCI state in the first signaling, such that the terminal device switches from the first unified TCI state mode to the second unified TCI state mode. As illustrated in FIG. 22, the table 1610 is used to indicate unified TCI states activated prior to receiving the first signaling, the table 1620 is used to indicate unified TCI states activated in the first signaling, and the table 1630 is used to indicate unified TCI states activated after an overwrite or rewrite or update operation. The terminal device is in the first unified TCI state prior to receiving the first signaling, and the activated unified TCI states include the first joint TCI state and the second joint TCI state. For example, the TCI codepoint is 000, which corresponds to the first joint TCI state and the second joint TCI state; the TCI codepoint is 001, which corresponds to the first joint TCI state; the Flag field in the first signaling takes 0, and the activated unified TCI state is overwritten or rewritten or updated using the first joint TCI state in the first signaling.

In some embodiments, the switching module 3320 is configured to overwrite or rewrite or update the activated unified TCI state using the second joint TCI state indicated in the first signaling by default.

In some embodiments, the terminal device is in the first unified TCI state mode, that is, in the communication protocol of the R18 version, and the Flag field in the first signaling received by the terminal device takes 0. In this case, the terminal device overwrites or rewrites or updates the activated unified TCI state using the second joint TCI state in the first signaling, such that the terminal device switches from the first unified TCI state mode to the second unified TCI state mode. As illustrated in FIG. 23, the table 1710 is used to indicate unified TCI states activated prior to receiving the first signaling, the table 1720 is used to indicate unified TCI states activated in the first signaling, and the table 1730 is used to indicate unified TCI states activated after an overwrite or rewrite or update operation. The terminal device is in the first unified TCI state prior to receiving the first signaling, and the activated unified TCI states include the first joint TCI state and the second joint TCI state. For example, the TCI codepoint is 000, which corresponds to the first joint TCI state and the second joint TCI state; the TCI codepoint is 001, which corresponds to the first joint TCI state; the Flag field in the first signaling takes 0, and the activated unified TCI state is overwritten or rewritten or updated using the second joint TCI state in the first signaling.

In some embodiments, the switching module 3320 is configured to overwrite or rewrite or update the activated unified TCI state using the first UL and/or DL TCI state indicated in the first signaling by default.

In some embodiments, the terminal device is in the first unified TCI state mode, that is, in the communication protocol of the R18 version, and the Flag field in the first signaling received by the terminal device takes 0. In this case, the terminal device overwrites or rewrites or updates the activated unified TCI state using the first UL TCI state and the first DL TCI state in the first signaling, such that the terminal device switches from the first unified TCI state mode to the second unified TCI state mode. As illustrated in FIG. 24, the table 1810 is used to indicate unified TCI states activated prior to receiving the first signaling, the table 1820 is used to indicate unified TCI states activated in the first signaling, and the table 1830 is used to indicate unified TCI states activated after an overwrite or rewrite or update operation. The terminal device is in the first unified TCI state prior to receiving the first signaling, and the activated unified TCI states include the first UL TCI state, the first DL TCI state, the second UL TCI state, and the second DL TCI state. For example, the TCI codepoint is 000, which corresponds to the first UL TCI state, the first DL TCI state, the second UL TCI state, and the second DL TCI state; the TCI codepoint is 001, which corresponds to the first UL TCI state and the first DL TCI state; the Flag field in the first signaling takes 0, and the activated unified TCI state is overwritten or rewritten or updated using the first UL TCI state and/or the first DL TCI state in the first signaling.

In some embodiments, the switching module 3320 is configured to overwrite or rewrite or update the activated unified TCI state using the second UL and/or DL TCI state indicated in the first signaling by default.

In some embodiments, the terminal device is in the first unified TCI state mode, that is, in the communication protocol of the R18 version, and the Flag field in the first signaling received by the terminal device takes 0. In this case, the terminal device overwrites or rewrites or updates the activated unified TCI state using the first UL TCI state and the first DL TCI state in the first signaling, such that the terminal device switches from the first unified TCI state mode to the second unified TCI state mode. As illustrated in FIG. 25, the table 1910 is used to indicate unified TCI states activated prior to receiving the first signaling, the table 1920 is used to indicate unified TCI states activated in the first signaling, and the table 1930 is used to indicate unified TCI states activated after an overwrite or rewrite or update operation. In a case where the terminal device is in the first unified TCI state, the activated unified TCI states include the first UL TCI state, the first DL TCI state, the second UL TCI state, and the second DL TCI state. For example, the TCI codepoint is 000, which corresponds to the first UL TCI state, the first DL TCI state, the second UL TCI state, and the second DL TCI state; the TCI codepoint is 001, which corresponds to the first UL TCI state and the first DL TCI state; the Flag field in the first signaling takes 0, and the activated unified TCI state is overwritten or rewritten or updated using the second UL TCI state and/or the second DL TCI state in the first signaling.

It should be noted that the above process 2110 may be separately implemented as one embodiment, the above process 2120 may be separately implemented as one embodiment, and the above processes 2110 and 2120 may be combined to form one embodiment, which is not limited in the present disclosure.

### 3.4 The Second Unified TCI State Mode is Switched to the First Unified TCI State Mode.

A receiving module 3310 is configured to receive second signaling, wherein the second signaling includes a Flag field, the Flag field in the second signaling taking a third value.

A switching module 3320 is configured to switch from the second unified TCI state mode to the first unified TCI state mode.

The third value is a value corresponding to the first version.

In some embodiments, the switching module 3320 is configured to overwrite or rewrite or update the activated unified TCI state using the first joint TCI state and the second joint TCI state indicated (i.e., activated) in the second signaling.

In some embodiments, the terminal device is in the second unified TCI state mode, that is, in the communication protocol of the R17 version, and the Flag field in the second signaling received by the terminal device takes 1. In this case, the terminal device overwrites or rewrites or updates the activated unified TCI state using the first joint TCI state and the second joint TCI state in the second signaling, such that the terminal device switches from the second unified TCI state mode to the first unified TCI state mode. As illustrated in FIG. 15, the table 910 is used to indicate unified TCI states activated prior to receiving the second signaling, the table 920 is used to indicate unified TCI states activated in the second signaling, and the table 930 is used to indicate unified TCI states activated after an overwrite or rewrite or update operation. The terminal device is in the second unified TCI state prior to receiving the second signaling: the activated unified TCI states include the first joint TCI state; the Flag field in the second signaling takes 1: the activated unified TCI state is overwritten or rewritten or updated using the first joint TCI state and the second joint TCI in the second signaling.

In some embodiments, the switching module 3320 is configured to overwrite or rewrite or update the activated unified TCI state using the unified TCI state indicated in the second signaling (including eight groups at most, each group of unified TCI states including one or more of the first UL TCI state, the first DL TCI state, the second UL TCI state, and the second DL TCI state).

In some embodiments, the terminal device is in the second unified TCI state mode, that is, in the communication protocol of the R17 version, and the Flag field in the second signaling received by the terminal device takes 1. In this case, the terminal device overwrites or rewrites or updates the activated unified TCI state using the first UL TCI state and the second UL TCI state in the second signaling, such that the terminal device switches from the second unified TCI state mode to the first unified TCI state mode. As illustrated in FIG. 16, the table 1010 is used to indicate unified TCI states activated prior to receiving the second signaling, the table 1020 is used to indicate unified TCI states activated in the second signaling, and the table 1030 is used to indicate unified TCI states activated after an overwrite or rewrite or update operation. The terminal device is in the second unified TCI state prior to receiving the second signaling: the activated unified TCI state only corresponds to the first UL TCI state and/or the first DL TCI state; the Flag field in the second signaling takes 1; the activated unified TCI state is overwritten or rewritten or updated using the unified TCI state in the second signaling.

It should be noted that the above process 2210 may be separately implemented as one embodiment, the above process 2220 may be separately implemented as one embodiment, and the above processes 2210 and 2220 may be combined to form one embodiment, which is not limited in the present disclosure.

In summary; the apparatus for switching a TCI state mode according to the present disclosure is implemented by newly adding or designing a Flag field. Although the packet format of the MAC CE is changed, the solutions can explicitly and accurately instruct the terminal device to switch between two unified TCI states.

In a case where the UE moves between cells or within a cell, the UE may be proximal to a first TRP and distal to a second TRP. In a case where a significant difference is present in link qualities between the UE and a plurality of TRPs, the UE is not suitable for operating in an MTRP scenario. Therefore, the UE does not need to consume a large number of downlink measurement and reporting resources and store a plurality of unified TCI state resources, and the UE may switch from the first unified TCI state mode to the second unified TCI state mode. On the contrary, in a case where the UE moves to a cell edge, to enhance the uplink and downlink coverage of the UE, MTRP transmission is more suitable for the UE, and the UE may switch from the second unified TCI state mode to the first unified TCI state mode, thereby satisfying requirements in different transmission scenarios.

In the above embodiments, an example in which the first information field is the eLCID field or the first information field is the Flag field is used for description, but it is not excluded that in some other embodiments, other information fields in the MAC CE are used as the first information field to indicate switching between two TCI state modes, which is not limited in the embodiments of the present disclosure.

In some embodiments, switching between the two unified TCI state modes is applicable to all carriers in a first carrier list, wherein all the carriers in the first carrier list are a plurality of carriers of a common beam.

The common beam means that in a case where a plurality of component carriers (CCs) are configured in the first carrier list, and in a case where any one of the CCs receives the signaling, triggering a switch between the two unified TCI state modes, then the process is applicable to all other CCs in the first carrier list.

In some embodiments, a plurality of serving cells are configured in the same CC list, that is, a CC list of common beam operations. After the UE receives the MAC CE of the unified TCI state corresponding to R18 and the switching of the unified TCI state modes of R18 and R17 occurs, and moreover, in a case where the serving cell ID in the MAC CE is configured in a CC list of common beam operations, such as the TCI synchronization update list XsimultaneousU-TCI-Update ListX, the TCI synchronization update list YsimultaneousU-TCI-UpdateListY, and the TCI synchronization update list ZsimultaneousU-TCI-UpdateListZ, the UE switches the unified TCI state modes of all serving cells in the CC list, that is, switches from R18 to the 17 mode or vice versa.

In some embodiments, capability information is reported, wherein the capability information is used to indicate to the network device whether the terminal device supports the capability of switching between different unified TCI state modes.

In some embodiments, Implementation 1 and Implementation 2 are combined and implemented as an independent embodiment: Implementation 1 and Implementation 3 are combined and implemented as an independent embodiment: Implementation 2 and Implementation 3 are combined and implemented as an independent embodiment: Implementation 1, Implementation 2, and Implementation 3 are combined and implemented as an independent embodiment, which are not listed one by one in the embodiments of the present disclosure, but the protection scope of the present disclosure is not limited thereto.

In some embodiments, one or more receiving modules 3310 are provided, and one or more switching modules 3320 are also provided. In the present disclosure, an example in which one receiving module 3310 and one switching module 3320 are provided is used for description, but this is not limited. The receiving module 3310 may be separately implemented as an embodiment, and the switching module 3320 may be separately implemented as an embodiment, which is not limited in the present disclosure.

FIG. 40 illustrates a structural block diagram of an apparatus for switching a TCI state mode according to some embodiments of the present disclosure. The switching apparatus may be implemented as a part of a network device. The method includes at least some of the following content.

A transmitting module 3410 is configured to transmit signaling, wherein the signaling is used to instruct a terminal device to switch between two unified TCI state modes.

The two unified TCI state modes include a first unified TCI state mode and a second unified TCI state mode. The first unified TCI state mode corresponds to a communication protocol of a first version, and the second unified TCI state mode corresponds to a communication protocol of a second version, the first version being different from the second version.

In some embodiments, the first unified TCI state mode supports both STRP and MTRP, and the second unified TCI state mode supports STRP. In some embodiments, the communication protocol of the first version supports STRP and MTRP, and the communication protocol of the second version supports STRP. In some embodiments, the communication protocol of the first version is a communication protocol of an R18 version, and the communication protocol of the second version is a communication protocol of an R17 version: alternatively, the communication protocol of the first version is a communication protocol of an R19 version, and the communication protocol of the second version is a communication protocol of an R17 version. The specific version numbers of the two versions of the communication protocols are not limited in the embodiments.

In some embodiments, the terminal device switches from the first unified TCI state mode to the second unified TCI state mode based on first signaling: alternatively, the terminal device switches from the second unified TCI state mode to the first unified TCI state mode based on second signaling. In a case where the first version is higher than the second version, the terminal device falls back from the first unified TCI state mode to the second unified TCI state mode based on the first signaling.

In some embodiments, switching between the two unified TCI state modes is applicable to all carriers in a first carrier list, wherein all the carriers in the first carrier list are a plurality of carriers of a common beam.

The common beam means that in a case where a plurality of component carriers (CCs) are configured in the first carrier list, and in a case where any one of the CCs receives the signaling, triggering a switch between the two unified TCI state modes, then the process is applicable to all other CCs in the first carrier list.

In summary, in the apparatus according to the present disclosure, in a case where the terminal device needs to be switched from the first unified TCI state mode to the second unified TCI state mode, the communication protocol of the terminal device is switched from the first version to the second version; alternatively, in a case where the terminal device needs to be switched from the second unified TCI state mode to the first unified TCI state mode, the communication protocol of the terminal device is switched back from the second version to the first version.

In some embodiments, the signaling is signaling used for configuring a unified TCI state, such as RRC signaling: alternatively, the first signaling is signaling used for activating a unified TCI state, such as MAC CE: alternatively, the first signaling is signaling used for indicating a unified TCI state, such as DCI. In the embodiments of the present disclosure, an example in which the signaling is signaling used for activating a unified TCI state is used for description.

The present disclosure illustrates three implementations of transmitting signaling (that is, signaling used for activating a unified TCI state), wherein the signaling is used to instruct a terminal device to switch between two unified TCI state modes. At least one of the three implementations may be used in different embodiments. The three implementations are as follows.

Implementation 1: Signaling is transmitted, wherein the signaling includes an information field for activating a unified TCI state, which is used to indicate switching between two unified TCI state modes.

Implementation 2: Signaling is transmitted, wherein the signaling includes an eLCID field, which is used to indicate switching between two unified TCI state modes.

Implementation 3: Signaling is transmitted, wherein the signaling includes a Flag field, which is used to indicate switching between two unified TCI state modes.

The three implementations are sequentially described hereinafter, but the introduction sequence of the three implementations does not limit the superiority or inferiority of the three implementations.

With respect to Implementation 1: Signaling is transmitted, wherein the signaling includes an information field for activating a unified TCI state, which is used to indicate switching between two unified TCI state modes.

Since two cases of switching between two unified TCI states are present, the following is categorized into 1.1 and 1.2 for introduction, respectively.

### 1.1 the First Unified TCI State Mode is Switched to the Second Unified TCI State Mode.

A transmitting module 3410 is configured to transmit first signaling, wherein the first signaling is signaling used for activating a unified TCI state.

In some embodiments, the first signaling is signaling used for activating a unified TCI state in the first version: alternatively, the first signaling is signaling used for activating a unified TCI state in the second version.

With Respect to the First Signaling being Signaling Used for Activating a Unified TCI State in the First Version:

In some embodiments, all unified TCI states activated in the first signaling satisfy a first condition. The first condition includes:
the all unified TCI states activated in the first signaling only corresponding to a first joint TCI state; or
the all unified TCI states activated in the first signaling only corresponding to a second joint TCI state; or
the all unified TCI states activated in the first signaling only corresponding to a first UL TCI state and/or a first DL TCI state; or
the all unified TCI states activated in the first signaling only corresponding to a second UL TCI state and/or a second DL TCI state.
   With Respect to the First Signaling being Signaling Used for Activating a Unified TCI State in the Second Version:

In some embodiments, all unified TCI states activated in the first signaling satisfy a first condition. The first condition includes:
the all unified TCI states activated in the first signaling only corresponding to the joint TCI state; or
the all unified TCI states activated in the first signaling only corresponding to the UL TCI state and/or the DL TCI state.

In some embodiments, the terminal device overwrites or rewrites or updates the activated unified TCI state using the unified TCI state indicated in the first signaling, so as to switch from the first unified TCI state mode to the second unified TCI state mode. The specific embodiments are illustrated in embodiments corresponding to FIG. 9.

### 1.2 the Second Unified TCI State Mode is Switched to the First Unified TCI State Mode.

A transmitting module 3410 is configured to transmit second signaling, wherein the second signaling is signaling used for activating a unified TCI state.

In some embodiments, the first unified TCI state mode corresponds to the communication protocol of the R18 version that supports STRP and MTRP, and the second unified TCI state mode corresponds to the communication protocol of the R17 version that supports only STRP. The second signaling is a MAC CE. Each codepoint of the MAC CE corresponding to R17 corresponds to only one unified TCI state, and one codepoint of the MAC CE corresponding to R18 may correspond to one or two unified TCI states.

The second signaling is used to indicate switching from the second unified TCI state to the first unified TCI state. At least one unified TCI state activated in the second signaling satisfies a second condition. In some embodiments, the second condition includes:
in some embodiments, the at least one unified TCI state activated in the second signaling corresponding to a first joint TCI state and a second joint TCI state simultaneously: or
in some embodiments, the at least one unified TCI state activated in the second signaling corresponding to a first UL TCI state and a second UL TCI state simultaneously: or
in some embodiments, the at least one unified TCI state activated in the second signaling corresponding to a first DL TCI state and a second DL TCI state simultaneously: or
in some embodiments, the at least one unified TCI state activated in the second signaling corresponding to a first UL TCI state, a second UL TCI state, a first DL TCI state, and a second DL TCI state simultaneously.

In some embodiments, the terminal device overwrites or rewrites or updates the activated unified TCI state using the unified TCI state indicated in the second signaling. The specific method is illustrated in embodiments corresponding to FIG. 14.

In summary; the apparatus for switching a TCI state mode according to the present disclosure uses the activated unified TCI state as an implicit indication. For example, in a case where all unified TCI states activated in the signaling only correspond to the first joint TCI state, it is considered that the terminal device needs to fall back to the second version that supports only STRP: in a case where at least one unified TCI state activated in the signaling corresponds to the first UL TCI state and the second UL TCI state simultaneously, it is considered that the terminal device needs to switch to the first version that supports MTRP. Based on the method, not only can the switching intention of the terminal device be identified, but also the original MAC CE packet format can be used for determination, thereby better accommodating the earlier version to achieve switching between unified TCI state modes.

With respect to Implementation 2: Signaling is transmitted, wherein the signaling includes an eLCID field, which is used to indicate switching between two unified TCI state modes.

The present disclosure exemplarily illustrates the value range of the eLCID field corresponding to the first version, as illustrated in Table 3.

The first value is the codepoint 233 and/or the index 297.

The second value is the codepoint xxx and/or the index yyy. The codepoint xxx is any numerical value from 0 to 226, the index yyy is any numerical value from 64 to 290, and the index yyy is the codepoint xxx plus 64.

Since two cases of switching between two unified TCI states are present, the following is categorized into 2.1 and 2.2 for introduction, respectively.

### 2.1 the First Unified TCI State Mode is Switched to the Second Unified TCI State Mode.

A transmitting module 3410 is configured to transmit first signaling, wherein the first signaling includes an eLCID field, a value of the eLCID field taking a first value, wherein this eLCID field is used to instruct a terminal device to switch from the first unified TCI state mode to the second unified TCI state mode.

The first value is a value corresponding to the second version.

In some embodiments, the value range of the first value includes the codepoint 233 and/or the index 297.

In some embodiments, the value corresponding to the eLCID of R17 includes the codepoint 233 and the index 297.

In some embodiments, the terminal device overwrites or rewrites or updates the activated unified TCI state using the joint TCI state indicated in the first signaling. The specific method is illustrated in embodiments corresponding to FIG. 17.

### 2.2 the Second Unified TCI State Mode is Switched to the First Unified TCI State Mode.

A transmitting module 3410 is configured to transmit second signaling, wherein the second signaling includes an eLCID field, a value of the eLCID field taking a second value, wherein this eLCID field is used to instruct a terminal device to switch from the second unified TCI state mode to the first unified TCI state mode.

The second value is a value corresponding to the first version.

In some embodiments, a value corresponding to the eLCID of R18 is that the eLCID codepoint ranges from 0 to 226, an index of the eLCID ranges from 64 to 290, and the index of the eLCID is the eLCID codepoint plus 64. The terminal device determines, based on the value of the eLCID in the second signaling, whether to switch from the second unified TCI state mode to the first unified TCI state mode.

In some embodiments, the terminal device overwrites or rewrites or updates the activated unified TCI state using the unified TCI state indicated in the second signaling. The specific method is illustrated in embodiments corresponding to FIG. 18.

In summary; in the apparatus for switching a TCI state mode according to the present disclosure, by using different designed values of the eLCID in the signaling, switching can be achieved between two unified TCI states by only modifying the existing value or setting a reserved value to a value corresponding to the first version. The overall format and length of the packet are not affected and better accommodation to different versions can be achieved. In addition, for the terminal device, the switching instruction in the solutions is clearer and more specific.

With respect to Implementation 3: Signaling is transmitted, wherein the signaling includes a Flag field, wherein this Flag field is used to indicate switching between two unified TCI state modes.

In the present disclosure, a Flag field is newly added or designed to the signaling exemplarily; which is used to instruct the terminal device to switch to a corresponding unified TCI state mode. The Flag field may be designed to be one bit, two bits, or more bits.

In the embodiments of the present disclosure, an example in which the Flag field includes one bit and two bits is used for description. However, the number of bits of the Flag field is not limited.

In Some Embodiments, Flag is Two Bits, and the Two Bits have at Least Three Values.

A first value is a value corresponding to the second version and the first value is used to instruct the terminal device to use the first unified TCI state as a unified TCI state in the second unified TCI state mode in a case where the terminal device switches from the first unified TCI state mode to the second unified TCI state mode.

A second value is a value corresponding to the second version and the second value is used to instruct the terminal device to use the second unified TCI state as a unified TCI state in the second unified TCI state mode in a case where the terminal device switches from the first unified TCI state mode to the second unified TCI state mode.

A third value is a value corresponding to the first version and the third value is used to instruct the terminal device to switch from the second unified TCI state mode to the first unified TCI state mode.

In some embodiments, the first value is any one of 00, 01, 10, or 11: the second value is any one of 00, 01, 10, or 11 except the first value: the third value is any one of 00, 01, 10, or 11 except the first value and the second value. In some embodiments, the first value is 00, the second value is 01, and the third value is 10: or the first value is 01, the second value is 10, and the third value is 00; or the first value is 11, the second value is 00, and the third value is 10. In the embodiments of the present disclosure, an example in which the first value is 00, the second value is 01, and the third value is 10 is used for description. However, the specific values of the first value, the second value, and the third value are not limited.

### 3.1 the First Unified TCI State Mode is Switched to the Second Unified TCI State Mode.

A transmitting module 3410 is configured to transmit first signaling, wherein the first signaling includes a Flag field, the Flag field taking a value within a first range, wherein this Flag field is used to instruct a terminal device to switch from the first unified TCI state mode to the second unified TCI state mode.

The first range includes values corresponding to the second version.

In some embodiments, two values corresponding to the second version are present in the first range, a first value of 00 and a second value of 01, respectively.

In some embodiments, the Flag field takes the first value within the first range, which is used to instruct the terminal device to overwrite or rewrite or update the activated unified TCI state using the first joint TCI state indicated in the first signaling. The specific method is illustrated in embodiments corresponding to FIG. 21.

In some embodiments, the Flag field takes the second value within the first range, which is used to instruct the terminal device to overwrite or rewrite or update the activated unified TCI state using the second joint TCI state indicated in the first signaling.

In some embodiments, the Flag field takes the first value within the first range, which is used to instruct the terminal device to overwrite or rewrite or update the activated unified TCI state using the first UL TCI state and/or the first DL TCI state indicated in the first signaling.

In some embodiments, the Flag field takes the second value within the first range, which is used to instruct the terminal device to overwrite or rewrite or update the activated unified TCI state using the second UL TCI state and/or the second DL TCI state indicated in the first signaling.

### 3.2 the Second Unified TCI State Mode is Switched to the First Unified TCI State Mode.

A transmitting module 3410 is configured to transmit second signaling, wherein the second signaling includes a Flag field, the Flag field taking a third value (10), wherein the Flag field is used to instruct a terminal device to switch from the second unified TCI state mode to the first unified TCI state mode.

The third value is a value corresponding to the first version.

In some embodiments, the Flag field takes the third value, which is used to instruct the terminal device to overwrite or rewrite or update the activated unified TCI state using the first joint TCI state and the second joint TCI indicated in the second signaling. The specific method is illustrated in embodiments corresponding to FIG. 26.

In some embodiments, the Flag field takes the third value, which is used to instruct the terminal device to overwrite or rewrite or update the activated unified TCI state using the first UL TCI state and/or the first DL TCI state and/or the second UL TCI state and/or the second DL TCI state indicated in the second signaling.

### In Some Embodiments of the Present Disclosure, Flag is One Bit, and the One Bit has Two Values.

A first value is a value corresponding to the second version and the first value is used to instruct the terminal device to switch from the first unified TCI state mode to the second unified TCI state mode.

A third value is a value corresponding to the first version and the third value is used to instruct the terminal device to switch from the second unified TCI state mode to the first unified TCI state mode.

In some embodiments, the first value is any one of 0 or 1: the second value is any one of 0 or 1 except the first value. In some embodiments, the first value is 0, and the third value is 1: or the first value is 1, and the third value is 0. In the embodiments of the present disclosure, an example in which the first value is 0 and the third value is I is used for description. However, the specific values of the first value and the second value are not limited.

### 3.3 the First Unified TCI State Mode is Switched to the Second Unified TCI State Mode.

A transmitting module 3410 is configured to transmit first signaling, wherein the first signaling includes a Flag field, the Flag field taking a first value, wherein the Flag field is used to instruct a terminal device to switch from the first unified TCI state mode to the second unified TCI state mode.

The first value is a value corresponding to the second version.

In some embodiments, the Flag field takes the first value, which is used to indicate to overwrite or rewrite or update the activated unified TCI state using the first joint TCI state indicated in the first signaling. The specific method is illustrated in embodiments corresponding to FIG. 9.

In some embodiments, the Flag field takes the first value, which is used to overwrite or rewrite or update the activated unified TCI state using the second joint TCI state indicated in the first signaling.

In some embodiments, the Flag field takes the first value, which is used to overwrite or rewrite or update the activated unified TCI state using the first UL and/or DL TCI state indicated in the first signaling.

In some embodiments, the Flag field takes the first value, which is used to overwrite or rewrite or update the activated unified TCI state using the second UL and/or DL TCI state indicated in the first signaling.

### 3.4 the Second Unified TCI State Mode is Switched to the First Unified TCI State Mode.

A transmitting module 3410 is configured to transmit second signaling, wherein the second signaling includes a Flag field, the Flag field taking a third value (1), wherein the Flag field is used to indicate a terminal device to switch from the second unified TCI state mode to the first unified TCI state mode.

In some embodiments, the Flag field takes the third value, which is used to instruct the terminal device to overwrite or rewrite or update the activated unified TCI state using the first joint TCI state and the second joint TCI indicated in the first signaling. The specific method is illustrated in embodiments corresponding to FIG. 28.

In some embodiments, the Flag field takes the third value, which is used to instruct the terminal device to overwrite or rewrite or update the activated unified TCI state using the unified TCI state indicated in the second signaling (including eight groups at most, each group of unified TCI states including one or more of the first UL TCI state, the first DL TCI state, the second UL TCI state, and the second DL TCI state).

In summary; the apparatus for switching a TCI state mode according to the present disclosure is implemented by newly adding or designing a Flag field. Although the packet format is changed, the solutions can very accurately instruct the terminal device to switch between two unified TCI states.

In the above embodiments, an example in which the first information field is the eLCID field or the first information field is the Flag field is used for description, but it is not excluded that in some other embodiments, other information fields in the MAC CE are used as the first information field to indicate switching between two TCI state modes, which is not limited in the embodiments of the present disclosure.

In some embodiments, switching between the two unified TCI state modes is applicable to all carriers in a first carrier list, wherein all the carriers in the first carrier list are a plurality of carriers of a common beam.

The common beam means that in a case where a plurality of component carriers (CCs) are configured in the first carrier list, and in a case where any one of the CCs receives the signaling, triggering a switch between the two unified TCI state modes, then the process is applicable to all other CCs in the first carrier list.

In some embodiments, a plurality of serving cells are configured in the same CC list, that is, a CC list of common beam operations. After the UE receives the MAC CE of the unified TCI state corresponding to R18 and the switching of the unified TCI state modes of R18 and R17 occurs, and moreover, in a case where the serving cell ID in the MAC CE is configured in a CC list of common beam operations, such as the TCI synchronization update list XsimultaneousU-TCI-Update ListX, the TCI synchronization update list YsimultaneousU-TCI-UpdateListY, and the TCI synchronization update list ZsimultaneousU-TCI-UpdateListZ, the UE switches the unified TCI state modes of all serving cells in the CC list, that is, switches from R18 to the 17 mode or vice versa.

In some embodiments, the capability information reported by the terminal device is received. The capability information is used to indicate whether the terminal device supports the capability of switching between different unified TCI state modes. In a case where the terminal device supports switching between different unified TCI state modes, two different types of signaling are configured and used. In a case where the terminal device does not support switching between different unified TCI state modes, signaling supported by the terminal device is configured and used.

In some embodiments, Implementation 1 and Implementation 2 are implemented as an independent embodiment: Implementation 1 and Implementation 3 are implemented as an independent embodiment: Implementation 2 and Implementation 3 are implemented as an independent embodiment; Implementation 1, Implementation 2, and Implementation 3 are implemented as an independent embodiment, which is not limited thereto.

In some embodiments, one or more transmitting modules 3410 are provided. In the present disclosure, an example in which one transmitting module 3410 is provided is used for description, but this is not limited.

It should be noted that in a case where the apparatus according to the above embodiments implements the functions thereof, the division of the functional modules is merely exemplary. In practice, the above functions can be assigned to different functional modules based on actual needs, that is, the internal structure of the device may be divided into different functional modules, so as to implement all or a part of the above functions. The transmitting module may be implemented by a transmitter, the receiving module may be implemented by a receiver, and the switching module may be implemented by a processor.

With regard to the apparatus in the above embodiments, the specific manner in which each module performs the operation has been described in detail in the embodiments related to the method and will not be elaborated herein any further.

FIG. 41 illustrates a schematic structural diagram of a communication device (terminal device or network device) according to some embodiments of the present disclosure. The communication device includes: a processor 3501, a receiver 3502, a transmitter 3503, a memory 3504, and a bus 3505.

The processor 3501 includes one or more processing cores, and the processor 3501 executes various functional applications and performs information processing by running software programs and modules.

The receiver 3502 and the transmitter 3503 may be implemented as one transceiver, and the transceiver may be a communication chip.

The memory 3504 is connected to the processor 3501 over the bus 3505. In some embodiments, the processor 3501 may be implemented as a first IC chip, and the processor 3501 and the memory 3504 may be jointly implemented as a second IC chip. The first chip or the second chip may be an application specific integrated circuit (ASIC) chip.

The processor 3501 can implement the function implemented by the switching module 3320 in the above method embodiments. The receiver 3502 can implement the function implemented by the receiving module 3310 in the above method embodiments. The transmitter 3503 can implement the function implemented by the transmitting module 3410 in the above method embodiments.

The memory 3504 can be configured to store at least one computer program, and the processor 3501 is configured to run the at least one computer program to implement the processes performed by the communication system in the above method embodiments.

Furthermore, the memory 3504 may be implemented by any type of volatile or non-volatile storage device, or a combination thereof. Volatile or non-volatile storage devices include but are not limited to: a random-access memory (RAM), a read-only memory (ROM), an erasable programmable read-only memory (EPROM), an electrically erasable programmable read-only memory (EEPROM), a flash memory or another solid-state storage technology, a compact disc read-only memory (CD-ROM), a digital video disc (DVD) or another optical storage, a magnetic cassette, a magnetic tape, a magnetic disc storage, or another magnetic storage device.

The embodiments of the present disclosure further provide a computer-readable storage medium storing one or more computer programs, where the one or more computer programs, when loaded and run by a processor of a communication device, cause the communication device to perform the method for switching a TCI state mode as described above.

In some embodiments, the computer-readable storage medium includes a read-only memory (ROM), a random-access memory (RAM), a solid state drive (SSD), or an optical disc. Here, the random-access memory includes a resistance random access memory (ReRAM) and a dynamic random access memory (DRAM).

The embodiments of the present disclosure further provide a chip including one or more programmable logic circuits and/or one or more program instructions. The chip, when running on a communication device, is configured to perform the method for switching a TCI state mode as described above.

The embodiments of the present disclosure further provide a computer program product or a computer program. The computer program product or the computer program includes one or more computer instructions stored in a computer-readable storage medium, wherein the one or more computer instructions, when read from the computer-readable storage medium and executed by a processor of a communication device, cause the communication device to perform the method for switching a TCI state mode as described above.

It should be understood that the term “indication” mentioned in the embodiments of the present disclosure is a direct indication, an indirect indication, or an indication that there is an association relationship. For example, A indicates B, which may mean that A indicates B directly, e.g., B may be acquired by A: or that A indicates B indirectly, e.g., A indicates C by which B may be acquired: or that an association relationship is present between A and B.

In the description of the embodiments of the present disclosure, the term “correspond” indicates a direct or indirect corresponding relationship between two items, or indicates an associated relationship between the two items; and also indicates relationships such as indicating and being indicated, or configuring and being configured.

The mentioned term “a plurality of” herein means two or more. The term “and/or” describes the association relationship between the associated objects, and indicates that three relationships may be present. For example, the phrase “A and/or B” means (A), (B), or (A and B). The symbol “/” generally indicates an “or” relationship between the associated objects.

In addition, serial numbers of the processes described herein only show an exemplary possible sequence of performing the processes. In some other embodiments, the processes may also be performed out of the numbering sequence, for example, two processes with different serial numbers are performed simultaneously, or two processes with different serial numbers are performed in a reverse order to the illustrated sequence, which is not limited in the present disclosure.

Those skilled in the art should understand that in one or more of the above embodiments, the functions described in the embodiments of the present disclosure may be implemented in hardware, software, firmware, or any combination thereof. The functions, when implemented in software, may be stored in a computer-readable medium or transmitted as one or more instructions or codes on a computer-readable medium. The computer-readable medium includes a computer storage medium and a communication medium, where the communication medium includes any medium that facilitates the transfer of a computer program from one place to another. The storage medium is any available medium that is accessible by a general-purpose or special-purpose computer.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Described above are merely embodiments of the present disclosure and are not intended to limit the present disclosure. Any modifications, equivalent substitutions, improvements, and the like, made within the spirit and principle of the present disclosure should fall within the protection scope of the present disclosure.

1. A method for switching a transmission configuration indication (TCI) state mode, performed by a terminal device, the method comprising:
receiving signaling, wherein the signaling is used to indicate switching between two unified TCI state modes;
wherein the two unified TCI state modes comprise a first unified TCI state mode and a second unified TCI state mode, wherein the first unified TCI state mode corresponds to a communication protocol of a first version, and the second unified TCI state mode corresponds to a communication protocol of a second version, the first version being different from the second version.

2. The method according to claim 1, wherein the signaling is second signaling, wherein the second signaling is used to indicate switching from the second unified TCI state mode to the first unified TCI state mode, and the second signaling is signaling used for activating a unified TCI state.

3. The method according to claim 2, wherein the second signaling is a medium access control control element (MAC CE): or
at least one unified TCI state activated in the second signaling satisfies a second condition; or
the second signaling comprises a first information field: wherein a value of the first information field is used to indicate switching from the second unified TCI state mode to the first unified TCI state mode.

4. The method according to claim 3, wherein the second condition comprises: the at least one unified TCI state activated in the second signaling corresponding to a first joint TCI state and a second joint TCI state simultaneously; or the at least one unified TCI state activated in the second signaling corresponding to a first uplink TCI state and a second uplink TCI state simultaneously; or the at least one unified TCI state activated in the second signaling corresponding to a first downlink TCI state and a second downlink TCI state simultaneously; or
the method further comprises: switching from the second unified TCI state mode to the first unified TCI state mode by overwriting or rewriting or updating an activated unified TCI state using the unified TCI state indicated in the second signaling.

5. The method according to claim 3, wherein the first information field is an eLCID field, the eLCID field taking a second value; wherein the second value is a value corresponding to the first version; or
the first information field is a Flag field, the Flag field taking a third value; wherein the third value is a value corresponding to the first version.

6. The method according to claim 5, in a case where the first information field is the eLCID field, the method further comprises at least one of: overwriting or rewriting or updating an activated unified TCI state using a first joint TCI state and a second joint TCI state indicated in the second signaling: or overwriting or rewriting or updating an activated unified TCI state using a first uplink TCI state and a second uplink TCI state indicated in the second signaling: or overwriting or rewriting or updating an activated unified TCI state using a first downlink TCI state and a second downlink TCI state indicated in the second signaling in a case where the eLCID field takes the second value: or
in a case where the first information field is the eLCID field, a value range of the second value comprises codepoints from 0 to 226 and/or indices from 64 to 290, wherein the index is the codepoint plus 64.

7. The method according to claim 5, in a case where the first information field is a Flag field, the method further comprises:
overwriting or rewriting or updating an activated unified TCI state using a first joint TCI state and a second joint TCI indicated in the second signaling: or
overwriting or rewriting or updating an activated unified TCI state using at least one of a first uplink TCI state, a first downlink TCI state, a second uplink TCI state, or a the second downlink TCI state indicated in the second signaling.

8. A communication device, comprising:
a processor and a memory storing at least one program therein, wherein the processor, when running the at least one program stored in the memory, causes the communication device to:
receive signaling, wherein the signaling is used to indicate switching between two unified TCI state modes:
wherein the two unified TCI state modes comprise a first unified TCI state mode and a second unified TCI state mode, wherein the first unified TCI state mode corresponds to a communication protocol of a first version, and the second unified TCI state mode corresponds to a communication protocol of a second version, the first version being different from the second version.

9. The communication device according to claim 8, wherein the signaling is first signaling, wherein the first signaling is used to indicate switching from the first unified TCI state mode to the second unified TCI state mode, and the first signaling is signaling used for activating a unified TCI state.

10. The communication device according to claim 9, wherein the first signaling is a medium access control control element (MAC CE): or
all unified TCI states activated in the first signaling satisfy a first condition.

11. The communication device according to claim 10, wherein the first unified TCI state is a first joint TCI state, and the first joint TCI state is associated with a first transmission reception point (TRP); the second unified TCI state is a second joint TCI state, and the second joint TCI state is associated with a second TRP: or a first unified TCI state is at least one of a first uplink TCI state or a first downlink TCI state, the at least one of the first uplink TCI state or the first downlink TCI state being associated with a first TRP; and a second unified TCI state is at least one of a second uplink TCI state or a second downlink TCI state, the at least one of the second uplink TCI state or the second downlink TCI state being associated with a second TRP: or
the first condition comprises:
the all unified TCI states activated in the first signaling only corresponding to a first joint TCI state; or
the all unified TCI states activated in the first signaling only corresponding to a second joint TCI state; or
the all unified TCI states activated in the first signaling only corresponding to at least one of a first uplink TCI state or a first downlink TCI state; or
the all unified TCI states activated in the first signaling only corresponding to at least one of a second uplink TCI state or a second downlink TCI state; or
the processor, when running the at least one program stored in the memory, further causes the communication device to: switch from the first unified TCI state mode to the second unified TCI state mode by overwriting or rewriting or updating an activated unified TCI state using the unified TCI state indicated in the first signaling.

12. The communication device according to claim 9, wherein the first signaling comprises a first information field:
wherein a value of the first information field is used to indicate switching from the first unified TCI state mode to the second unified TCI state mode.

13. The communication device according to claim 12, wherein the first information field is an extended logical channel identifier (eLCID) field, the eLCID field taking a first value; wherein the first value is a value corresponding to the second version: or
the first information field is a Flag field, the Flag field taking a first value: wherein the first value is a value corresponding to the second version: or
the first information field comprises a Flag field, the Flag field in the first signaling taking a value within a first range: wherein the first range comprises values corresponding to the second version.

14. The communication device according to claim 13, wherein in a case where the first information field is the eLCID field, a value range of the first value comprises a codepoint 233 and/or an index 297; or
the processor, when running the at least one program stored in the memory, further causes the communication device to perform at least one of:
overwriting or rewriting or updating an activated unified TCI state using a joint TCI state indicated in the first signaling: or
overwriting or rewriting or updating an activated unified TCI state using at least one of an uplink TCI state and/or a downlink TCI state indicated in the first signaling.

15. The communication device according to claim 13, wherein in a case where the first information field is the Flag field, the Flag field taking the first value, the processor, when running the at least one program stored in the memory, further causes the communication device to:
overwrite or rewrite or update an activated unified TCI state using a first joint TCI state indicated in the first signaling: or
overwrite or rewrite or update an activated unified TCI state using a second joint TCI state indicated in the first signaling: or
overwrite or rewrite or update an activated unified TCI state using at least one of a first uplink TCI state or a downlink TCI state indicated in the first signaling: or
overwrite or rewrite or update an activated unified TCI state using a second uplink TCI state and/or a downlink TCI state indicated in the first signaling.

16. The communication device according to claim 13, wherein in a case where the first information field comprises the Flag field, the Flag field in the first signaling taking the value within the first range, the processor, when running the at least one program stored in the memory, further causes the communication device to:
overwrite or rewrite or update an activated unified TCI state using a first joint TCI state indicated in the first signaling in a case where the Flag field in the first signaling takes a first value within the first range; or
overwrite or rewrite or update an activated unified TCI state using a second joint TCI state indicated in the first signaling in a case where the Flag field in the first signaling takes a second value within the first range: or
overwrite or rewrite or update an activated unified TCI state using at least one of a first uplink TCI state or a first downlink TCI state indicated in the first signaling in a case where the Flag field in the first signaling takes a first value within the first range; or
overwrite or rewrite or update an activated unified TCI state using at least one of a second uplink TCI state and/or a second downlink TCI state indicated in the first signaling in a case where the Flag field in the first signaling takes a second value within the first range.

17. The communication device according to claim 8, wherein the method is applicable to all carriers in a first carrier list, wherein the all carriers in the first carrier list are a plurality of carriers of a common beam: or
the first unified TCI state mode supports a single transmission reception point (STRP) and multiple transmission reception points (MTRPs), and the second unified TCI state mode supports the STRP; or
the communication protocol of the first version is a communication protocol of an R18 version, and the second version is a communication protocol of an R17 version; or
the processor, when running the at least one program stored in the memory, further causes the communication device to: report capability information, wherein the capability information is used to indicate to a network device whether the terminal device supports a capability of switching between different unified TCI state modes.

18. A communication device, comprising:
a processor and a memory storing at least one program therein, wherein the processor, when running the at least one program stored in the memory, causes the communication device to:
transmit signaling, wherein the signaling is used to instruct a terminal device to switch between two unified TCI state modes;
wherein the two unified TCI state modes comprise a first unified TCI state mode and a second unified TCI state mode, wherein the first unified TCI state mode corresponds to a communication protocol of a first version, and the second unified TCI state mode corresponds to a communication protocol of a second version, the first version being different from the second version.

19. The communication device according to claim 18, wherein the signaling is first signaling, wherein the first signaling is used to instruct the terminal device to switch from the first unified TCI state mode to the second unified TCI state mode.

20. The communication device according to claim 19, wherein the first signaling is a medium access control control element (MAC CE); or
all unified TCI states activated in the first signaling satisfy a first condition.
